(19) United States
(12) Patent Application Publication
(10) Pub. No.: US 2026/0286068 A1
(43) Pub. Date: Sep. 24, 2026

(54) Nano and Micro Particles Enhancing Physical Performance of Formulations, Preparation, and Final Product

(71) Applicant: Nano Catalytics, Inc., Cincinnati, OH (US)

(72) Inventors: Srinagesh Kumar Potluri, Mason, OH (US); Adam Malofsky, Loveland, OH (US)

(21) Appl. No.: 19/475,888

(22) PCT Filed: Apr. 18, 2024
(86) PCT No.: PCT/US2024/025251

§ 371 Date: Oct. 16, 2025

Related U.S. Application Data
(60) Provisional application No. 63/496,724, filed on Apr. 18, 2023.

(51) Int. Cl. C08J 3/12; C08J 3/20; C08K 3/04; C08K 11/00

(52) U.S. Cl. CPC C08J 3/126; C08J 3/20; C08K 3/041; C08K 11/00; C08J 2325/02; C08J 2333/12; C08J 2391/06; C08K 2201/005

(57) ABSTRACT

In one aspect, this invention relates to a plurality of matrix particles, comprising a core and optionally, at least one shell, wherein said core comprises: (i) a matrix material, wherein said matrix material is capable of fully or partially altering its physical and/or chemical characteristics; (ii) at least one susceptor component, wherein said at least one susceptor component is embedded in said matrix material; and (iii) at least one releasable ingredient, wherein said at least one releasable ingredient is embedded in said matrix material, wherein said at least one releasable ingredient is capable of impacting physically or chemically a physical or a chemical composition with which said plurality of matrix particles is contacted; and wherein said at least one shell comprises: (iv) optionally, said at least one susceptor component, wherein said at least one susceptor component is embedded in said at least one shell; and (v) at least one releasable ingredient, wherein said at least one releasable ingredient is embedded in said at least one shell, wherein said at least one releasable ingredient is capable of impacting physically or chemically a physical or a chemical composition with which said plurality of matrix particles is contacted.

### CROSS REFERENCE TO RELATED APPLICATIONS

This application claims priority to and the benefit of U.S. Provisional Patent Application No. 63/496,724 filed Apr. 18, 2023, which is incorporated by reference herein in its entirety for any and all purposes.

### FIELD OF THE INVENTION

Nano and micro particles of the present invention serve as carriers for more effectively delivering nanomaterials into sealants, coatings, composites, adhesives, and other polymeric products. Specifically, the present invention relates to matrix particles carrying nanomaterials, including metals and their chemical products, carbon nanostructures such as graphene and carbon nanotubes for improving physical, electrical, thermal, chemical, and conductive properties, or simply minimizing more amount of said nanomaterial. Optionally, crosslinking chemistries can be incorporated into said particles, either simply on the surface or as ligand or oligomeric like structures capable of even further enhancing noted physical performance. In one embodiment, the matrix particles as described above are used as nano-particle and/or micro-particle carriers to be blended or mixed into polymeric or reaction precursor mixtures for further processing.

Generally, speaking, and in one aspect, this invention relates to matrix particles that comprise a matrix material, susceptors and releasable ingredient, defined infra. In some embodiments, these particles are in a core-shell configuration, or just a core. The core is capable of altering its physical or chemical form, which allows for the release of the releasable ingredient. When the particle is in a core-shell configuration, there can be one or more shell. The susceptor can be in none or one or more than one shells. Similarly, the releasable ingredient can be in none or one or more than one shells. So the shells are physically or chemically alterable materials such as oligomeric or polymeric materials. The presence of the susceptor in the matrix particle is optional. Such matrix particles are mixed in a physical or chemical composition of interest that needs to be physically or chemically impacted by the mixing with the matrix particles and applying an external force such as radio frequency or heat that will alter the matrix particle and release the releasable ingredient into the physical or the chemical mixture or composition.

### BACKGROUND

In composite manufacturing, eliminating gross heating provides for higher throughputs and eliminates the need to cool parts of equipment or molded materials before removing them from molds. Currently, polymerization can be initiated by two-component mixing to achieve a completed reaction system, by activating a catalyst by light or by grossly heating a composition or similar. Each has limits by default. Gross heating takes a long time, uses a maximum amount of energy and associated complex equipment and leaves behind, through heating and cooling, limited performance with excess material due to built-in stresses from polymerization. Gross heating cannot be used in an adhesive application with elastomeric substrates with glass transition temperatures lower than room temperatures. Two-component mixing can have the same or worse complexity and requires complex mixing or metering equipment to achieve even curing and appropriate mix ratio respectively. Light, by default is limited to clear objects, can only cure thinner objects, requires special packaging to prohibit light, excess catalyst amounts typically beyond 1% and typically inputs excess thermal energy and again requires complex equipment. On the other hand, active catalyst and co-catalyst embedded in the matrix particle improves the shelf life of the products. For example, in B-staged products such as thermoset prepregs and film adhesives, to improve the shelf life and usable time the products are kept frozen until use.

It is a desire in industrial manufacturing or processing to not utilize gross heating, to cure larger objects on-demand as with light, to not utilize complex curing equipment, to eliminate the need for complex and metal-based molding equipment and to minimize catalyst loadings as well two-part systems or limited pot life for a two-part system.

In adhesion, gross heating limits the use of thick substrates with higher glass transition temperatures. Higher molecular weight materials pose challenges in accepting higher loadings of fillers or reinforcements such as milled carbon fibers and glass fibers. Use of low molecular weight materials would enable use of higher filler content. Uniform mixing of the fillers and higher performance without rheological issues would be an advantage of using low molecular weight materials.

Unless an object it sufficiently transparent to allow a substantial transmission of light, chemistry activation through opaque objects is often limited as described above. There is a need for a technology capable of penetrating opaque materials, especially through a substantial distance. This would afford the new ability to initiate polymerization in an object filled with a variety of fillers to varying extents without the need for heat and without the limitations of light transmission if even possible.

As the art stands today, ingredient release in a chemical reaction must be caused by the external environment of a chemical reaction chamber, versus by an event caused from within the particle. This is similar to bulk heating, or if using external light, it would be limited by thin dimensions.

Overall, there is a need to activate chemistry and achieve the elimination of gross heating, minimization of energy use, minimization of materials, and minimization of catalyst use to achieve high-speed chemistry as desired, eliminate equipment complexity and minimize its cost and space, minimize or eliminate invasive procedures and to achieve on-demand activation.

Many desirable effects can be achieved incorporating nanomaterials in compositions and their subsequent realizations through to final performing products. The noted functional materials and their formation or the effect of covalent bonds, hydrogen, and Van der Waals forces can alone enable significantly increased toughness, elasticity, strength, wear resistance, product life, environmental resistance and the like.

Importantly, the addition of nanomaterials is often fraught with challenges, both physical, chemical, process and economic.

In particular, nanomaterials such as graphene or other platelike structures and or nanotubes and the like possess properties that inherently lead to their physical association, by example, which can lead to agglomeration, attachment and then network formation all of which can lead to limiting deleterious effects. Both chemical, Van der Waals and other associations then lead in the end to dramatic viscosity increases as the amount of said nanomaterials increase, by example, limiting the amount to be added thus limiting the range of desired effects to be incorporated into a composition. Carbon nanotubes are among the nanomaterials most limited by these overall effects. This then can among other things, limit the overall amount of nanomaterial that can be incorporated or the overall amount required to achieve a particular effect.

The latter effects can also limit composition processing, not merely the amounts of materials than can be incorporated. By example, shear effects limit pumping and mixing or blending, as the amount of energy required significantly increases, the nanomaterials wear equipment components, heat builds up breaking down compositional ingredients and or initiating a variety of undesirable chemical and physical effects.

Economically, even the former is to whatever degree overcome, unnecessary and then more expensive amounts of materials may be incorporated to achieve a desired effect, often making many applications uneconomic and or limited in overall economic application in the broadest markets.

In summary, it would be useful to find a more efficient, less limiting way to take utilize nanomaterials, in particular nanotubes, graphene and the like without or while greatly reducing the aforementioned limitations.

### SUMMARY OF THE INVENTION

In one embodiment, this invention relates to a plurality of matrix particles, comprising a matrix particle A and/or a matrix particle B:
wherein, said matrix particle A comprises a core and optionally, at least one shell,
wherein said core comprises:
(i) a matrix material, wherein said matrix material is capable of fully or partially altering its physical and/or chemical characteristics;
(ii) at least one susceptor component, wherein said at least one susceptor component is embedded in said matrix material; and
(iii) at least one releasable ingredient, wherein said at least one releasable ingredient is embedded in said matrix material, wherein said at least one releasable ingredient is capable of impacting physically or chemically a bulk physically or chemically alterable composition with which said plurality of matrix particles is contacted, and wherein said at least one shell comprises:
(iv) optionally, said at least one susceptor component, wherein said at least one susceptor component is embedded in said at least one shell; and
(v) at least one releasable ingredient, wherein said at least one releasable ingredient is embedded in said at least one shell, wherein said at least one releasable ingredient is capable of impacting physically or chemically said bulk physically or chemically alterable composition with which said plurality of matrix particles is contacted;
AND
wherein said matrix particle B comprises a core and optionally, at least one shell, wherein said core comprises:
(vi) a matrix material, wherein said matrix material is capable of fully or partially altering its physical and/or chemical characteristics; and
(vii) at least one releasable ingredient, wherein said at least one releasable ingredient is embedded in said matrix material, wherein said at least one releasable ingredient is capable of impacting physically or chemically said bulk physically or chemically alterable composition with which said plurality of matrix particles is contacted; and
wherein said at least one shell comprises:
(viii) optionally, said at least one susceptor component, wherein said at least one susceptor component is embedded in said at least one shell; and
(ix) said at least one releasable ingredient, wherein said at least one releasable ingredient is embedded in said at least one shell, wherein said at least one releasable ingredient is capable of impacting physically or chemically said bulk physically or chemically alterable composition with which said plurality of matrix particles is contacted; and
wherein said at least one susceptor component and/or the releasable ingredient is capable of activation through radio-frequency (RF), micro-wave (MW) radiation, thermal activation, mechanical abrasion, or a combination thereof.

In another embodiment, this invention relates to a plurality of matrix particles as recited above, wherein said matrix material is derived from and/or comprises organic, monomeric, oligomeric, polymeric materials, or a combination thereof.

In yet another embodiment, this invention relates to a plurality of matrix particles as recited above, wherein said at least one susceptor and/or said at least one releasable ingredient is selected from the group consisting of fullerene compounds, graphene, graphite oxide, nanocrystalline cellulose, single-wall carbon nanotubes, multi-wall carbon nanotubes, carbon nanofibers, carbon nanotubes, doped carbon nanotubes, carbon sheets, one or more ferrous metals, oxides of one or more ferrous metals, SPIONS, one or more non-ferrous metals, oxides of one or more non-ferrous metals, transition metals, transition metal oxides, silicon carbide-based material, boron nitride, and one or more combinations thereof.

In one embodiment, this invention relates to a plurality of matrix particles as recited above, wherein the dimensions of said at least one susceptor and/or said at least one releasable ingredient are in the range of from about 0.1 nm to about 1000 μm, and optionally, said at least one susceptor and/or said at least one releasable ingredient are functionalized and/or non-functionalized.

In another embodiment, this invention relates to a plurality of matrix particles as recited above, wherein said at least one susceptor and/or said at least one releasable ingredient are in said at least one shell and wherein said at least one susceptor and said at least one releasable ingredient are in direct or indirect contact.

In yet another embodiment, this invention relates to a plurality of matrix particles as recited above, wherein the matrix particle is partially or wholly coated in one or more layers of a deformable material or a force ameliorating material, wherein, optionally, one or more of said layers contains said at least one susceptor and/or said at least one releasable ingredient.

In one embodiment, this invention relates to a plurality of matrix particles as recited above, wherein said at least one releasable ingredient is a single chemical, a combination of chemicals, organic chemicals, and/or inorganic chemicals, and wherein said at least one releasable ingredient comprises one or more catalysts, co-catalysts, co-reactants, oxidizers, reaction-inhibiting compounds, accelerators, co-accelerators, fuels, an explosives, or one or more combinations thereof.

In another embodiment, this invention relates to a plurality of matrix particles as recited above, wherein said at least one releasable ingredient is released when the matrix material or the shell is deformed, dissolved, melted, expanded, contracted, ruptured, plasticized, solvated, impacted by light, or one or more combinations thereof.

In yet another embodiment, this invention relates to a plurality of matrix particles as recited above, wherein the particle is further chemically surface-modified via one or more chemical reactions, optionally comprising said at least one releasable ingredient, and optionally then forming a partial or complete coating.

In one embodiment, this invention relates to a plurality of matrix particles as recited above, possessing a chemical functionality, wherein said at least one releasable ingredient comprises a chemically functional monomer, wherein the matrix material comprises a polymerized material, and optionally, the matrix particle is coated with a polymerized coating.

In another embodiment, this invention relates to a plurality of matrix particles as recited above, wherein the one or more alterable matrix material comprises a wax, one or more of polymethyl methacrylate (PMMA), styrene, or one or more polymers or copolymers thereof.

In yet another embodiment, this invention relates to a process for preparing the plurality of matrix particle as recited above, using the process A, B, C, D, or a combination thereof, wherein:
(A) comprises emulsion, dispersion, and/or suspension polymerization; or
(B) comprises core-shell polymerization; or
(C) comprises copolymerization, wherein said copolymerization step comprises emulsion, dispersion, suspension polymerization or combinations thereof;
(D) comprises the following steps:
(i) coating a polymeric microparticle with a material comprising susceptors and releasable ingredient,
(ii) encapsulating a microparticle in which susceptor and releasable ingredients are embedded, with a monomeric, oligomeric, or a polymeric or a polymeric material, and/or
(iii) amalgamating the susceptors and releasable ingredients, and
(iv) entrapping the susceptors and releasable ingredients into external pores on the surface or internal pores in the core of the porous microspheres; OR a combination of A, B, C, and D.

In one embodiment, this invention relates to a process for impacting a chemical reaction or a process for releasing at least one releasable ingredient from a plurality of matrix particles, comprising:
(i) providing a bulk reaction mixture;
(ii) providing matrix particles as recited above;
(iii) incorporating said plurality of matrix particles in the bulk reaction mixture; and
(iv) optionally incorporating said plurality of matrix particles in said bulk reaction mixture, and impinging the bulk reaction mixture with at least one frequency of RF radiation and/or at least one frequency of MW radiation, at least once, on to thermally activate said susceptor component embedded within the matrix particles;
heating said bulk reaction mixture comprising said plurality of matrix particles;
mechanically abrade said bulk reaction mixture comprising said plurality of matrix particles; or a combination thereof.

In another embodiment, this invention relates to a plurality of matrix particles as recited above, wherein the CNT are incorporated into the matrix particle by the process recited above.

In yet another embodiment, this invention relates to an article comprising the plurality of matrix particles as recited above.

In one embodiment, this invention relate to an article prepared as recited above, that is in whole or in part:
(i) a polymerizable composition or several polymerizable compositions of at least one chemistry;
(ii) a reinforced composite article;
(iii) a laminated article;
(iv) a rigid laminated article;
(v) a flexible laminated article;
(vi) a foam; or a
(vii) combination thereof.

In another embodiment, this invention relates to a plurality of matrix particles as recited above, wherein said composition is an adhesive, sealant, coating, paint, ink, plastic, molded plastic, thermoset plastic, molded thermoset plastic, or other polymer forming composition, in whole or part.

In yet another embodiment, this invention relates to a plurality of matrix particles as recited above, wherein the releasable ingredient is a catalyst selected from the group consisting of transition metal complexes; transition metal alkoxides; stannous (II) bis(2-ethylhexanoate); carboxylates, alkoxide, and complexes of stannous, bismuth, zinc, titanium; blocked super acids; dodecyl benzene sulphonic acids; dinonyl naphthalene sulphonic acids; N,N′,N″-tris(dimethylaminopropyl) hexahydrotriazine; organic bases; 1,8-diazabicyclo [5.4.0] undec-7-ene; 1,5-diazabicyclo [4.3.0] nonene-5); (1,4-diazabicylo 2.2.2 octane); and combinations thereof.

In one embodiment, this invention relates to a multilayer polymer composition comprising a first plurality of matrix particles as recited above, and one or more additional plurality of matrix particles as recited above, disposed upon the first matrix particle forming one or more matrix particle layers.

In another embodiment, this invention relates to precursor, intermediate, or final monomeric, oligomeric, or polymeric composition, comprising a plurality of matrix particles as recited above, wherein the composition is solid state polymerized or is prepared from a reactive hot-melt formulation.

In yet another embodiment, this invention relates to a plurality of matrix particles as recited above, wherein the plurality of matrix particles comprises carbon nanotubes, wherein the carbon nanotubes are coated on the matrix particle and/or are contained in the matrix particle.

In one embodiment, this invention relates to a plurality of matrix particles as recited above, wherein the CNT are incorporated into the plurality of matrix particles by the process of amalgamation.

In another embodiment, this invention relates to a plurality of matrix particles as recited above, wherein matrix particle is further coated with functional nano-particle emulsions.

In yet another embodiment, this invention relates to a plurality of matrix particles as recited above, wherein matrix particle is further coated with monofunctional reactive materials or with di-reactive materials.

In one embodiment, this invention relates to a precursor, intermediate, or final monomeric, oligomeric, or polymeric composition, comprising a plurality of matrix particles according to any one of the claims as recited above; optionally wherein the composition is prepared from a functionalized polymer formulation and optionally wherein the composition is prepared as a reactive blend with non-reactive polymers or oligomers.

In another embodiment, this invention relates to a process for impacting a chemical reaction, comprising:
(i) providing a bulk reaction mixture;
(ii) providing a plurality of matrix particles as recited above;
(ii) incorporating said plurality of matrix particles in said bulk reaction mixture, and impinging the bulk reaction mixture with at least one frequency of RF radiation and/or at least one frequency of MW radiation, at least once, on to thermally activate said susceptor component embedded within the matrix particles;
heating said bulk reaction mixture comprising said plurality of matrix particles;
mechanically abrade said bulk reaction mixture comprising said plurality of matrix particles; or a combination thereof;
wherein the bulk reaction mixture is a precursor or intermediate monomeric, oligomeric, or polymeric composition for solid state polymerization;
wherein the bulk reaction mixture is a precursor or intermediate monomeric, oligomeric, or polymeric composition for reactive hot-melt formulation;
wherein the bulk reaction mixture is a precursor or intermediate monomeric, oligomeric, or polymeric composition for a reactive blend with non-reactive polymers or oligomers; or
wherein the bulk reaction mixture is a precursor or intermediate monomeric, oligomeric, or polymeric composition for a functionalized polymer formulation.

In yet another embodiment, this invention relates to a process to increase the overall loading of CNTs in a bulk physically or chemically alterable composition, by the process recited in the above process.

In one embodiment, this invention relates to a process to maintain lower viscosity upon adding of at least one additive in a bulk physically or chemically alterable composition comprising incorporating said at least one additive as at least one releasable ingredient in the plurality of matrix particles as recited above, and incorporating said plurality of matrix particles in the bulk physically or chemically alterable composition.

In another embodiment, this invention relates to a process for increasing the overall loading of additives in a bulk physically or chemically alterable composition, comprising:
(i) providing said bulk physically or chemically alterable composition;
(ii) incorporating said at least one additive in a plurality of matrix particles as recited in above, as a releasable ingredient;
(ii) incorporating said plurality of matrix particles in said bulk physically or chemically alterable composition, and impinging said bulk physically or chemically alterable composition with at least one frequency of RF radiation and/or at least one frequency of MW radiation, at least once, to thermally activate said susceptor component embedded within the matrix particles;
heating said bulk physically or chemically alterable composition comprising said plurality of matrix particles;
mechanically abrade said bulk physically or chemically alterable composition comprising said plurality of matrix particles; or a combination thereof;
optionally wherein the bulk physically or chemically alterable composition is a precursor or intermediate monomeric, oligomeric, or polymeric composition for reactive hot-melt formulation, adhesives, coatings, composites, are a combination there of.

In yet another embodiment, this invention relates to a process to maintain lower viscosity upon adding of at least one additive in a bulk physically or chemically alterable composition, comprising the steps of:
(i) providing said bulk physically or chemically alterable composition:
(ii) incorporating said at least one additive in a plurality of matrix particles as recited above, as a releasable ingredient;
(ii) incorporating said plurality of matrix particles in said bulk physically or chemically alterable composition, and impinging said bulk physically or chemically alterable composition with at least one frequency of RF radiation and/or at least one frequency of MW radiation, at least once, to thermally activate said susceptor component embedded within the matrix particles;
heating said bulk physically or chemically alterable composition comprising said plurality of matrix particles;
mechanically abrade said bulk physically or chemically alterable composition comprising said plurality of matrix particles; or a combination thereof;
optionally wherein the bulk physically or chemically alterable composition is a precursor or intermediate monomeric, oligomeric, or polymeric composition for reactive hot-melt formulation, adhesives, coatings, composites, are a combination there of.

In another embodiment, this invention relates to a plurality of matrix particles as recited above, wherein the releasable ingredient is a catalyst for curing, polymerizing, reacting acrylates, silane-terminated polymers, hydrolysis, condensation catalysts, isocyanate trimerization, 1K moisture cure isocyanates, melamine crosslinked systems, 2K polyurethanes, 1K blocked isocyanate-based polyurethanes, epoxy, esterification, and transesterifications.

In one embodiment, this invention relates to a matrix particle, comprising:
(i) a matrix material, wherein said matrix is capable of fully or partially altering its physical characteristics;
(ii) at least one susceptor component, wherein said at least one susceptor component is embedded in said matrix material, and wherein said at least one susceptor component is capable of thermal activation through electromagnetic radiation; and
(iii) at least one releasable and/or activatable ingredient embedded in said matrix and in proximity to said susceptor component, wherein said at least one releasable and/or activatable ingredient is capable of impacting a chemical reaction.

In another embodiment, this invention relates to a matrix particle as recited above, comprising one or more matrices that fit in discrete zones, said discrete zones being in one or more shape; wherein the discrete zones comprise coatings or varied layers; wherein each zone comprises from about zero to multiple susceptors and/or releasable ingredients; and wherein the matrix particle, in the aggregate, has at least one zone comprising a susceptor and at least one zone containing a releasable ingredient.

In yet another embodiment, this invention relates to a matrix particle as recited above, wherein said matrix is derived from and/or contains organic, inorganic, monomeric, oligomeric, polymeric materials, or a combination thereof.

In another embodiment, this invention relates to a matrix particle as recited above, wherein said at least one susceptor is selected from the group consisting of fullerene compounds, graphene, single-wall carbon nanotubes, multi-wall carbon nanotubes, carbon nanofibers, carbon nanotubes, doped carbon nanotubes, carbon sheets, one or more ferrous metals, oxides of one or more ferrous metals, super paramagnetic iron oxides (SPIONs), one or more non-ferrous metals, oxides of one or more non-ferrous metals, transition metals, transition metal oxides, silicon carbide-based material, boron nitride, and one or more combinations thereof.

In yet another embodiment, this invention relates to a matrix particle as recited above, wherein the dimensions of the susceptor are in the range of from about 0.1 nm to about 1000 μm.

In one embodiment, this invention relates to a matrix particle as recited above, wherein the susceptors comprise functionalized susceptors, non-functionalized susceptors, or both functionalized and non-functionalized susceptors.

In another embodiment, this invention relates to a matrix particle as recited above, wherein the susceptor is in the geometric center of a matrix material in direct or indirect contact with the susceptor.

In yet another embodiment, this invention relates to a matrix particle as recited above, wherein the susceptor and/or the releasable ingredient are in an outer layer of the matrix particle, wherein the susceptor and the releasable ingredient are in direct or indirect contact.

In one embodiment, this invention relates to a matrix particle as recited above, wherein the matrix particle are partially or wholly coated in one or more layers of a deformable material.

In another embodiment, this invention relates to a matrix particle as recited above, where the matrix particle is are partially or wholly coated in one or more layers of a deformable material wherein one or more of said layers contains a susceptor and or a releasable ingredient.

In yet another embodiment, this invention relates to a matrix particle as recited above, wherein the matrix material contains no susceptors or releasable ingredient.

In one embodiment, this invention relates to a matrix particle as recited above, wherein said at least one releasable and/or activatable ingredient is a single chemical, a combination of chemicals, organic chemicals, and/or inorganic chemicals.

In another embodiment, this invention relates to a matrix particle as recited above, wherein said chemical ingredient comprises one or more catalysts, co-catalysts, co-reactants, oxidizers, reaction-inhibiting compounds, accelerators, fuels, explosives, or one or more combinations thereof.

In yet another embodiment, this invention relates to a matrix particle as recited above, wherein the releasable ingredient is released when the matrix is deformed, dissolved, melted, expanded, contracted, ruptured, plasticized, solvated, or one or more combinations thereof.

In one embodiment, this invention relates to a matrix particle as recited above, wherein the electromagnetic radiation frequency is in the range of from about 300 MHz to about 300 GHz.

In another embodiment, this invention relates to a matrix particle as recited above, wherein the electromagnetic radiation frequency is in the range of from about 915 MHz to about 2.450 MHz.

In yet another embodiment, this invention relates to a matrix particle as recited above, wherein the electromagnetic radiation frequency is in the range of from about 915 MHz to about 2.450 MHz and/or the power is in the range of 1-10,000 W.

In another embodiment, this invention relates to a matrix particle as recited above, wherein the matrix particle is subjected to electromagnetic radiation frequency as described above for 10 seconds to 60 minutes.

In one embodiment, this invention relates to a matrix particle as recited above, wherein said matrix is optionally supported with a support comprising a metal, a ceramic, or a glass.

In another embodiment, this invention relates to a matrix particle as recited above, wherein the particle is further chemically surface modified via one or more chemical reactions, optionally comprising a releasable ingredient, optionally then forming a partial or complete coating.

In yet another embodiment, this invention relates to a matrix particle as recited above, further possessing a chemical functionality.

In one embodiment, this invention relates to a matrix particle as recited above, wherein the releasable ingredient comprises a chemically functional monomer, wherein the matrix material comprises a polymerized material, and optionally, the matrix particle is coated with a polymerized coating.

In another embodiment, this invention pertains to a process for preparing the matrix particle as recited above, the process steps comprising:
(i) emulsion, dispersion, and/or suspension polymerization, or
(ii) core-shell polymerization.

In yet another embodiment, this invention pertains to a process for preparing the matrix particle as recited above, the process comprising:
(i) coating a polymeric microparticle with a material comprising susceptors and releasable ingredients,
(ii) encapsulating a microparticle in which susceptors and releasable ingredients are embedded, with a monomeric, oligomeric, or a polymeric material,
(iii) amalgamating the susceptors and releasable ingredients, and/or
(iv) entrapping the susceptors and releasable ingredients into external pores on the surface or internal pores in the core of the porous microspheres.

In one embodiment, this invention pertains to a process for preparing the matrix particle as recited above, the process steps comprising copolymerization, wherein said copolymerization step comprises emulsion, dispersion, suspension polymerization or combinations thereof.

In one embodiment, this invention pertains to a process for impacting a chemical reaction, comprising:
(i) providing a bulk reaction mixture;
(ii) providing matrix particles as recited above; and
(iii) incorporating the matrix particles in the bulk reaction mixture.

In another embodiment, this invention pertains to a process for impacting a chemical reaction as recited above, further comprising:
(iv) impinging the bulk reaction mixture with at least one frequency of RF radiation and/or at least one frequency of MW radiation, at least once, on to thermally activate said susceptor component embedded within the matrix particles.

In yet another embodiment, this invention pertains to a process for impacting a chemical reaction as recited above, wherein the impinging of the at least one frequency of RF radiation and/or at least one frequency of MW radiation is performed periodically, wherein the period is regular or irregular.

In one embodiment, this invention pertains to a process for impacting a chemical reaction as recited above, wherein the electromagnetic radiation comprises wavelengths ranging from about one meter to one millimeter; and frequencies ranging between 50 MHz and 30 GHz.

In another embodiment, this invention pertains to a process for impacting a chemical reaction as recited above, wherein the electromagnetic radiation frequency is in the range of from about 915 MHz to about 2.450 MHz.

In yet another embodiment, this invention pertains to a process for impacting a chemical reaction as recited above, wherein the electromagnetic radiation frequency is in the range of from about 915 MHz to about 2.450 MHz and/or the power is in the range of 1-10,000 W.

In one embodiment, this invention pertains to a process for impacting a chemical reaction as recited above, wherein said reaction is a polymerization reaction.

In another embodiment, this invention relates to a process for releasing a releasable ingredient from a matrix particle as recited above, comprising:
(a) dispersing said matrix particles in a bulk reaction mixture; and
(b) impinging the bulk reaction mixture with at least one frequency of RF radiation and/or at least one frequency of MW radiation, at least once, to thermally activate said susceptor component embedded within the matrix particles.

In yet another embodiment, this invention relates to the matrix particle as described above, wherein the one or more alterable matrix material comprises a wax, one or more of polymethyl methacrylate (PMMA), styrene, or one or more polymers or copolymers thereof.

In one embodiment, this invention relates to the matrix particle as described above, wherein the at least one releasable chemical ingredient comprises an activator or catalyst.

In another embodiment, this invention relates to the matrix particle as described above, wherein the catalyst comprises one or more of Cu-acetyl acetonate, Cu-2-ethyl hexanoate, ferrocene, dimethylaminomethyl ferrocene, or one or more combinations thereof.

In yet another embodiment, this invention also relates to an article prepared using the process as described above.

In yet another embodiment, this invention relates to an article prepared using a process as recited above, that is in whole or in part:
(i) a polymerizable composition or several polymerizable compositions of at least one chemistry;
(ii) a reinforced composite article;
(iii) a laminated article;
(iv) a rigid laminated article;
(v) a flexible laminated article;
(vi) a foam; or a
(vii) combination thereof.

In one embodiment, this invention also relates to a composition comprising the matrix particle as recited above, wherein said composition is an adhesive, sealant, coating, paint, ink, plastic, molded plastic, thermoset plastic, molded thermoset plastic, or other polymer forming composition, in whole or part.

In another embodiment, this invention relates to the matrix particle as recited in above, wherein the releasable and/or activatable ingredient is a catalyst selected from the group consisting of transition metal complexes; transition metal alkoxides; stannous (II) bis(2-ethylhexanoate); carboxylates, alkoxide, and complexes of stannous, bismuth, zinc, titanium; blocked super acids; dodecyl benzene sulphonic acids; dinonyl napthalene sulphonic acids; N,N′,N″-tris(dimethylaminopropyl) hexahydrotriazine; organic bases; 1,8-diazabicyclo [5.4.0] undec-7-ene; 1,5-diazabicyclo [4.3.0] nonene-5); (1,4-diazabicylo 2.2.2 octane); and combinations thereof.

In one embodiment, this invention relates to a matrix particle as recited above, wherein the matrix particle comprises carbon nanotubes, wherein the carbon nanotubes are coated on the matrix particle and/or are contained in the matrix particle.

In one embodiment, this invention relates to a matrix particle as recited above, wherein the CNT are incorporated into the matrix particle by the process of amalgamation.

In one embodiment, this invention relates to a matrix particle as recited above, wherein matrix particle is further coated with functional nano-particle emulsions.

In one embodiment, this invention relates to a matrix particle as recited above, wherein matrix particle is further coated with monofunctional reactive materials.

In one embodiment, this invention relates to a matrix particle as recited above, wherein matrix particle is further coated with di-reactive materials.

In one embodiment, this invention relates to a precursor, intermediate, or final monomeric, oligomeric, or polymeric composition, comprising a matrix particle according to above recitation.

In one embodiment, this invention relates to a precursor, intermediate, or final monomeric, oligomeric, or polymeric composition, comprising a matrix particle according to the above recitation, wherein the composition is prepared from a functionalized polymer formulation.

In one embodiment, this invention relates to a precursor, intermediate, or final monomeric, oligomeric, or polymeric composition, comprising a matrix particle according to the above recitation, wherein the composition is prepared as a reactive blend with non-reactive polymers or oligomers.

In one embodiment, this invention relates to a process for impacting a chemical reaction, comprising:
(i) providing a bulk reaction mixture;
(ii) providing matrix particles as recited in any one of the preceding claims;
(iii) incorporating the matrix particles in the bulk reaction mixture; and
(iv) impinging the bulk reaction mixture with at least one frequency of RF radiation and/or at least one frequency of MW radiation, at least once, on to thermally activate said susceptor component embedded within the matrix particles;
wherein the bulk reaction mixture is a precursor or intermediate monomeric, oligomeric, or polymeric composition for solid state polymerization.

In one embodiment, this invention relates to a process for impacting a chemical reaction, comprising:
(i) providing a bulk reaction mixture;
(ii) providing matrix particles as recited above;
(iii) incorporating the matrix particles in the bulk reaction mixture; and
(iv) impinging the bulk reaction mixture with at least one frequency of RF radiation and/or at least one frequency of MW radiation, at least once, on to thermally activate said susceptor component embedded within the matrix particles;
wherein the bulk reaction mixture is a precursor or intermediate monomeric, oligomeric, or polymeric composition for reactive hot-melt formulation.

In one embodiment, this invention relates to a process for impacting a chemical reaction, comprising:
(i) providing a bulk reaction mixture;
(ii) providing matrix particles as recited above;
(iii) incorporating the matrix particles in the bulk reaction mixture; and
(iv) impinging the bulk reaction mixture with at least one frequency of RF radiation and/or at least one frequency of MW radiation, at least once, on to thermally activate said susceptor component embedded within the matrix particles;
wherein the bulk reaction mixture is a precursor or intermediate monomeric, oligomeric, or polymeric composition for a functionalized polymer formulation.

In one embodiment, this invention relates to a process for impacting a chemical reaction, comprising:
(i) providing a bulk reaction mixture;
(ii) providing matrix particles as recited above;
(iii) incorporating the matrix particles in the bulk reaction mixture; and
(iv) impinging the bulk reaction mixture with at least one frequency of RF radiation and/or at least one frequency of MW radiation, at least once, on to thermally activate said susceptor component embedded within the matrix particles;
wherein the bulk reaction mixture is a precursor or intermediate monomeric, oligomeric, or polymeric composition for a reactive blend with non-reactive polymers or oligomers.

In one embodiment, this invention relates to a process as recited above, wherein the impinging of the at least one frequency of RF radiation and/or at least one frequency of MW radiation is performed periodically, wherein the period is regular or irregular.

In another embodiment, this invention relates to a process as recited above, wherein the electromagnetic radiation comprises wavelengths ranging from about one meter to one millimeter; and frequencies ranging between 50 MHz and 30 GHz.

In yet another embodiment, this invention relates to a process as recited above, wherein the electromagnetic radiation frequency is in the range of from about 915 MHz to about 2.450 MHz.

In one embodiment, this invention relates to a process as recited above, wherein the electromagnetic radiation frequency is in the range of from about 915 MHz to about 2.450 MHz and/or the power is in the range of 1-10,000 W.

In another embodiment, this invention relates to a process as recited above, wherein the electromagnetic radiation is impinged for 10 seconds to 60 minutes.

In yet another embodiment, this invention relates to a process as recited above, wherein said reaction is a polymerization reaction.

In one embodiment, this invention relates to a process to increase the overall loading of CNTs in a reaction mixture, by the process recited above.

In one embodiment, this invention relates to a process to maintain lower viscosity upon adding of additives in a reaction mixture comprising incorporating the additives in a matrix particle as recited above, and incorporating the matrix particles in the bulk reaction mixture.

In one embodiment, this invention relates to a process for increasing the overall loading of additives in a chemical reaction, comprising:
(i) providing a bulk reaction mixture;
(ii) providing matrix particles comprising additives as recited above;
(iii) incorporating the matrix particles in the bulk reaction mixture; and
(iv) impinging the bulk reaction mixture with at least one frequency of RF radiation and/or at least one frequency of MW radiation, at least once, on to thermally activate said susceptor component embedded within the matrix particles;
wherein the bulk reaction mixture is a precursor or intermediate monomeric, oligomeric, or polymeric composition for reactive hot-melt formulation.

In one embodiment, this invention relates to a process to maintain lower viscosity upon adding of additives in a reaction mixture comprising reducing van der Waals forces between the additives and the bulk reaction mixture, comprising the steps of incorporating the additives in a matrix particle as recited above, incorporating the matrix particles in the bulk reaction mixture, and impinging the bulk reaction mixture with at least one frequency of RF radiation and/or at least one frequency of MW radiation, at least once, on to thermally activate said susceptor component embedded within the matrix particles;

wherein the bulk reaction mixture is a precursor or intermediate monomeric, oligomeric, or polymeric composition for reactive hot-melt formulation.

Surprisingly, it has been found that nano and micro particles can serve as carriers for more effectively delivering nanomaterials into sealants, coatings, composites, adhesives, and other polymeric products. Of particular interest are where physical properties of an end composition and or physical product are achieved, including, but not limited to, thermal and electrical conductivity, improved and or controlled strength, toughness, elasticity, chemical resistance, environmental resistance, energy dampening and the like and improved or con-trolled product life and or failure.

The invention is specifically, but not limited to, particles carrying layers of, filled with or otherwise nanomaterials, including metals and their chemical products, graphene, nanotubes and like structures for the benefit of improved physical, electrical, conductive and other like properties minimizing by example the need for more significant amounts of said nanomaterials.

Optionally, crosslinking chemistries can be incorporated into or on the surface of said particles, either simply using surface chemistry or as ligand or oligomeric like structures capable of even further enhancing noted physical performance.

Specifically, one can incorporate within and or coat polymer-based particles with nanomaterials such as nanotubes or like structures, specifically by example carbon nanotubes and or graphene or like structures. This basic concept helps to limit among other things overall amounts of material required, can provide a large surface area containing said structures through which forces to separate are spread, limits agglomeration and so on. Where the nano and or micro particles are coated with van der Waals and other physical or chemical force ameliorating coating, these effects can be further ameliorated and or amplified and controlled as desired.

Literature notes the coating of said particles with by example carbon nanotubes or the coating of individual nanotubes. Here, we differentiate by coating particles with nanotubes and then coating with force-ameliorating compositions, incorporate more than one and preferably three or more nanotubes and or then coating with force ameliorating compositions.

Optionally, one can incorporate within the particles and or their coatings if any chemical functionalization for either subsequent reaction or physical effects. Examples of chemical reactions are myriad, and not limited, but include crosslinking and or polymerization reactions. Physical effect can include ligand, polymeric and or oligomeric structures for, by example, physical combining with a surrounding polymer matrix or in the case of a metallic or soapy ligand, dispersion or inclusion into emulsions, dispersions and the like, in solvent, water or otherwise. The optional inclusion—See U.S. patent application Ser. No. 18/055,302 to Malofsky et.al., which is incorporated by reference as if it is fully set forth herein,—of catalysts, co-catalyst, accelerators, fuels, energetic materials and the like are included in said invention.

An additional objective of the present invention is to provide polymeric nano and microparticles with functionalities on surfaces that can irreversibly/reversibly diminish when the composition containing polymer microparticles is applied to compositions containing sealants, composites, adhesives, other polymeric products and the like.

Other objective is to provide functionalities capable of non-covalent bonding such as hydrogen bonding or van der Waals when the composition containing polymer microparticles are applied in the composition for sealants, composites, adhesives, and other polymeric products.

In general, these functional nano and microparticles are versatile platforms with tunable properties that can be tailored to meet specific application requirements. These functional nano and microparticles find use in many application, including, but not limited to adhesives, composites, laminates, sealants, coatings, inks, plastics and the like in many final products across many consumer, industrial and or medical applications.

The functional nano microparticles include latex particles, nano and microgel particles, colloidal particles, including but not limited to colloidal particles composed of polymer chains that are dispersed in water or other solvents. Also included are microgel particles that can swell or shrink in response to changes in their environment.

The functional microparticles containing reactive functional groups such as carboxylic acids, amino groups, thiol, epoxy, acrylics, isocyanates can be cross-linked with other functionalized particles.

In the coating, crosslinked polymer microparticles are used to produce compositions that contain a high solids content and/or to improve the rheological properties.

Polymers with functional microparticles, such as waterborne polyurethanes (WPU), polyester dispersions (PED), and polyacrylate emulsions (PAE), which are commonly used in wood coatings, metal coatings, printing inks, architectural coatings, and plastic coatings. Despite their inherent advantages, polymers have some drawbacks, such as low mechanical strength, low hardness, high water sensitivity, and heat softening. Water borne reactions have a relatively slow reaction rate and can also cause health hazards because of the release and use of hydrazine, formaldehyde, and other toxic chemistries.

In addition to making the polymer particles dispersible in liquids, the surface functionalities eliminate slow reactivity, and the need to accelerate reactions using toxic chemistries.

With a core and shell configuration, the nanomaterials present in the core and cross-linkable functionalities on the shell help protect the CNTs until secondary processing is carried out. Nanomaterials released will increase interaction and crosslinking densities due to van der Waals forces.

As another aspect of the invention, the present invention provides a microparticle composition consisting of nanomaterials, catalysts, crosslinkers in the cores, and functionalities on the shells. Further objectives of the invention can be achieved by producing microparticles with particle sizes ranging from 0.01 to 10 microns, as well as by modifying preexisting microparticles.

Further objectives of the invention can be achieved by producing nano and micro-particles with particle sizes ranging from 0.01 to 100 microns, including modifying preexisting microparticles.

Polymer microparticles of this invention are engineered into specific shapes, sizes, and surface chemistries, so that hybrids of organic and inorganic materials can be created.

A further aspect of the present invention provides a method for manufacturing the cross-linked polymer microparticles with nanomaterials embedded within them. Also, the cross-linked microparticles can be delivered in a masterbatch or as standalone particles.

A covalent adaptable network (CAN) is a polymer material that has covalent bonds that can be broken and reformed under certain conditions. Materials with reversible or tunable properties, such as mechanical strength or viscosity, can be developed in this way.

The low entropy of the functional groups on the microparticles enhances the chance of CAN formation in comparison with conventional crosslinkers. Carbon Nanotubes and Graphene on the surface of functional microparticles provide additional anchoring sites for CAN formation.

These cross-linkable, reversible groups attached to microparticles help to create self-healing coatings, adhesives, composites, and structural materials through CANs.

Functional groups on microparticles used in PSA (Pressure Sensitive Adhesives) improve their tack, making them more readily adhere to surfaces. Functional microparticles provide additional contact points between the adhesive and the substrate, reducing the chance of creep failure over time.

The addition of nanomaterials with high modulus such as CNTs and graphene, enhances the resistance to deformation.

Pressure causes the functional particles to collapse in PSAs, releasing the chemistry, facilitating further crosslinking with the substrate, and enhancing adhesion. Functional microparticles provide a tunable bond line thickness. Microparticles can, for example, increase an adhesive's viscosity, which improves its shear strength and prevents it from flowing.

A further aspect of the invention relates to superior thermal and electrical conductivity using materials more efficiently and incorporating them with a lower viscosity by creating an apparently honeycomb network allowing for a final polymer based, highly conductive product.

### BRIEF DESCRIPTION OF DRAWINGS

In the drawings, which are not necessarily drawn to scale, like numerals can describe similar components in different views. Like numerals having different letter suffixes can represent different instances of similar components. The drawings illustrate generally, by way of example, but not by way of limitation, various aspects discussed in the present document. In the drawings:

FIG. 1 depicts a schematic of the process of the present invention.

FIGS. 2A and 2B depict the reaction injection molding process currently available, and the process as simplified by the present invention, respectively.

FIGS. 3A and 3B depict a film-laminating adhesives currently available and the process simplified as a result of the invention, respectively.

FIG. 4 depicts exemplary general structures of matrices of the invention as contemplated herein as well as coated matrices.

FIGS. 5A and 5B depict exemplary compositional structures of the matrices of the invention as contemplated herein.

FIG. 6 depicts exemplary matrices and coated matrices of the invention as contemplated herein. The matrices can be coated on objects or positioned within coatings on various objects.

FIG. 7 depicts scanning electron micrograph (SEM) images of exemplary hollow particles.

FIG. 8 depicts SEM images of exemplary hollow particles plus SPIONs plus copper.

FIG. 9 depicts an SEM image of the commercial PMMA (MX 500-ML, Soken) coated with carbon nanotubes (CNTs).

FIG. 10 is a graph of heating curves using carbon nanostructure (CNS) susceptors.

FIG. 11 is a diagram showing the selective placement of susceptors in the shell on the particles of the present invention.

FIG. 12 is a diagram showing a sheet created through non-covalent interactions.

FIG. 13 depicts a schematic of functionalized CNTs located in the shell of the particles of the present invention.

FIG. 14 depicts a diagram showing the post-functionalization of microparticles for chelating a catalyst.

FIG. 15 depicts a schematic showing the entrapment of CNTs and susceptors using a micellar microparticle.

FIG. 16 depicts a schematic showing entrapment of a catalyst on microparticles and CNTs in a micelle.

FIG. 17 depicts a diagram of the chelation of a catalyst and entrapment of a susceptor using a micellar microparticle.

FIG. 18 depicts core shell particles generated using commercial aqueous emulsions.

FIG. 19 depicts the matrix particles (a core) as carriers for delivering CNTs into the different matrices.

FIG. 20 depicts a plot of the resistivity versus the CNS loading that indicates a steady drop of resistivity from 1.0×10¹³ to 6.0×10³ ohm at a CNT loading of 0 to 3.2%.

### DETAILED DESCRIPTION OF THE INVENTION

Generally, speaking, and in one aspect, this invention relates to matrix particles that comprise a matrix material, susceptors and releasable ingredient, defined infra. In some embodiments, these particles are in a core-shell configuration, or just a core. The core is capable of altering its physical or chemical form, which allows for the release of the releasable ingredient. When the particle is in a core-shell configuration, there can be one or more shell. The susceptor can be in none or one or more than one shells. Similarly, the releasable ingredient can be in none or one or more than one shells. So the shells are physically or chemically alterable materials such as oligomeric or polymeric materials. The presence of the susceptor in the matrix particle is optional. Such matrix particles are mixed in a physical or chemical composition of interest that needs to be physically or chemically impacted by the mixing with the matrix particles and applying an external force such as radio frequency or heat that will alter the matrix particle and release the releasable ingredient into the physical or the chemical mixture or composition.

The present invention generally relates to matrix microparticles and nanoparticles. While the invention herein is discussed in terms of microparticles, it applies equally to nano-particles.

A plurality of matrix particles, comprising a matrix particle A and/or a matrix particle B: wherein, said matrix particle A comprises a core and optionally, at least one shell, wherein said core comprises: (i) a matrix material, wherein said matrix material is capable of fully or partially altering its physical and/or chemical characteristics; (ii) at least one susceptor component, wherein said at least one susceptor component is embedded in said matrix material; and (iii) at least one releasable ingredient, wherein said at least one releasable ingredient is embedded in said matrix material, wherein said at least one releasable ingredient is capable of impacting physically or chemically a bulk physically or chemically alterable composition with which said plurality of matrix particles is contacted, and wherein said at least one shell comprises: (iv) optionally, said at least one susceptor component, wherein said at least one susceptor component is embedded in said at least one shell; and (v) at least one releasable ingredient, wherein said at least one releasable ingredient is embedded in said at least one shell, wherein said at least one releasable ingredient is capable of impacting physically or chemically said bulk physically or chemically alterable composition with which said plurality of matrix particles is contacted;
AND
wherein said matrix particle B comprises a core and optionally, at least one shell, wherein said core comprises: (vi) a matrix material, wherein said matrix material is capable of fully or partially altering its physical and/or chemical characteristics; and (vii) at least one releasable ingredient, wherein said at least one releasable ingredient is embedded in said matrix material, wherein said at least one releasable ingredient is capable of impacting physically or chemically said bulk physically or chemically alterable composition with which said plurality of matrix particles is contacted; and wherein said at least one shell comprises: (viii) optionally, said at least one susceptor component, wherein said at least one susceptor component is embedded in said at least one shell; and (ix) said at least one releasable ingredient, wherein said at least one releasable ingredient is embedded in said at least one shell, wherein said at least one releasable ingredient is capable of impacting physically or chemically said bulk physically or chemically alterable composition with which said plurality of matrix particles is contacted; and wherein said at least one susceptor component and/or the releasable ingredient is capable of activation through radio-frequency (RF), micro-wave (MW) radiation, thermal activation, mechanical abrasion, or a combination thereof.

In one embodiment, this invention relates to a plurality of matrix particles, comprising matrix particle A, wherein, said matrix particle A comprises a core and optionally, at least one shell, wherein said core comprises:
(i) a matrix material, wherein said matrix material is capable of fully or partially altering its physical and/or chemical characteristics;
(ii) at least one susceptor component, wherein said at least one susceptor component is embedded in said matrix material; and
(iii) at least one releasable ingredient, wherein said at least one releasable ingredient is embedded in said matrix material, wherein said at least one releasable ingredient is capable of impacting physically or chemically a bulk physically or chemically alterable composition with which said plurality of matrix particles is contacted, and wherein said at least one shell comprises:
(iv) optionally, said at least one susceptor component, wherein said at least one susceptor component is embedded in said at least one shell; and
(v) at least one releasable ingredient, wherein said at least one releasable ingredient is embedded in said at least one shell, wherein said at least one releasable ingredient is capable of impacting physically or chemically said bulk physically or chemically alterable composition with which said plurality of matrix particles is contacted; and
wherein said at least one susceptor component and/or the releasable ingredient is capable of activation through radio-frequency (RF), micro-wave (MW) radiation, thermal activation, mechanical abrasion, or a combination thereof.

In another embodiment, this invention relates to a plurality of matrix particles, comprising matrix particle B, wherein said matrix particle B comprises a core and optionally, at least one shell, wherein said core comprises:
(vi) a matrix material, wherein said matrix material is capable of fully or partially altering its physical and/or chemical characteristics; and
(vii) at least one releasable ingredient, wherein said at least one releasable ingredient is embedded in said matrix material, wherein said at least one releasable ingredient is capable of impacting physically or chemically said bulk physically or chemically alterable composition with which said plurality of matrix particles is contacted; and wherein said at least one shell comprises:
(viii) optionally, said at least one susceptor component, wherein said at least one susceptor component is embedded in said at least one shell; and
(ix) said at least one releasable ingredient, wherein said at least one releasable ingredient is embedded in said at least one shell, wherein said at least one releasable ingredient is capable of impacting physically or chemically said bulk physically or chemically alterable composition with which said plurality of matrix particles is contacted; and wherein said at least one susceptor component and/or the releasable ingredient is capable of activation through radio-frequency (RF), micro-wave (MW) radiation, thermal activation, mechanical abrasion, or a combination thereof.

In one embodiment, this invention relates to a plurality of matrix particles, comprising matrix particle A and/or matrix particle B:
wherein, said matrix particle A comprises a core and optionally, at least one shell,
wherein said core comprises:
(i) a matrix material, wherein said matrix material is capable of fully or partially altering its physical and/or chemical characteristics;
(ii) at least one susceptor component, wherein said at least one susceptor component is embedded in said matrix material; and
(iii) at least one releasable ingredient, wherein said at least one releasable ingredient is embedded in said matrix material, wherein said at least one releasable ingredient is capable of impacting physically or chemically a physical or a chemical composition with which said plurality of matrix particles is contacted; and
wherein said at least one shell comprises:
(iv) said at least one susceptor component, wherein said at least one susceptor component is embedded in said at least one shell; and
(v) at least one releasable ingredient, wherein said at least one releasable ingredient is embedded in said at least one shell, wherein said at least one releasable ingredient is capable of impacting physically or chemically a physical or a chemical composition with which said plurality of matrix particles is contacted;
AND
wherein said matrix particle B comprises a core and optionally, at least one shell, wherein said core comprises:
(vi) a matrix material, wherein said matrix material is capable of fully or partially altering its physical and/or chemical characteristics; and
(vii) at least one releasable ingredient, wherein said at least one releasable ingredient is embedded in said matrix material, wherein said at least one releasable ingredient is capable of impacting physically or chemically a physical or a chemical composition with which said plurality of matrix particles is contacted; and wherein said at least one shell comprises:
(viii) said at least one susceptor component, wherein said at least one susceptor component is embedded in said at least one shell; and
(ix) said at least one releasable ingredient, wherein said at least one releasable ingredient is embedded in said at least one shell, wherein said at least one releasable ingredient is capable of impacting physically or chemically a physical or a chemical composition with which said plurality of matrix particles is contacted; and wherein said at least one susceptor component or and/or the releasable and/or activatable ingredient is capable of activation through radio-frequency (RF), micro-wave (MW) radiation, thermal activation, mechanical abrasion, or a combination thereof.

In another embodiment, the matrix particles described above are contacted with or incorporated or dispersed in a chemical reaction mixture with constituent reactants likely to undergo a chemical reaction, for example within monomers or oligomers of a polymerization reaction. In a further embodiment of the invention, the chemical reaction mixture with the dispersed matrix particles is impinged with radio frequency electromagnetic radiation or microwave radiation or is heated or is mechanically abraded. The EMR (Electro Magnetic Radiation) heats the susceptor component in the matrix particles. In turn, this heating releases the active ingredient, which, then, catalyzes the reaction in the reaction mixture. Therefore, the reaction starts only when the RF or the MW radiation releases the ingredients of from the matrix particle.

In another embodiment, the matrix particles described above are contacted with or incorporated or dispersed in a chemical mixture where the constituents may or may not undergo a chemical change upon contacting of the matrix particles, but a physical change, for example a change in viscosity, upon release of the releasable and/or activatable ingredient via RF/MF radiation or heating or mechanical abrasion.

### Definitions

By “alterable matrix,” or “altering matrix,” is meant that the matrix material within the matrix particle can be fully or partially deformed, dissolved, melted, expanded, contracted, ruptured, plasticized, or solvated. In other words, its physical and/or chemical form can be altered to render it amenable to releasing the active ingredient.

By “susceptor,” is meant the particle within the matrix particle that is amenable to being heated or thermally activated by the electromagnetic radiation, particularly, radio frequency and/or microwave.

By “impacting a chemical reaction,” is meant that the releasable ingredient can activate or trigger, catalyze, co-catalyze, promote, accelerate, co-accelerate, inhibit, and/or heat a chemical reaction.

By “matrix material,” or “matrix,” is meant the base material in a matrix particle in which the susceptor component and/or the releasable and/or activatable ingredients are embedded. The base material, for example, can be monomeric, oligomeric, or polymeric.

By “embedded,” is meant the susceptors or the releasable and/or activatable ingredients are encapsulated or entrapped within the matrix material, in intimate or associated contact with said matrix; for example in the pores of the matrix, or are bonded to one or more matrix materials, may be within the matrix or on one or more surfaces of the matrix material, fully encapsulated within the matrix material, or partially embedded within the matrix particle by physical adhesion, or are partially protruding at the surface of the matrix particle.

By “matrix particle,” is meant the nano or microparticle comprising a matrix material, the susceptor component, and the releasable and/or activatable ingredient, which is used for thermal activation of the bulk reaction mixture as recited in the present invention. In some embodiments, a susceptor component may not be present. In some embodiments, the susceptor itself may be the releasable and/or the activatable ingredient.

By “EM,” is meant high-frequency electromagnetic radiation such as radio frequency (RF) or microwave (MW).

By “releasable and/or activatable ingredient,” is meant the ingredient that is comprised within a matrix microparticle which plays the role of impacting the chemical reaction upon remote thermal activation of the susceptor within the matrix particle that then releases or activates the releasable and/or activatable ingredient. As an alternative to the term “releasable and/or activatable ingredient,” the term “active ingredient” or the “releasable ingredient” is used. In other words, the active ingredient embodies its releasability characteristic as well as activity characteristic. The active ingredient is an active chemical ingredient in many embodiments as described infra.

By “bulk reaction mixture,” is meant the reaction mixture that can be impacted by the matrix particle upon release of the active ingredient. In the bulk reaction mixture, the matrix particles are dispersed, to then have a remote activation of the susceptors to release the active ingredient, for example, to catalyze the bulk reaction mixture. As a matter of example, the bulk reaction mixture can be a pre-polymerization material, and even post-polymerization materials to increase molecular weight, for example, any other chemical reaction such as an organic or an inorganic, or a combined organic-inorganic reaction. The bulk reaction mixture can be clear, translucent, or opaque. Or the bulk reaction mixture can change its transparency as the reaction progresses.

By “precursor” when used in the reaction mixture context is meant a reaction mixture that is likely to progress to its next form of “intermediate” reaction mixture. In one embodiment, the precursor reaction mixture can be monomeric, oligomeric, polymeric, or a mixture of one or more.

By “intermediate” when used in the reaction mixture context is meant a reaction mixture that is a result of a precursor reaction mixture that has been chemically and/or physically transformed to the next phase, and which may further be chemically and/or physically transformed into the final phase of the reaction. In one embodiment, the intermediate reaction mixture can be monomeric, oligomeric, polymeric, or a mixture of one or more.

By “core” is meant that portion of the matrix particle that comprises the matrix material and in which susceptors and/or the releasable ingredient are embedded.

By “shell” is meant that portion of the matrix particle that fully or partially covers the core. It is made up of monomeric, oligomeric, or polymeric material and can have susceptors and/or the releasable ingredient embedded in it. The shell is alterable in that it can allow for the release of the releasable ingredient. In one embodiment, the shell may act as a force-ameliorating material at the time of the introduction of the matrix particle into a chemical or physical mixture that needs to be chemically and/or physically altered. Later, the shell can be alterable by external force as an when needed, for example, through RF, MF, mechanical shear, heat, or a combination of these techniques. In one embodiment, the shell is also made from the matrix material similar or different from the core.

By “polymeric brush particles” is meant particles that have a dense layer of polymer chains attached to their surface, resembling a brush in appearance.

By “bulk physical or chemical composition” is meant a chemical composition that is understood in the art to have physical properties and chemical properties. The term “physical composition” may be used only to show that it is amenable to a change in physical properties. The chemical composition may be amenable to a change in at least one chemical property, as used herein.

By “impacting physically or chemically a bulk physical or chemical composition” is meant that the incorporation of the matrix particles will change at least one physical or one chemical property of the bulk physical or. Or it will maintain one physical or one chemical property which would have changed otherwise, had the releasable ingredient been added without the matrix particle configuration of the present invention.

The precursor or the intermediate can be transformed by standard chemical or physical procedures and/or by the RF and/or MW frequency impingement as described in the present disclosure.

In another embodiment, this invention relates to the process of incorporating the matrix particle in a chemical reaction mixture to impact the chemical reaction. For example, the matrix particles can be dispersed in the monomeric mixture prior to polymerization. In another embodiment, this invention relates to activating the chemical reaction, for example the polymerization reaction, by heating the susceptor in the matrix particle by high-frequency electromagnetic radiation (EMR) such as radio-frequency (RF) or microwave (MW) radiation to then release or activate the releasable and/or activatable ingredient. Alternatively, heat and mechanical abrasion, for example shear, may be used to release the releasable ingredient.

The present disclosure relates to materials and methods for performing chemical reactions, for example, polymerization reactions wherein a chemical event is activated, uniformly, and on demand. The reactions as contemplated herein can be accomplished without needing to heat the entire reaction material mass; without the limitation of light such as infrared, ultraviolet, or visible penetration especially for highly filled material masses, opaque material masses and the like.

In some embodiments, the present invention relates to materials and methods for polymerization without the need to mix two reaction components, and in some embodiments with the ability to mix two components but not have an immediate or accelerated reaction and/or have a delayed reaction, on demand. For example, some embodiments of the present disclosure provide low molecular weight and high-performing materials for reducing cure times in polymerization to minutes or hours and in mold-making to a day or a few weeks. In one embodiment, this invention can inhibit a chemical event by activation of a chemical ingredient.

In some embodiments, the present disclosure provides materials and methods for polymerization that reduce or eliminate the need for higher molecular weight materials where high pressure is consequently required along with high temperatures, for example, in injection molding and reaction injection molding, and instead allowing for increasing of molecular weight while in process or within the mold, and on demand. Preferably, the matrix particles have matrix materials that are of low molecular weight. The low molecular weight matrix particles of the present invention provide uniform mixing of fillers and provide higher performance adhesion without unwanted rheological issues. The invention allows for less complex equipment and on-demand curing that simplifies material preparation, storage, packaging, and handling.

The low molecular weight matrix particles provided by the present disclosure can be applied as adhesives to various materials with various applications. The present invention also provides for local heating or thermal activation. The matrix particles as described herein provide the ability to activate polymerization on demand. Polymerization as provided herein can be activated through substrates, fillers, other additives and the like. In other words, the opacity or lack of transparency of the bulk chemical mixture or pore-polymerization mixture does not significantly impact the reaction progression. The low molecular weight matrix particles as described herein, provide for polymerization without relying on gross heating or thermal activation.

The low molecular weight materials, that is, the matrix particles, of the present invention can be applied to a substrate in a pattern, thereby providing for a patterned adhesive. Embodiments of the low molecular weight matrix particles of the present invention can be applied in a patterned manner thereby providing a patterned adhesive that includes both two and three-dimensional selective activation.

In some embodiments, the matrix particles as described herein provide on-demand polymerization for adhesives for producing converted goods, including rigid and or flexible laminates with two or more layers. In some embodiments, the matrix particles as described herein provide polymerization for adhesives for pressure-sensitive materials and their associated goods.

In one embodiment, the low molecular weight matrix particles of the present disclosure provide improved curing for adhesives, coatings, and the like. This also includes substrates to pass energy through, such as highly filled material masses, opaque material masses and the like.

Embodiments of the present invention provide materials and methods for improved non-metallic molding, polymeric molding, and high-speed mold making and delivery.

This process can also occur under ambient conditions. The thermal activation to engender the local chemical event is accomplished by applying electromagnetic radiation (EMR) such as radio frequency (RF) radiation or microwave (MW) radiation. This invention is applicable to bonding polymeric substrates, such as elastomeric and rigid substrates, including fabrics and laminates.

For example, a matrix that dissolves, melts, expands, cracks, ruptures, and/or otherwise deforms due to the heating of the susceptor component such as a carbon nanotube to release or activate a chemical ingredient such as a catalyst that then catalyzes the reaction, for example, a polymerization reaction or a reaction that leads to a rapid energy generating reaction.

In another aspect, this invention relates to a matrix particle, comprising:
(i) a matrix material, wherein said matrix material is capable of fully or partially altering its physical and/or chemical characteristics; and
(ii) at least one susceptor component, wherein said at least one susceptor component is embedded in said matrix material; and/or at least one releasable ingredient embedded in said matrix material, wherein said at least one releasable ingredient is capable of impacting a chemical reaction;
wherein said at least one susceptor component or and/or the releasable ingredient is capable of thermal activation through radio-frequency (RF), micro-wave (MW) radiation, thermal activation, or mechanical abrasion.

Stated differently, in one embodiment, the matrix particle comprises either the susceptor component or the releasable material or both. For example, a carbon nanostructure such as a CNT or a graphene could act as a susceptor and be the releasable ingredient.

In one embodiment, the susceptor component is absent, as there may or may not be a need for activation through RF or MF, as the activation is initiated thermally or via mechanical abrasion.

In one embodiment, the matrix particle comprises a core, wherein the core itself acts as the matrix material. The core comprises carbon nanostructures releasably attached to or embedded in or incorporated within the core. The core is made of organic materials, for example, oligomeric, or polymeric. For example, and as described elsewhere, the core is made from wax.

In another embodiment, the matrix particle comprises a core and a shell. The core, the shell, or the core and the shell are matrix material. The matrix material comprises carbon nanostructures releasably attached to, embedded in, or incorporated within the matrix material. The core is made of organic materials, for example, oligomeric, or polymeric. For example, and as described elsewhere, the core is made from wax. Organic materials include polymeric materials and oligomeric materials. The shell, if present, is made of an organic material such as oligomeric or polymeric, which allows for deformation and release of the releasable ingredient.

Nano- and micro-sized matrix particles can serve as carriers (see U.S. Patent Application US 2023/0285948A1 to Malofsky et al., which is incorporated by reference in its entirety) for more effectively delivering nanomaterials into sealants, coatings, composites, adhesives, and other polymeric products. Of particular interest are where physical properties of an end composition or physical product are achieved, including, but not limited to, thermal and electrical conductivity, improved or controlled strength, toughness, elasticity, chemical resistance, environmental resistance, energy dampening, and improved or controlled product life and failure.

The invention relates to matrix particles comprising nanomaterials, including metals and their chemical products, carbon nanostructures such as graphene and carbon nanotubes, which can improve physical, electrical, conductive, as well as simply providing more amount of said nanomaterials.

Optionally, crosslinking chemistries can be incorporated into or on the surface of said matrix particles, either by simply using surface chemistry, a ligand, or an oligomer-like structure capable further enhancing noted physical performance.

Specifically, one can incorporate within or coat polymer-based particles comprising nanomaterials such as carbon nanostructures such as carbon nanotubes or graphene. This basic concept helps to limit, among other things, overall amounts of material required, provide a large surface area containing said structures through which forces to separate are spread, limits agglomeration, etc. Where the matrix particles are coated with van der Waals and other physical or chemical force-ameliorating coating, these effects can be further ameliorated, amplified, controlled as desired.

In one aspect of the invention, particles are coated with nanotubes and then coated with force-ameliorating compositions, incorporating more than one, and preferably three or more nanotubes, optionally followed by coating with force-ameliorating compositions.

Optionally, one can incorporate within the particles or their coatings of any chemical functionalization for either subsequent reaction or physical effects. Examples of chemical reactions are myriad, and not limited, but include crosslinking and or polymerization reactions. Physical effect can include ligand, polymeric, or oligomeric structures for example, by physical combining with a surrounding polymer matrix or in the case of a metallic or soapy ligand, dispersion or inclusion into emulsions, dispersions and the like, in solvent, water, or otherwise. The optional inclusion of catalysts, co-catalyst, accelerators, fuels, energetic materials and the like are included in said invention.

An additional objective of the present invention is to provide polymeric nano and microparticles with functionalities on surfaces that can irreversibly/reversibly diminish when the composition containing polymer microparticles is applied to compositions containing sealants, composites, adhesives, other polymeric products and the like.

Other objective is to provide functionalities capable of non-covalent bonding such as hydrogen bonding or van der Waals when the composition containing polymer microparticles are applied in the composition for sealants, composites, adhesives, and other polymeric products.

In general, these functional nano- and microparticles are versatile platforms with tunable properties that can be tailored to meet specific application requirements. These functional nano- and microparticles find use in many applications, including adhesives, composites, laminates, sealants, coatings, inks, plastics and the like in many final products across many consumer, industrial and or medical applications.

The functional microparticles containing reactive functional groups such as carboxylic acids, amino groups, thiol, epoxy, acrylics, isocyanates can be cross-linked with other functionalized particles.

Polymers with functional microparticles, such as waterborne polyurethanes (WPU), polyester dispersions (PED), and polyacrylate emulsions (PAE), which are commonly used in wood coatings, metal coatings, printing inks, architectural coatings, and plastic coatings. Despite their inherent advantages, polymers have some drawbacks, such as low mechanical strength, low hardness, high water sensitivity, and heat softening. Water borne reactions have a relatively slow reaction rate and can also cause health hazards because of the release and use of hydrazine, formaldehyde, and other toxic chemistries.

In addition to making the polymer particles dispersible in liquids, the surface functionalities eliminate slow reactivity, and the need to accelerate reactions using toxic chemistries.

With a core and shell configuration, the nanomaterials present in the core and cross-linkable functionalities on the shell help protect the CNTs until secondary processing is carried out. Nanomaterials released will increase interaction and crosslinking densities due to van der Waals forces.

As another aspect of the invention, the present invention provides a microparticle composition comprising of nanomaterials, catalysts, crosslinkers in the cores, and functionalities on the shells. Further objectives of the invention can be achieved by producing microparticles with particle sizes ranging from 0.01 to 10 microns, as well as by modifying preexisting microparticles.

Further objectives of the invention can be achieved by producing nano and micro-particles with particle sizes ranging from 0.01 to 100 microns, including modifying preexisting microparticles.

Polymer microparticles of this invention are engineered into specific shapes, sizes, and surface chemistries, so that hybrids of organic and inorganic materials can be created.

A further aspect of the present invention provides a method for manufacturing the cross-linked polymer microparticles with nanomaterials embedded within them. Also, the cross-linked microparticles can be delivered in a masterbatch or as standalone particles.

A covalent adaptable network (CAN) is a polymer material that has covalent bonds that can be broken and reformed under certain conditions. Materials with reversible or tunable properties, such as mechanical strength or viscosity, can be developed in this way.

The low entropy of the functional groups on the microparticles enhances the chance of CAN formation in comparison with conventional crosslinkers. Carbon nanotubes and graphene on the surface of functional microparticles provide additional anchoring sites for CAN formation.

These cross-linkable, reversible groups attached to microparticles help to create self-healing coatings, adhesives, composites, and structural materials through CANs.

Functional groups on microparticles used in PSA (Pressure Sensitive Adhesives) improve their tack, making them more readily adhere to surfaces. Functional microparticles provide additional contact points between the adhesive and the substrate, reducing the chance of creep failure over time.

The addition of nanomaterials with high modulus such as CNTs and graphene, enhances the resistance to deformation.

Pressure causes the functional particles to collapse in PSAs, releasing the chemistry, facilitating further crosslinking with the substrate, and enhancing adhesion. Functional microparticles provide a tunable bond line thickness. Microparticles can, for example, increase an adhesive's viscosity, which improves its shear strength and prevents it from flowing.

A further aspect of the invention relates to superior thermal and electrical conductivity using materials more efficiently and incorporating them with a lower viscosity by creating an apparently honeycomb network allowing for a final polymer based, highly conductive product.

The ability to heat a composition and release catalyst, co-catalyst, an accelerator or such other reaction-initiating compound on demand and at low to no significant additional energy input enables new processes, materials and subsequent products and processes that were previously unattainable, specifically regarding hot-melt adhesives, molding, preforms, plastics for thermoplastic molding, and over-molding dissimilar materials. In over-molding processes the adhesive layer functions to compatibilize thermoplastic and thermoset.

Specifically, this invention relates to the addition of carbonaceous susceptor particles coated with materials capable of preventing strong van der Waals force interactions and or individual or clusters of carbonaceous susceptors costed with materials capable of preventing van der Waals interactions such that the latter force affects are significantly minimized or eliminated allowing for the facile addition of said materials, especially at higher concentrations, to facilitate RF heating to make facile physical deformations, including softening or melting. The aforementioned coatings significantly reduce clumping or other macro-structures capable of causing significant viscosity increases or similar physical effects. The coatings can slow, stop, or prevent where thermal, electrical conduction, or other similar effects are desired. The aforementioned composition can be readily mixed into the existing formulations using conventional equipment.

Hot-melt adhesive applications illustrate the overall possible effects extendable to other products containing materials ranging from low molecular weight materials, bio-sourced, temperature-sensitive renewable material, to high molecular thermoplastic resins and polymers.

Specifically, one can coat carbonaceous materials as individual, clusters, particles coated with and other combinations incorporating optionally other materials such that van der Waals effects are minimized significantly reducing viscosities through a temperature range allowing for more of said coated materials to be incorporated.

In one embodiment, the invention allows for a higher loading of said materials to facilitate RF heating, particularly microwave heating to facilitate ease of processing and or high levels of reinforcement. As noted in the background above, other purposes can include conductivity of heat or electricity, reaction initiation, matching CTEs, thermal conductivities via particles and so on.

Preforms comprise another example application group where we enable first addition of said carbonaceous materials to polymers in the melt for any of the properties noted above or for reactive options using particles containing catalysts and the like noted in U.S. patent application Ser. No. 18/055,302 to Malofsky et.al., in particular to initiate reactions where particles maintain integrity at the forming or deformation temperature during part making processing until RF heated to an even higher temperature for catalyst or otherwise release or exposure and subsequent activation. RF heating would enable high speed manufacturing for high throughputs and lower costs. Such a process in certain applications can eliminate B-stage preform or material refrigeration.

Plastics injection, blow molding and layers for hot binding of polymer or polymer coated layers (extrusion) served similarly to the above.

The bonus of added reinforcements, such as carbon, glass, aramid, ultra-high molecular weight polyethylene and natural and synthetic fibers and other combinations is demonstrated in multiple ways.

This method provides the advantage of the ease of addition and lower viscosity.

Example of the applications include reinforced hot melts; reactive hot melts; hot melt coated articles, webs, films, continuous or not; hot melt coated fibers, continuous or not; hot melt adhesive articles, including fibers, ropes, shapes, dots and preform articles made from monomers, polymers and/or oligomers.

One of the advantages is the substrate attachment with minimal squeeze out of the materials of adhesive.

### Polymerization Energy Minimization and Fine Polymerization Control

In one embodiment, this invention also relates to minimizing the energy required to activate chemical reactions and their effects, specifically avoiding gross heating, limited energy penetration as with, for example UV light, and the ability to activate one or more chemical events on demand, in whatever order or series desired to achieve the desired result.

### Activating Chemistry and Polymerization Through Opaque Objects

Uncontrolled and fast reactions in UV curing chemistries can result in highly cross-linked systems. In some applications that require toughness, uncontrolled UV cure reaction leads to unwanted vitrification and brittleness. Embodiments of the present invention provide uniform distribution of the catalyst/co-catalyst, as components of the matrix particles, in the reaction mixture. Without being bound to theory, this uniform distribution in the reaction mixture enables the simultaneous initiation of a polymerization reaction at multiple sites that helps the creation of a homogenous polymeric network. Without being bound to theory, the simultaneous reaction at multiple sites results in a controlled exotherm and improved efficiencies.

Embodiments of the present invention provide activation of catalysts of polymerization at one or more depths on a matrix material. The catalyst may be on the surface of the matrix material or a depth below the surface or embedded within the matrix material. For example, the catalyst may be positioned at a depth below the surface of up to about 0.01 μm, from about 0.01 μm to about 0.05 μm, from about 0.05 μm to about 0.1 μm, from about 0.1 μm to about 0.2 μm, from about 0.2 μm to about 0.3 μm, from about 0.3 μm to about 0.4 μm, from about 0.4 μm to about 0.5 μm, from about 0.5 μm to about 0.6 μm, from about 0.6 μm to about 0.7 μm, from about 0.7 μm to about 0.8 μm, from about 0.8 μm to about 0.9 μm, from about 0.9 μm to about 1 μm, from about 1 μm to about 5 μm, from about 5 μm to about 10 μm, or greater than about 10 μm and any and all increments therebetween.

In one embodiment, this invention relates to solid-state polymerization, in which the molecular weight is built up over time, where the polymer is already in a solid state or a highly viscous state, but with the inclusion of matrix microparticles, and the treatment with RF or MW, the polymerization yield or the molecular weight can be increased, for example, in situ.

### Particle Composition and Structure

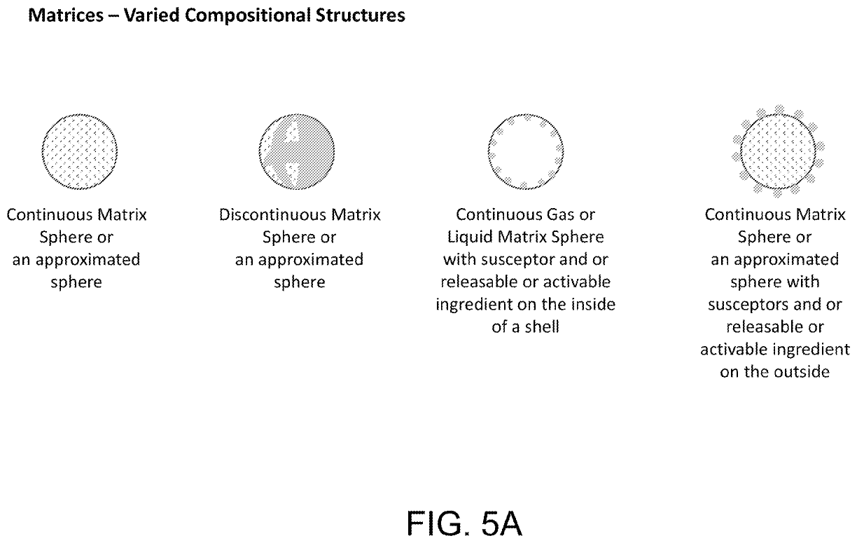

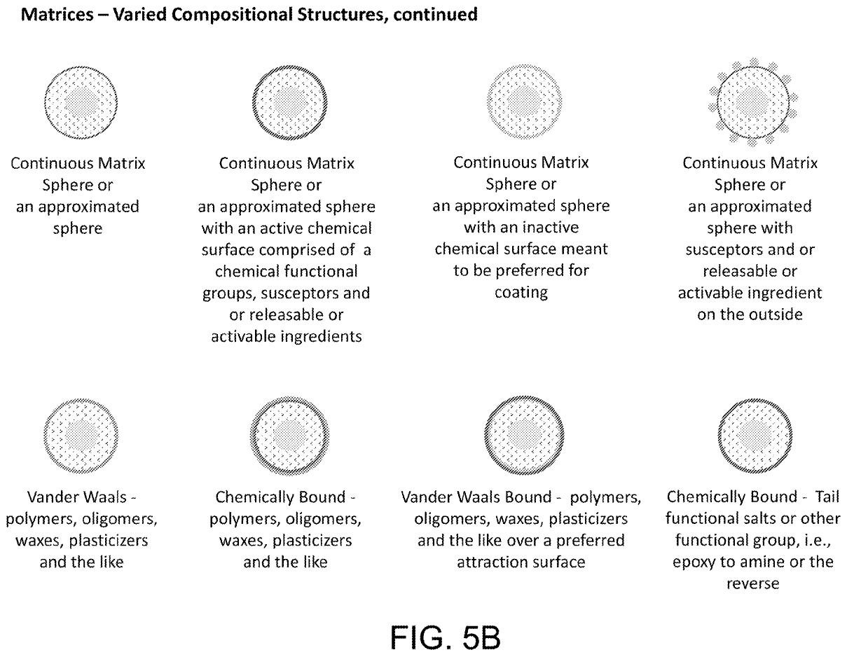

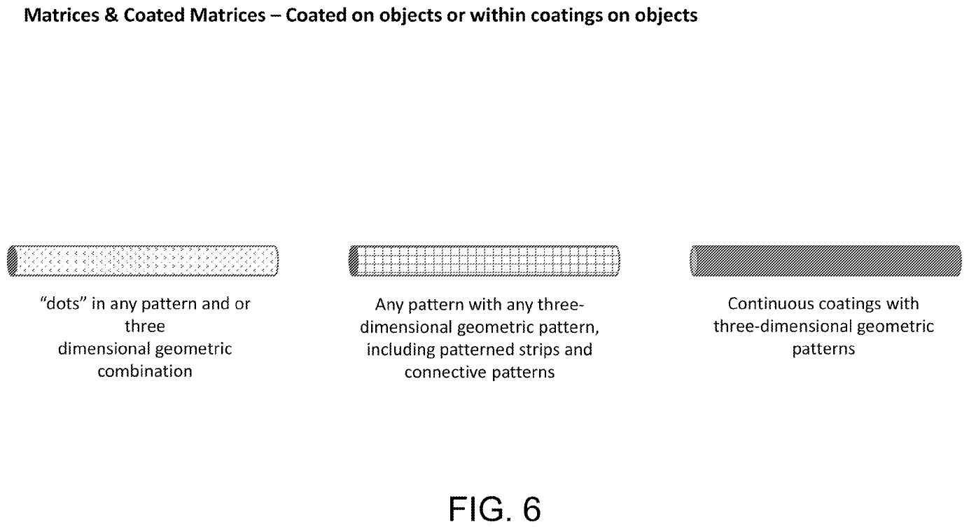

Referring now to FIGS. 5A and 5B, in some embodiments, the matrix particles of the present invention can be of highly varied composition. The matrix material can optionally be deformable. In some embodiments, multiple matrices are used in one embodiment. In some embodiments, one or more susceptor component can be used. In some embodiments, one or more releasable and/or activatable ingredients are contained within or on the matrix. In some embodiments, the one or more releasable and/or activatable ingredient includes one or more of a catalyst, a co-catalyst, a co-reactant, fuel, an explosive, another ingredient, and mixtures thereof. In some embodiments, the releasable and/or activatable ingredients are released by one or more means including for example dissolving, expansion, cracking, light, and/or one or more combinations thereof.

### Alterable Matrix Material

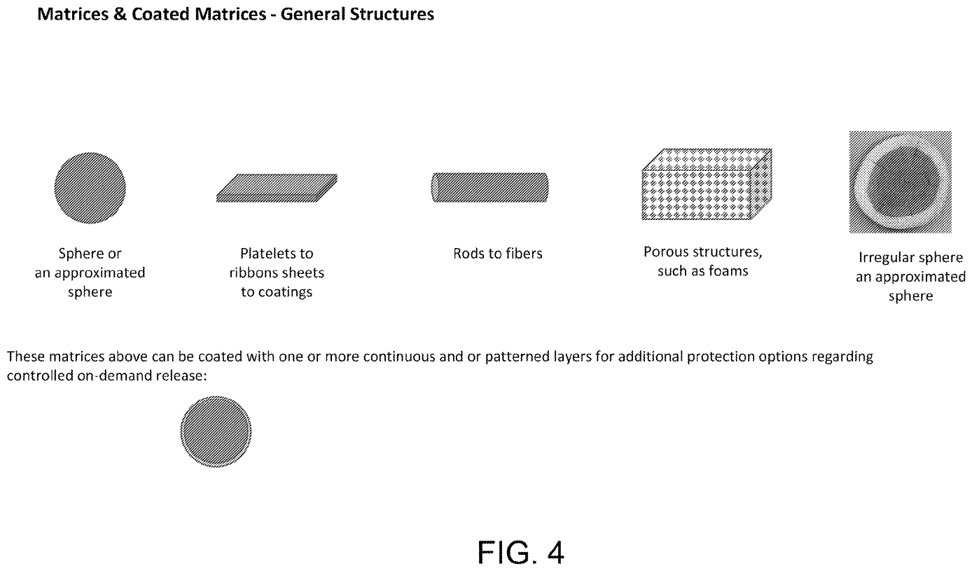

As used herein, “alterable matrix” refers to a material that when heated is capable of deforming, dissolving, melting, rupturing, expanding, contracting, plasticizing and/or solvating in such a way as to release its active ingredient, for example, chemical contents. The matrix particle may have almost any geometric configuration, geometry, or size. For example, as shown in FIG. 4, the matrix particle may be formed in a shape including one or more of a sphere, thin plate, ribbon, sheet or coating, a rod or distended fiber, a porous structure including for example a foam, or one or more irregular or amorphous shapes.

In some embodiments, shown in FIGS. 5A and 5B, the matrix material is continuous. In some embodiments, the matrix material has an isotropic structure. In some embodiments, the matrix material is discontinuous. In some embodiments, the matrix material has an anisotropic or orthotropic structure. In some embodiments, the matrix material is a mixture of one or more materials or structures. In some embodiments, the matrix material includes a mixture of isotropic and anisotropic structures.

The matrix material can be composed of any suitable material as understood in the art. In some embodiments, the matrix material can be monomeric, oligomeric, or polymeric. For example, the matrix can comprise methyl methacrylate. In some embodiments, the matrix material is composed of polymeric microparticles. For example, the polymeric microparticles can be made from polymethyl methacrylate (PMMA), styrene, and/or one or more polymers or copolymers thereof. The microparticles can also be blends, alloys, and mixtures of polymers.

The polymeric microparticles can include polymeric microspheres and microcapsules. The microcapsules can be porous or can be partially open.

In some embodiments, the microparticles are spherical microparticles. The micro-particles can have an effective diameter of from about 0.1 μm to about 1000 μm. As used herein, “effective diameter” refers to the diameter of an equivalent spherical microparticle of the same volume or weight. For example, the microparticles can have an effective diameter of from about 0.1 μm to about 0.5 μm, from about 0.5 μm to about 1 μm, from about 1 μm to about 5 μm, from about 5 μm to about 10 μm, from about 10 μm to about 50 μm, from about 50 μm to about 100 μm, from about 100 μm to about 200 μm, from about 200 μm to about 300 μm, from about 300 μm to about 400 μm, from about 400 μm to about 500 μm, from about 500 μm to about 600 μm, from about 600 μm to about 700 μm, from about 700 μm to about 800 μm, from about 800 μm to about 900 μm, from about 900 μm to about 1000 μm, and any and all increments therebetween.

In one embodiment, the effective diameter of the microparticle is one of the numbers as measured in μm, or one of the numbers within a range defined by any two numbers below, including the endpoints, in μm:
0.1, 0.2, 0.3, 0.4, 0.5, 0.6, 0.7, 0.8, 0.9, 1, 2, 3, 4, 5, 6, 7, 8, 9, 10, 20, 30, 40, 50, 60, 70, 80, 90, 100, 200, 300, 400, 500, 600, 700, 800, 900, and 1,000.

In one embodiment, the microspheres as referred to herein, are microparticles composed of a homogeneous and solid polymer matrix material, while microcapsules are coreshell microparticles where the core may be solid, liquid, or even hollow spaces. The microparticles can also be prepared as a porous matrix material composed of interconnected microspheres. The porous matrix material can include pores that form on the surface or that are external and/or pores that form internally. The pores can be isolated or interconnected. The pores lead to very low mass density matrix material. The pores are suitable for entrapping susceptors and releasable and/or activatable ingredients, such as activators, catalysts, co-catalysts, co-reactants, oxidizers, reaction inhibitors, accelerators, and/or one or more other releasable ingredients.

In some embodiments, the matrix material is composed of monodispersed polymeric particles. In some embodiments, the matrix material is composed of poly dispersed polymeric particles. The polydispersion may include a narrow dispersion of particle sizes, for example, a monomodal distribution, a bimodal distribution, or a trimodal distribution. In some embodiments, the polydispersion includes a middle-dispersion of particle sizes. In some embodiments, the polydispersion includes a wide dispersion of particle sizes. In some embodiments, the polydispersion includes particle sizes ranging from about 1 nm to about 10 nm, from about 10 nm to about 50 nm, from about 50 nm to about 100 nm, from about 100 nm to about 200 nm, from about 200 nm to about 400 nm, from about 400 nm to about 600 nm, from about 600 nm to about 800 nm, from about 800 nm to about 1000 nm, about 1 μm, from about 1 μm to about 1.5 μm, from about 1.5 μm to about 2 μm, from about 2 μm to about 2.5 μm, from about 2.5 μm to about 3 μm, from about 3 μm to about 3.5 μm, from about 3.5 μm to about 4 μm, from about 4 μm to about 4.5 μm, from about 4.5 μm to about 5 μm, and any and all increments therebetween. In some embodiments, the average particle size is up to about 0.1 μm. In some embodiments, the average particle size is in the range of from about 0.1 μm to about 0.5 μm, from about 0.5 μm to about 0.8 μm, from about 0.8 μm to about 1 μm, from about 1 μm to about 1.2 μm, from about 1.2 μm to about 1.5 μm, from about 1.5 μm to about 1.8 μm, from about 1.8 μm to about 2 μm, from about 2 μm to about 4 μm, from about 4 μm to about 6 μm, from about 6 μm to about 8 μm, from about 8 μm to about 10 μm, from about 10 μm to about 20 μm, from about 20 μm to about 40 μm, from about 40 μm to about 60 μm, from about 60 μm to about 80 μm from about 80 μm to about 100 μm, from about 100 μm to about 200 μm, from about 200 μm to about 400 μm, from about 400 μm to about 600 μm, from about 600 μm to about 800 μm, from about 800 μm to about 1000 μm, and any and all values therebetween.

In some embodiments, the matrix material in the matrix particles has a molecular weight of up to 10 kDa. In some embodiments, the matrix material in the matrix particles have a molecular weight of from about 10 kDa to about 25 kDa, from about 25 kDa to about 50 kDa, from about 50 kDa to about 75 kDa, from about 75 kDa to about 100 kDa, from about 100 kDa to about 125 kDa, from about 125 kDa to about 150 kDa, from about 150 kDa to about 175 kDa, from about 175 kDa to about 200 kDa, from about 200 kDa to about 225 kDa, from about 225 kDa to about 250 kDa, and any and all increments therebetween. Matrix materials, with much higher molecular weight, for example, that of branched or cross-linked polymers such as rubber is also within the scope of this invention.

In some embodiments, the matrix material has a molecular weight as provided by any number below, in kDa, or by a number within a range defined by any two numbers below, including the endpoints of such a range, in kDa:
200, 300, 400, 500, 600, 700, 800, 900, 1000, 1100, 1200, 1300, 1400, 1500, 1600, 1700, 1800, 1900, 2000, 3000, 4000, 5000, 6000, 7000, 8000, 9000, 10000, 20000, 30000, 40000, 50000, 60000, 70000, 80000, 90000, 100000, 200000, 300000, 400000, 500000, 600000, 700000, 800000, 900000, and 1000000.

In some embodiments, the dispersion of polymeric particles includes particles with a low level of crosslinking. In some embodiments, the dispersion of polymeric particles includes particles with a standard or intermediate level of cross-linking. In some embodiments, the dispersion of polymeric particles includes particles with a high level of cross-linking.

### Susceptors

In some embodiments, the matrix particle composition of the present disclosure includes one or more susceptors. The susceptors as contemplated herein are particles that can be heated or otherwise activated to generate heat. The susceptors are composed of materials that create higher heating rates or lower thermal capacity than the surrounding or adjacent matrix materials. The higher heating rates of the susceptors result in altering—as defined previously—of the matrix upon application of an energy source without bulk heating of the matrix material. The heated susceptors can induce deformation of the matrix material so that components or chemical ingredients that can impact reactions, such as catalysts or inhibitors within the matrix, can participate in one or more chemical reactions. Embodiments of the susceptors that can be heated include one or more carbon-based or silicon carbide-based materials. The susceptors may include one or more ferrous or non-ferrous metals including for example, one or more transition metal oxides, ferrites, and the like, and/or one or more combinations thereof. Transition metals include Ti, V, Cr, Mn, Fe Co, Ni, Cu, and Zn.

Embodiments of ferrous susceptors include one or more ferrite powders, superparamagnetic iron oxide (SPION) particles, and the like, including one or more combinations thereof. Embodiments of the susceptors include one or more of graphene, graphite oxide fullerenes, single-wall carbon nanotubes, multi-wall carbon nanotubes, carbon nanofibers, filled or doped carbon nanotubes, carbon sheets, bucky paper, nanocrystalline cellulose and the like, including one or more combinations thereof.

Embodiments of the susceptors are composed of one or more materials that generate heat when exposed to radio frequency (RF) radiation and/or microwave (MW) radiation; microwave heating is used as an example for describing the process of the present invention, infra. Externally applied microwaves can generate matrix heating internally. Without being bound to theory, unlike conventional means of bulk heating, microwave-induced heating rates are not limited to the rate of heat transfer from external heat sources to the inside of the bulk reaction mixture. Accordingly, microwave heating is more efficient than conventional heating. That is, microwave heating provides a faster and uniform heating of the bulk reaction mixture that has matrix particles of the present invention dispersed into the bulk reaction mixture. Furthermore, conventional heating occurs via heat flow from the external heat sources while conventional heating propagates from the surface to the core of the bulk reaction mixture by one or more means, including conduction and/or convection, and through and mixing.

As such, the surface of the bulk reaction mixture often remains at higher temperature than the core of the bulk reaction mixture. For example, the outside surface of a reaction vessel in immediate contact with the bulk reaction mixture will heat up the immediate vicinity of the bulk reaction mixture, with a progressively declining temperature to the core. Even if an equilibrium temperature is established, the wall of the bulk reaction mixture proximate to the reaction vessel will likely have a higher to a much higher temperature, introducing a non-uniform yield and chemical properties of the bulk reaction mixture progressing towards an end-product. For example, in a polymerization reaction, the bulk reaction mixture, starting out with monomers and oligomers, and if dependent on temperature, will either have a distribution of molecular weight from outside to the core of the bulk reaction mixture, or will have a higher degradation closer to the reaction vessel, or will have higher gelling/crosslinking at the reaction vessel walls.

This can result in uneven heating, overheating, and/or underheating creating reaction non-uniformity, which can then affect yield or create problems with other reaction parameters. However, because microwave heating can uniformly occur whether at the core or the outside of the bulk reaction material, because the microwaves penetrate matrix materials and thermally activate or excite the susceptors within the core of the bulk material nearly simultaneously, it generates heat inside the bulk material allowing the core of the matrix to generally remain at even a higher temperature than the surface. That is, localized heating sources can be engendered that are very small in dimension.

As such, in some embodiments, susceptors are positioned within the core of the matrix particle such as a polymeric matrix material so when microwaves are applied, the susceptors are heated, resulting in heating the core of the matrix particle. In some embodiments, the susceptors are positioned on the surface of the matrix particle, so that when microwaves are applied, local acute heating of the surface of the matrix particle results.

Embodiments of the susceptors are activatable at one or more frequencies or ranges of frequencies. The frequencies may include one or more frequencies within the following ranges: up to about 100 MHz, from about 100 MHz to about 200 MHz, from about 200 MHz to about 400 MHz, from about 400 MHz to about 600 MHz, from about 600 MHz to about 800 MHz, from about 800 MHz to about 1000 MHz, from about 1000 MHz to about 1500 MHz, from about 1500 MHz to about 2000 MHz, from about 2000 MHz to about 2500 MHz, from about 2500 MHz to about 5000 MHz, from about 5000 MHz to about 7500 MHz, and any and all increments therebetween. A preferred frequency range is 900 MHz to 2500 MHz.

In some embodiments, the frequencies are one of the numbers below as measured in MHz, or within a range defined by any two numbers below including the endpoints of such range, in MHz:
10, 20, 30, 40, 50, 60, 70, 80, 90, 100, 150, 200, 250, 300, 35, 400, 450, 500, 550, 600, 650, 700, 750, 800, 850, 900, 950, 1000, 1500, 2000, 2500, 3000, 3500, 4000, 4500, 5000, 5500, 6000, 6500, 7000, and 7500.

Embodiments of the susceptors include one or more shapes. For example, the susceptors may be spherical, cylindrical, disk-like, tube-like, or cuboidal, and may have one or more other regular polygonal prismed shapes, one or more irregular shapes, and/or one or more combinations thereof.

In some embodiments, the susceptors are functionalized. In some embodiments, the susceptors include both functionalized and unfunctionalized susceptors. In some embodiments, the functional groups include surface functional groups, wherein the functional groups are added by one or more monomeric or polymeric surfactants. For example, in some embodiments, the susceptors may include one or more carboxyl groups, hydroxy groups, methyl groups, and the like. The susceptor may include one or more functional groups that increase or decrease the hydrophilicity, or the hydrophobicity. The susceptors may include different functional groups so that regions of the susceptor are more hydrophilic or hydrophobic than other regions of the susceptor. For example, the susceptors can have functional groups so that the susceptor has a polar end and a nonpolar end.

Releasable and/or Activatable Ingredients

In some embodiments, the matrix material includes one or more releasable and/or activatable ingredients also known as releasable ingredients or active ingredients. The one or more releasable and/or activatable ingredients can be encased or entrapped within the matrix material which can be polymeric or oligomeric or monomeric or a mixture of the three. For example, the one or more releasable ingredients can be physically entrapped or encased within one or more pores of the microparticle matrix material. In some embodiments, the one or more releasable ingredients can be chemically entrapped within the polymeric matrix material. That is, the one or more releasable ingredients can be chemically bonded to one or more materials of the matrix within the matrix particle. The releasable ingredients can include one or more catalysts, co-catalysts, co-reactants, oxidizers, reaction-inhibiting compounds, chelators, initiators, accelerators, activators including surface activators, modifiers, fuels, explosives, and/or one or more combinations thereof. The releasable ingredients can include any chemical, combination of chemicals, organic or inorganic, as understood in the art. In some embodiments, the one or more releasable ingredients can include one or more compounds capable of initiating polymerization, for example, anionic, cationic or free radical polymerizations.

In some embodiments, the one or more releasable ingredients include one or more ingredients that initiate one or more reactions including redox reactions such as that in anaerobic adhesion. For example, the one or more releasable ingredients can include one or more of a hydroperoxide and one or more transition metals. The one or more releasable ingredients can be contained within different microcapsules within the matrix, within different pores, entrapped within the matrix material, bound to one or more components of the matrix material or otherwise are maintained separated, and are only in contact once the matrix material is heated or activated.

In one embodiment, the one or more releasable ingredients include one or more of a metal accelerator or catalyst such as ferrocene or other metallocenes. The one or more catalysts can be combined with peroxides and/or other compounds for activating or deactivating polymerization. In some embodiments, the catalyst includes one or more of Cu-acetyl acetonate, Cu-2-ethyl hexanoate, ferrocene, dimethyl aminomethyl ferrocene, and/or one or more combinations thereof. In some embodiments, the one or more releasable ingredients include one or more free radical stabilizers such as hydroquinone or p-methoxyphenol.

In some embodiments, including for example compositions that include anionic cyanoacrylate and/or methylene malonate, the one or more releasable ingredients can include one or more inorganic bases or organic bases (e.g., sodium propionate). In yet another example, for cationic polymerization of epoxy resins, one or more ingredients such as diaryliodonium and triarylsulfonium, blocked super acids, cationic catalysts are released. In some embodiments, such as in condensation polymerization, the one or more releasable ingredients can include one or more catalysts such as antimony, germanium, titanium, and aluminum compounds.

Fuels and explosives and the like are another example of where such materials could be used. Specifically, one could utilize individually or in combination a fuel or other explosive material with or without additional materials as described to initiate a chemical reaction releasing in various forms a large amount of energy either individually or in combination with other reactive materials to facilitate an event, for example, from powering a piston in an engine, to an explosive device to an incendiary event to a simple high-speed heating event.

In one embodiment, the releasable ingredient can modify physical characteristics of the bulk reaction mixture, for example increase or decrease its viscosity, or provide color or other optical property to the bulk reaction mixture, especially once it reaches its chemical equilibrium to a product, for example.

It should be noted that carbon nanostructures acts as susceptors and/or releasable ingredients simultaneously. Stated differently, in one embodiment, the carbon nanostructures are present only as susceptors. In another embodiment of the invention, the nanostructures are present as releasable and/or activatable ingredients. In yet another embodiment, the carbon nanostructures are present and function as susceptors as well as releasable and/or activatable ingredient. Embodiments of the releasable agents include one or more of graphene, fullerenes, single-wall carbon nanotubes, multi-wall carbon nanotubes, carbon nanofibers, filled or doped carbon nanotubes, carbon sheets, bucky paper, and the like, including one or more combinations thereof. In one embodiment, the releasable ingredient is a carbon nanotube that is releasably attached to the core, the shell, the deformable material, the force-ameliorating material, or the matrix material of the matrix particle. In another embodiment, the number of carbon nanotubes attached at a given location in a cluster inside the matrix particle is 2, 3, 4, 5, 6, 7, 8, 9, or 10.

### Particle Structures

Embodiments of the present disclosure provide matrix particle compositions having a matrix material comprised of one or more particles as described herein, one or more susceptors as described herein, and/or one or more releasable ingredients as described herein. The matrix particle composition may be simply structured as a matrix material containing the susceptor and a releasable ingredient as described supra and may present in any geometric configuration required by an application. For example, the matrix particle may present in a spherical or approximately spherical configuration, a ribbon or sheet-like configuration, a rod-like or fiber-like configuration, a porous configuration including for example a foam, and/or one or more irregular configurations. It should be noted that in some embodiments, the releasable ingredient may not be physically released, but rather, may be chemically activated to perform its function.

In some embodiments, the matrix particle compositions can have varied phases containing either susceptors and/or activatable and/or releasable ingredients. In some embodiments, the matrix particle compositions can have continuous phases which contain both susceptors and/or releasable ingredients. In some embodiments, one or more susceptors or releasable ingredients such as activators/catalysts can be contained in a first layer and/or one or more subsequent or alternating coating layer(s) of the matrix material in the matrix particle composition.

In some embodiments, the particle compositions include hydrophilic chemistries, hydrophobic chemistries, and/or one or more regions with hydrophilic and/or hydrophobic chemistries. In some embodiments, the one or more functionalized susceptors are positioned within or on the particle composition so that the like-charged susceptor functional groups and particle chemistries are aligned. For example, the hydrophilic region of the one or more susceptors aligns with one or more regions of the matrix particle composition having one or more hydrophilic chemistries. Similarly, in some embodiments, the hydrophobic region of the one or more susceptors aligns with one or more regions of the matrix particle compositions having one or more hydrophobic chemistries. As such, the position of the one or more susceptors within or on the matrix particle compositions can be directed by hydrophilic or hydrophobic regions of the matrix particle composition.

Embodiments of the matrix particle composition include configuration wherein the susceptors are combined with the matrix material, and one or more of the releasable ingredients. Embodiments of the matrix particle composition include configurations wherein the susceptors can be present on the surface of a first matrix materials or in another matrix material in contact with the first matrix material. In some embodiments, the particle composition includes a first layer of matrix material, and one or more additional adjacent layers of matrix material. For example, in some embodiments, the matrix particle composition can include a single matrix material or matrix material layer, 2 matrix material layers, 3 matrix material layers, and so on. The matrix particle composition can include one or more homogenous layers, one or more heterogenous layers, and/or combinations thereof. For example, in some embodiments, more than one susceptor or type of susceptor is included in one matrix particle composition. The additional susceptors can be positioned in the same matrix material layer, in adjacent matrix material layers, in alternating matrix material layers, and the like.

In some embodiments, more than one releasable ingredient such as an activator or catalyst is included in the same matrix material layer or a different matrix material layer. The activator or catalysts may be positioned in the same matrix material layer, in adjacent matrix material layers, in alternating matrix material layers, and the like. In some embodiments, more than one releasable ingredient is included in the same matrix material layer or a different matrix material layer. The releasable ingredient may be positioned in the same matrix material layer, in adjacent matrix material layers, in alternating matrix material layers, and the like.

In some embodiments, each matrix material layer comprises one combination of susceptor, activator/catalyst and releasable ingredient such as activator/catalyst. In some embodiments, each matrix material layer comprises more than one combination of susceptor, and releasable ingredient such as an activator/catalyst. In some embodiments, the matrix particle composition includes more than one matrix material layer where each matrix material layer comprises the same combination of susceptor, and releasable ingredient such as an activator/catalyst. In some embodiments, the particle composition includes more than one matrix material layer where each matrix material layer comprises a different combination of susceptor, and releasable ingredient such as an activator/catalyst.

In some embodiments, the matrix particle composition includes more than one matrix material layer where each layer is formulated to have a curing time within the same time interval. In some embodiments, the matrix particle composition includes more than one matrix material layer where each layer is formulated have a curing time at varied time intervals such as in molded structures. In some embodiments, the layered matrix materials are ordered for managing stresses and or other physical properties in the particle composition or in the material in which or on which they are applied. For example, in some embodiments, the particle composition is formulated with different amounts or concentrations of one or more activatable matrix component, activator, catalyst, releasable ingredient or the like.

A matrix particle may, in whole or part, be, optionally supported and or otherwise protected, for example by a crushable or a non-crushable support including for example a metal, ceramic or glass and the like, and in three dimensions like a foam, a solid object coated with or impregnated by the matrix particle composition. Even further by example, an object may present with a roughened, spiked or similar surface texture to, for example, prevent crushing with the matrix material ensconced below but surrounding said structures. Another example could include matrix particle composition as coated beads, particles, granules, and the like, including metal glass beads or even a susceptor as a bead to melt or otherwise deform the matrix particle composition coated on the surface through heating.

In some embodiments, multiple matrices are used if, for example, a particular application demands it. The matrix may be formed in various configurations including one or more coated layers, patterned films or layers, textured geometries, and the like.

In all applications, the susceptors are excited via external, high-frequency, electromagnetic radiation (EMR) to alter, for example, deform or dissolve or melt, in part or whole, the surrounding matrix or matrices to release the catalyst, co-catalyst, inhibitor, co-reactant, or accelerator, fuel, an explosive or other ingredients. In some embodiments, the susceptors, such as CNTs, are excited or activated to heat or thermally activate the matrix. In some embodiments, heating or thermally activating the matrix deforms the matrix material.

The matrix particles offer and efficient way to deliver the susceptors into the formulations used, for example, in adhesives, coatings, composites, molding applications, and polymeric systems. Use of matrix particles as a carrier helps with maintaining the rheological characteristics—for example even at low loadings CNTs causes spikes in viscosities creating processing challenges.

Various susceptors are also used depending on the specific applications. For example, in curing opaque polymers, single and multi-wall carbon nanotubes, sheets, and fiber susceptors generally offer very efficient energy susceptor material for heating and releasing a given catalyst. In other example, where optical clarity is a driving factor, CNTs with boron nitride may be used for transparency.

The size of the susceptor component ranges from nanometer range to micrometer to millimeters. For example, in some embodiments the susceptor component ranges in size of from about 1 nm to 10 nm, from about 10 nm to about 100 nm, from about 100 nm to about 1 μm, from about 1 μm to about 10 μm, from about 10 μm to about 100 μm, from about 100 μm to about 1000 μm, and any and all increments therebetween.

In some embodiments, the size of the susceptor component is one of the numbers below as measured in nm, or within a range defined by any two numbers below including the endpoints of such range, in nm, or an addition of any two numbers, in nm:
1, 2, 3, 4, 5, 6, 7, 8, 9, 10, 20, 30, 40, 50, 60, 70, 80, 90, 100, 200, 300, 400, 500, 600, 700, 800, 900, 1000, 2000, 3000, 4000, 5000, 6000, 7000, 8000, 9000, 10000, 20000, 30000, 40000, 50000, 60000, 70000, 80000, 90000, 100000, 200000, 300000, 400000, 500000, 600000, 700000, 800000, 900000, and 1000000.

In some embodiments, the susceptors are uniformly dispersed in the matrix material. The dispersion of susceptors can allow the use of optimized weight of the susceptors. In some embodiments, the well-dispersed susceptors can result in strong van der Waals forces between the susceptors and the matrix material, it is theorized without wishing to be bound by any theory as a limitation to the scope of the present invention. The interactions of the susceptors and matrix can also be through both covalent and non-covalent bonding.

The susceptor component may include carbon nanotubes, carbon nanostructures, ferrous particles including superparamagnetic iron oxide nanoparticles (SPIONs), and the like.

The catalyst, co-catalyst, inhibitor, co-reactant, accelerator, fuel, an explosive, other ingredients and the like and mixtures can be of virtually any composition but preferably where the final particles are present at a concentration suitable for the required chemistry. Applications can be very unique and widely varying in their requirements.

In some embodiments, susceptor component concentrations may vary from 0.01% to as much as 10% generally with the application itself and its requirements the final arbiter. Energy requirements derived from deformation temperatures and dynamics, heat transfer to the surrounding matrix, the timeframe of the event from thousandths of seconds to tens of seconds or more. In some embodiments, the matrix includes one or more waxes. The waxes can include one or more natural waxes such as carnauba wax. The waxes can include one or more synthetic waxes such as, for example polyethylene wax. The waxes can include a combination of both synthetic and natural waxes such that the combination has a sharp melting point. In some embodiments, the waxes have a melting and/or deformation temperatures in the range of between about 50° C. and 300° C. For example, the wax matrix in some embodiments has a melting temperature of between about 50° and about 75° C., between about 75° C. and about 100° C., between about 100° C. and about 125° C., between about 125° C. and about 150° C., between about 150° C. and about 175° C., between about 175° C. and about 200° C., between about 200° C. and about 225° C., between about 225° and about 250° C., between about 250° C. and about 275° C., between about 275° C. and about 300° C., and any and all increments therebetween.

### Waxes as Matrix Material

By “wax” is meant any naturally occurring or synthetically occurring wax. It also includes blends or mixtures of one or more naturally occurring and/or synthetically occurring waxes. Naturally occurring waxes include plant-based waxes, animal waxes, and mineral waxes. Synthetic waxes are made by physical or chemical processes. Because they are mixtures, naturally produced waxes are softer and melt at lower temperatures than the pure components.

Wax can be paraffin wax that is a linear alkane with a general formula of CₙH₂ₙ₊₂, wherein n varies from 13 to 80. The paraffin wax defined by n=13 is called tridecane and the one with n=80 is octacontane. The melting point of C₁₃ wax is −5.4° C. Similarly, the melting point of the C60 wax is 100° C. Similarly, the melting point of higher waxes (between C60 and C80) is higher than 100° C. Depending upon the temperature range in which the bulk reaction mixture needs to be heated to, one could tailor a wax-based matrix particle with a specific wax core within it that alters, deforms, or melts in that particular temperature range.

Examples of plant-based waxes include mixtures of unesterified hydrocarbons, which may predominate over esters. The epicuticular waxes of plants are mixtures of substituted long-chain aliphatic hydrocarbons, containing alkanes, alkyl esters, sterol esters, fatty acids, primary and secondary alcohols, diols, ketones, aldehydes, aliphatic aldehydes, primary and secondary alcohols, β-diketones, triacylglycerols, and many more. Specific examples of plant wax include Carnauba wax, candelilla wax, ouricury wax, jojoba plant wax, bay-berry wax, Japan wax, sunflower wax, tall oil, tallow wax, rice wax, and tallows.

Animal wax includes beeswax as well as waxes secreted by other insects. A major component of the beeswax used in constructing honeycombs is the ester myricyl palmitate which is an ester of triacontanol and palmitic acid. Spermaceti occurs in large amounts in the head oil of the sperm whale. One of its main constituents is cetyl palmitate, another ester of a fatty acid and a fatty alcohol. Lanolin is a wax obtained from wool, consisting of esters of sterols. Other animal wax examples include lanocerin, shellac, and ozokerite.

Examples of mineral waxes include montan wax, paraffin wax, microcrystalline wax and intermediate wax. Although many natural waxes contain esters, paraffin waxes are hydrocarbons, mixtures of alkanes usually in a homologous series of chain lengths. Paraffin waxes are mixtures of saturated n- and iso-alkanes, naphthenes, and alkyl- and naphthene-substituted aromatic compounds. The degree of branching has an important influence on the properties. Montan wax is a fossilized wax extracted from coal and lignite. It is very hard, reflecting the high concentration of saturated fatty acids/esters and alcohols. Montan wax includes chemical components formed of long chain alkyl acids and alkyl esters having chain lengths of about 24 to 30 carbons. In addition, natural montan includes resin acids, polyterpenes and some alcohol, ketone and other hydrocarbons such that it is not a “pure” wax. The saponification number of montan, which is a saponifiable wax, is about 92 and its melting point is about 80° C. In addition to montan wax, other naturally derived waxes are known for use in various industries and include petroleum waxes derived from crude oil after processing, which include macrocrystalline wax, microcrystalline wax, petrolatum and paraffin wax. Paraffin wax is also a natural wax derived from petroleum and formed principally of straight-chain alkanes having average chain lengths of 20-30 carbon atoms.

Synthetic waxes include waxes based on polypropylene, polyethylene, and polytetrafluoroethylene. Other synthetic waxes are based on fatty acid amines, Fischer Tropsch, and polyamides. Polyethylene and related derivatives. Some waxes are obtained by cracking polyethylene at 400° C. The products have the formula (CH₂)ₙH₂, where n ranges between about 50 and 100.

Also known synthetic waxes which include synthetic polyethylene wax of low molecular weight, i.e., molecular weights of less than about 10,000, and polyethylenes that have wax-like properties. Such waxes can be formed by direct polymerization of ethylene under conditions suitable to control molecular weight. Polyethylenes with molecular weights in about the 2,000-4,000 range are waxes, and when in the range of about 4,000-12,000 become wax resins.

Fischer-Tropsch waxes are polymethylene waxes produced by a particular polymerization synthesis, specifically, a Fischer-Tropsch synthesis (polymerization of carbon monoxide under high pressure, high temperature and special catalysts to produce hydrocarbon, followed by distillation to separate the products into liquid fuels and waxes). Such waxes (hydrocarbon waxes of microcrystalline, polyethylene and polymethylene types) can be chemically modified by, e.g., air oxidation (to give an acid number of 30 or less and a saponification number no lower than 25) or modified with maleic anhydride or carboxylic acid. Such modified waxes are more easily emulsified in water and can be saponified or esterified. Other known synthetic waxes are polymerized alpha-olefins. These are waxes formed of higher alpha-olefins of 20 or more carbon atoms that have wax like properties. The materials are very branched with broad molecular weight distributions and melting points ranging about 54° C. to 75° C. with molecular weights of about 2,600 to 2,800. Thus, waxes differ depending on the nature of the base material as well as the polymerization or synthesis process, and resulting chemical structure, including the use and type of any chemical modification.

The matrix particles can be made either by polymerization or physical material breakdown, emulsion, dispersion, and/or suspension polymerization, core-shell polymerization, solvent dispersion, cavitation of fluids and/or solids in fluids, amalgamation of susceptors and catalysts, amalgamation followed by pulverizing, grinding and like processes.

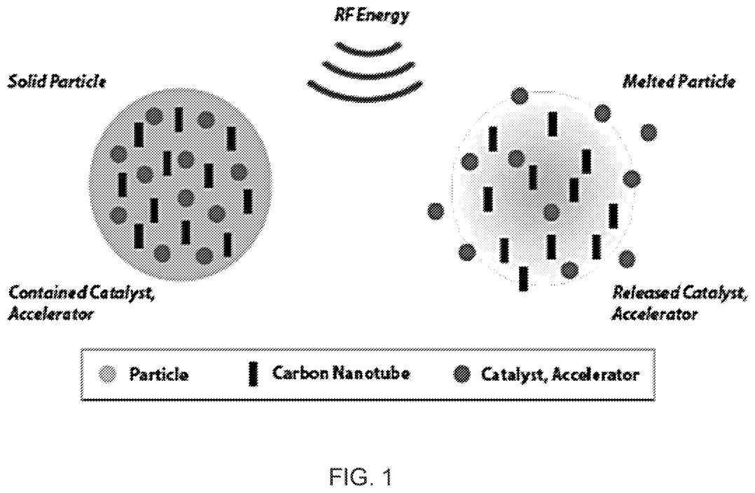

As shown in FIG. 1, a solid matrix particle is shown that comprises carbon nano-tubes as susceptor component and a catalyst for accelerating the chemical reaction. Radio frequency is impinged on the matrix particle which heats up the carbon nanotube particles. These particles are embedded in proximity of the catalyst particles. The matrix material is melted or deformed, fully or partially, but as a result of the radio frequency, the catalyst is released which then catalyzes the reaction of the substance in with a plurality of matrix particles are incorporated.

In this embodiment, the RF or MW energy only heats and melts the matrix particles. The rate of heating of the matrix particle is many orders higher than the adjacent materials. The differential heating the matrix particles leads to the deformation of the matrix particles without causing the bulk heating. Furthermore, uniformly dispersed matrix particles and the size of particles leads to no appreciable heating of the adjacent formulations. As a result, the RF or MW energy activates the release of the contents of the matrix particles to induce polymerization uniformly and quickly. In one embodiment, it requires 2% or less of catalyst, typically in the ppm range. In one embodiment, the catalyst percent is any number selected from the numbers provided below, or is within a range defined by any two numbers below, including the endpoints of such range:
0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, and 2.0.

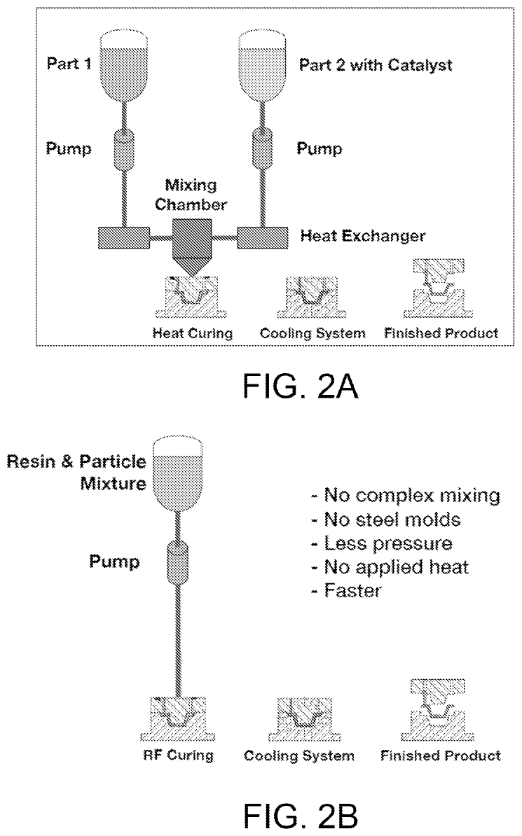

FIG. 2 shows reaction injection molding as currently practiced and with the invention. As a result of the invention, no complex mixing is required. Instead of heat curing, RF curing is done. This eliminates or reduces the use of steel molds; the reaction can be accomplished under lower pressure without application of gross heat and is faster. It also significantly reduces cure times.

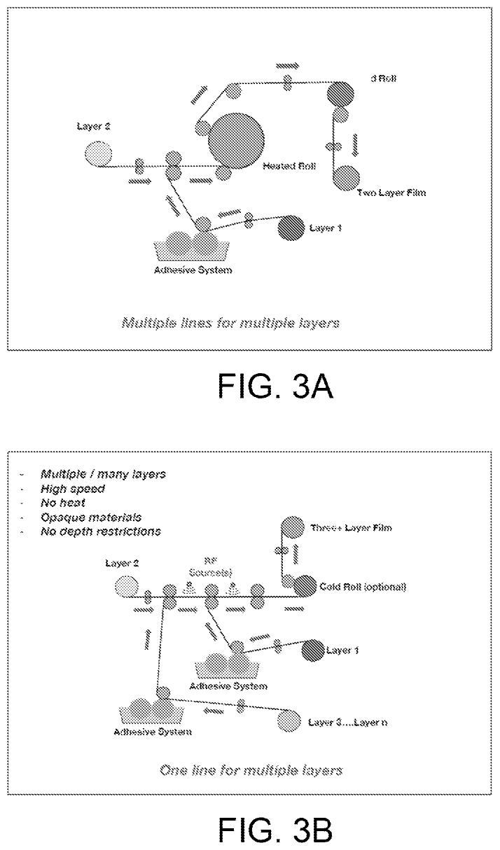

As shown in FIG. 3, as currently practiced, for film laminating adhesives, multiple film lines are used for multiple layers. With the use of the current invention, one line can be used for multiple layers. The advantage is high speed, no heat, opaque materials can be cured, and there are no depth restrictions. Control of curing location is also achieved, in addition to acute control of when in production curing is performed.

In one embodiment, the RF or MW is a directed source, in that the radiation is focused on a particular object or region of interest.

In some embodiments, the matrix may have a coating. In some embodiments, the coating is continuous. In some embodiments, the coating is discontinuous. In some embodiments, the coating is patterned. In some embodiments, the coating is deposited in one or more layers. In some embodiments, the coating is anisotropic.

In some embodiments, the coating attaches to the matrix by one or more means including, for example, entanglement, van der Waals interactions, through one or more chemically-bound compounds, and the like. In some embodiments, the coating includes one or more of a wax, one or more hydrophobic compounds and/or hydrophobic functional groups, one or more compounds having a nonpolar component including a nonpolar tail, including one or more oils, fatty acids, and the like.

The coating may have a thickness of up to 10 nm, from about 10 nm to about 15 nm, from about 50 nm to about 100 nm, from about 100 nm to about 500 nm, from about 500 nm to about 1 μm, from about 1 μm to about 2 μm, from about 2 μm to about 5 μm, from about 5 μm to about 10 μm, from about 10 μm to about 50 μm, from about 50 μm to about 100 μm, from about 100 μm to about 500 μm, from about 500 μm to about 1 mm, from about 1 mm to about 2 mm, from about 2 mm to about 5 mm, from about 5 mm to about 10 mm, from about 10 mm to about 50 mm, from about 50 mm to about 100 mm, from about 100 mm to about 500 mm, and any and all increments therebetween.

Embodiments of the matrix may include one or more additional components for providing controlled on-demand release. For example, matrices and or a coating and or a discontinuous coating containing matrices, coated or not, on any surface facile for matrix activation, such as round fibers, textile fibers, polymeric fibers, hollow fibers, reinforcing fiber such as that utilized in composites, sheets, flexible or inflexible materials, foams and other porous structures, non-woven materials, woven materials, polymer scrims, reinforcement scrims, and the like.

In some embodiments, the matrix includes one or more fillers. Embodiments of the fillers include particles such as fibers. The fibers may have one or more lengths. The fibers can include milled fibers. Embodiments of the fillers include one or more of clays, aggregates, plasticizers, plastic particles, nanoparticles of different shapes and the like.

### Particle Activation Process and Equipment

Particle activation, process and equipment constitutes a complete “System,” including various types of susceptors, activators, matrix components, RF and/or MW energy source(s), material handling, software, and controls.

Speed, time, unit throughput, form factor, topology, and unit volume are among the dependent characteristics that are analyzed for each application and adjusted by the Systems to produce a desired end artifact or result for a given set of materials.

Susceptors are excited via external high-frequency EMR to deform, in part or whole, the surrounding matrix or matrices to release the catalyst, co-catalyst, co-reactant, or accelerator. In areas such as remote joule heating properties of CNTs, without being bound to theory of the physical properties of how the CNTs heat the surrounding materials, the heated CNTs are used to deform the surrounding matrix.

In the most common form, microwave electromagnetic radiation with wavelengths ranging from about one meter to one millimeter; with frequencies between 300 MHz (1 m) and 300 GHz (1 mm) are used to excite the susceptors and deform the surrounding matrix to release the catalyst or activator material. In practice, various electromagnetic wavelengths and frequencies can be used; preferably the currently most common for consumer and industrial applications are frequencies of 915 MHz and 2450 Mhz. However, the one or more suitable frequencies may include up to about 100 MHz, from about 100 MHz to about 200 MHz, from about 200 MHz to about 400 MHz, from about 400 MHz to about 600 MHz, from about 600 MHz to about 800 MHz, from about 800 MHz to about 1 GHz, from about 1 GHz to about 1.5 GHz, from about 1.5 GHz to about 2 GHz, from about 2 GHz to about 2.5 GHZ, from about 2.5 GHz to about 5 GHZ, from about 5 GHz to about 7.5 GHZ, and any and all increments therebetween.

TABLE 1
Radiation Frequencies and Wavelengths

| Microwave Frequency | Wavelength | |
|---|---|---|
| 245 MHz ± 0.2% | 122.19 | cm |
| 433.92 MHz ± 0.2% | 69.14 | cm |
| 580 MHz ± 0.2% | 51.61 | cm |
| 915 MHz ± 13 MHz | 32.75 | cm |
| 2.45 GHz ± 50 MHz | 12.24 | cm |
| 5.8 GHz ± 75 MHz | 5.17 | cm |
| 24.125 GHz ± 125 MHz | 1.24 | cm |

In one embodiment of the invention, the process of applying electromagnetic radiation, that is, impinging the bulk reaction mixture is performed for 10 seconds to 60 minutes. In another embodiment, the time of radiation is any one number selected from the following, in seconds, or a number within a range defined by any two numbers below, including the end-points of such range, in seconds:
10, 15, 20, 25, 30, 35, 40, 45, 50, 55, 60, 100, 200, 300, 400, 500, 600, 700, 800, 900, 1000, 1100, 1200, 1300, 1400, 1500, 1600, 1700, 1800, 1900, 2000, 2100, 2200, 2300, 2400, 2500, 2600, 2700, 2800, 2900, 3000, 3100, 3200, 3300, 3400, 3500, and 3600.

In one embodiment of the invention, the EMR is used as a beam to be impinged upon the bulk reaction mixture, where the bulk reaction mixture is bathed in RF or MW radiation.

### Applications

Exemplary applications include but are not limited to the following:

### Adhesive Bonding

Releasing a catalyst, co-catalyst and or accelerator and the like on demand wherein the limitations of gross heating, multi-component mixing, long polymerization times and or the limits of depth, such as with light and or surface primer activated systems can be eliminated by dispersing as desired said ingredients within the polymerizable composition and activated on demand at a desired moment within the bonding or bond and or part preparation process. Benefits also include much more precise positioning without a reaction changing viscosity dynamics.

### Coating

Releasing a catalyst, co-catalyst and or accelerator and the like on demand wherein the limitations of gross heating, multi-component mixing, long polymerization times and or the limits of depth, such as with light and or surface primer activated systems can be eliminated by dispersing as desired said ingredients within the polymerizable composition and activated on demand at a desired moment within the coating or coating and or part preparation process. Benefits also include flow control before and without a reaction changing viscosity dynamics. Can overcome the limitations of UV curable systems such as incomplete cure in shadow areas and parts that have complex shapes. No limitation to curing, 3D and concave parts that have large appendages. Coating rates can be matched with the upstream and down-stream processing-debottlenecking the manufacturing throughputs.

### Molding and Composites

Releasing a catalyst, co-catalyst and or accelerator and the like on demand wherein the limitations of gross heating, multi-component mixing, long polymerization times and or the limits of depth, such as with light and or surface primer activated systems can be eliminated by dispersing as desired said ingredients within the polymerizable composition and activated on demand at a desired moment within the molding or mold and or part preparation process. Parts can be filled with many materials. Parts could be as large or larger than 14 feet by 14 feet in cross section. In the context of the present description, all publications, patent applications, patents and other references mentioned herein, if not otherwise indicated, are explicitly incorporated by reference herein in their entirety for all purposes as if fully set forth.

Surprisingly, it has been found that nano and micro particles can serve as carriers for more effectively delivering nanomaterials into sealants, coatings, composites, adhesives, and other polymeric products. Of particular interest are where physical properties of an end composition and or physical product are achieved, including, but not limited to, thermal and electrical conductivity, improved and or controlled strength, toughness, elasticity, chemical resistance, environmental resistance, energy dampening and the like and improved or con-trolled product life and or failure.

The invention is specifically, but not limited to, particles carrying layers of, filled with or otherwise nanomaterials, including metals and their chemical products, graphene, nanotubes and like structures for the benefit of improved physical, electrical, conductive and other like properties minimizing by example the need for more significant amounts of said nanomaterials.

Optionally, crosslinking chemistries can be incorporated into or on the surface of said particles, either simply using surface chemistry or as ligand or oligomeric like structures capable of even further enhancing noted physical performance.

Specifically, one can incorporate within and or coat polymer-based particles with nanomaterials such as nanotubes or like structures, specifically by example carbon nanotubes and or graphene or like structures. This basic concept helps to limit among other things overall amounts of material required, can provide a large surface area containing said structures through which forces to separate are spread, limits agglomeration and so on. Where the nano and or micro particles are coated with van der Waals and other physical or chemical force ameliorating coating, these effects can be further ameliorated and or amplified and controlled as desired.

Literature notes the coating of said particles with by example carbon nanotubes or the coating of individual nanotubes. Here, we differentiate by coating particles with nanotubes and then coating with force ameliorating compositions, incorporate more than one and preferably three or more nanotubes and or then coating with force ameliorating compositions.

Optionally, one can incorporate within the particles and or their coatings if any chemical functionalization for either subsequent reaction or physical effects. Examples of chemical reactions are myriad, and not limited, but include crosslinking and or polymerization reactions. Physical effect can include ligand, polymeric and or oligomeric structures for, by example, physical combining with a surrounding polymer matrix or in the case of a metallic or soapy ligand, dispersion or inclusion into emulsions, dispersions and the like, in solvent, water or otherwise. The optional inclusion-See U.S. patent application Ser. No. 18/055,302 to Malofsky et.al., which is incorporated by reference as if it is fully set forth herein,—of catalysts, co-catalyst, accelerators, fuels, energetic materials and the like are included in said invention.

An additional objective of the present invention is to provide polymeric nano and microparticles with functionalities on surfaces that can irreversibly/reversibly diminish when the composition containing polymer microparticles is applied to compositions containing sealants, composites, adhesives, other polymeric products and the like.

Other objective is to provide functionalities capable of non-covalent bonding such as hydrogen bonding or van der Waals when the composition containing polymer microparticles are applied in the composition for sealants, composites, adhesives, and other polymeric products.

In general, these functional nano and microparticles are versatile platforms with tunable properties that can be tailored to meet specific application requirements. These functional nano and microparticles find use in many application, including, but not limited to adhesives, composites, laminates, sealants, coatings, inks, plastics and the like in many final products across many consumer, industrial and or medical applications.

The functional nano microparticles include latex particles, nano and microgel particles, colloidal particles, including but not limited to colloidal particles composed of polymer chains that are dispersed in water or other solvents. Also included are microgel particles that can swell or shrink in response to changes in their environment.

The functional microparticles containing reactive functional groups such as carboxylic acids, amino groups, thiol, epoxy, acrylics, isocyanates can be cross-linked with other functionalized particles.

In the coating, crosslinked polymer microparticles are used to produce compositions that contain a high solids content and/or to improve the rheological properties.

Polymers with functional microparticles, such as waterborne polyurethanes (WPU), polyester dispersions (PED), and polyacrylate emulsions (PAE), which are commonly used in wood coatings, metal coatings, printing inks, architectural coatings, and plastic coatings. Despite their inherent advantages, polymers have some drawbacks, such as low mechanical strength, low hardness, high water sensitivity, and heat softening. Water borne reactions have a relatively slow reaction rate and can also cause health hazards because of the release and use of hydrazine, formaldehyde, and other toxic chemistries.

In addition to making the polymer particles dispersible in liquids, the surface functionalities eliminate slow reactivity, and the need to accelerate reactions using toxic chemistries.

With a core and shell configuration, the nanomaterials present in the core and cross-linkable functionalities on the shell help protect the CNTs until secondary processing is carried out. Nanomaterials released will increase interaction and crosslinking densities due to van der Waals forces.

As another aspect of the invention, the present invention provides a microparticle composition consisting of nanomaterials, catalysts, crosslinkers in the cores, and functionalities on the shells. Further objectives of the invention can be achieved by producing microparticles with particle sizes ranging from 0.01 to 10 microns, as well as by modifying preexisting microparticles.

Further objectives of the invention can be achieved by producing nano and micro-particles with particle sizes ranging from 0.01 to 100 microns, including modifying preexisting microparticles.

Polymer microparticles of this invention are engineered into specific shapes, sizes, and surface chemistries, so that hybrids of organic and inorganic materials can be created.

A further aspect of the present invention provides a method for manufacturing the cross-linked polymer microparticles with nanomaterials embedded within them. Also, the cross-linked microparticles can be delivered in a masterbatch or as standalone particles.

A covalent adaptable network (CAN) is a polymer material that has covalent bonds that can be broken and reformed under certain conditions. Materials with reversible or tunable properties, such as mechanical strength or viscosity, can be developed in this way.

The low entropy of the functional groups on the microparticles enhances the chance of CAN formation in comparison with conventional crosslinkers. Carbon nanotubes and graphene on the surface of functional microparticles provide additional anchoring sites for CAN formation.

These cross-linkable, reversible groups attached to microparticles help to create self-healing coatings, adhesives, composites, and structural materials through CANs.

Functional groups on microparticles used in PSA (Pressure Sensitive Adhesives) improve their tack, making them more readily adhere to surfaces. Functional microparticles provide additional contact points between the adhesive and the substrate, reducing the chance of creep failure over time.

The addition of nanomaterials with high modulus such as CNTs and graphene, enhances the resistance to deformation.

Pressure causes the functional particles to collapse in PSAs, releasing the chemistry, facilitating further crosslinking with the substrate, and enhancing adhesion. Functional microparticles provide a tunable bond line thickness. Microparticles can, for example, increase an adhesive's viscosity, which improves its shear strength and prevents it from flowing.

A further aspect of the invention relates to superior thermal and electrical conductivity using materials more efficiently and incorporating them with a lower viscosity by creating an apparently honeycomb network allowing for a final polymer based, highly conductive product.

The ability to heat a composition and release catalyst, co-catalyst, an accelerator or such other reaction-initiating compound on demand and at low to no significant additional energy input enables new processes, materials and subsequent products and processes that were previously unattainable, specifically regarding hot-melt adhesives, molding, preforms, plastics for thermoplastic molding, and over-molding dissimilar materials. In over-molding process the adhesive layer functions to compatibilize thermoplastic and thermoset.

Specifically, this invention relates to the addition of carbonaceous susceptor particles coated with materials capable of preventing strong van der Waals force interactions and or individual or clusters of carbonaceous susceptors costed with materials capable of preventing van der Waals interactions such that the latter force affects are significantly minimized or eliminated allowing for the facile addition of said materials, especially at higher concentrations, to facilitate RF heating to make facile physical deformations, including softening or melting. The aforementioned coatings significantly reduce clumping or other macro-structures capable of causing significant viscosity increases or similar physical effects. The coatings can slow, stop, or prevent where thermal, electrical conduction, or other similar effects are desired. The aforementioned composition can be readily mixed into the existing formulations using conventional equipment.

Hot-melt adhesive applications illustrate the overall possible effects extendable to other products containing materials ranging from low molecular weight materials, bio-sourced, temperature-sensitive renewable material, to high molecular thermoplastic resins and polymers.

Specifically, one can coat carbonaceous materials as individual, clusters, particles coated with and other combinations incorporating optionally other materials such that van der Waals effects are minimized significantly reducing viscosities through a temperature range allowing for more of said coated materials to be incorporated.

In one embodiment, the invention allows for a higher loading of said materials to facilitate RF heating, particularly microwave heating to facilitate ease of processing and or high levels of reinforcement. As noted in the background above, other purposes can include conductivity of heat or electricity, reaction initiation, matching CTEs, thermal conductivities via particles and so on.

Preforms comprise another example application group where we enable first addition of said carbonaceous materials to polymers in the melt for any of the properties noted above or for reactive options using particles containing catalysts and the like noted in U.S. patent application Ser. No. 18/055,302 to Malofsky et.al., in particular to initiate reactions where particles maintain integrity at the forming or deformation temperature during part making processing until RF heated to an even higher temperature for catalyst or otherwise release or exposure and subsequent activation. RF heating would enable high speed manufacturing for high throughputs and lower costs. Such a process in certain applications can eliminate B-stage preform or material refrigeration.

Plastics injection, blow molding and layers for hot binding of polymer or polymer coated layers (extrusion) served similarly to the above.

The bonus of added reinforcements, such as carbon, glass, aramid, ultra-high molecular weight polyethylene and natural and synthetic fibers and other combinations is demonstrated in multiple ways.

This method provides the advantage of the ease of addition and lower viscosity.

Example of the applications include reinforced hot melts; reactive hot melts; hot melt coated articles, webs, films, continuous or not; hot melt coated fibers, continuous or not; hot melt adhesive articles, including fibers, ropes, shapes, dots and preform articles made from monomers, polymers and/or oligomers.

One of the advantages is the substrate attachment with minimal squeeze out of the materials of adhesive.

Some of the uses of the present invention include the following:
Electrically conductive materials
Thermally conductive materials
Recyclable materials
Architectural, industrial coatings
Sealants—strength, durability, and adhesion of sealants. Improved Elasticity and flexibility. Resistance to UV radiation and moisture, better adhesion
Composites—fractured toughness, high modulus,
Adhesives—fractured toughness, high modulus,
Pressure sensitive Adhesive
Pressure sensitive reactive adhesives
Drug delivery—These particles can also be designed to release drugs in a controlled manner, allowing for targeted drug delivery and reducing the risk of side effects.
Imaging—contrast agents for imaging techniques such as MRI and CT scans.
3D printing: higher Z directional property-
Coatings—Abrasions strength
Plywood
Geotextiles (Road construction, rail line construction, River Bank construction)
Roofing, insulation, and cladding, acoustic and structural laminates

### Examples of Final or Intermediate Products

Examples of the final or the intermediate product include the following:
Additives in coatings to provide various properties, such as scratch resistance, UV protection, and water repellency.
Automotive coatings to improve their durability.
Textile coatings to provide various properties, such as water repellency, stain resistance, and antimicrobial activity.
Porous ceramic materials with specific pore sizes and distributions. The polymer template is removed during firing, leaving behind a porous ceramic material with tailored properties.
Shoes—linings, body parts, etc., and their ultimate construction.
Apparel—linings, body parts, etc., and their ultimate construction.
Packages—linings, body parts, etc., and their ultimate construction, sealings, closures.
Boxes—linings, body parts, etc., and their ultimate construction.
Decorate flexible and laminated articles (tablecloths, drapes . . . ).
Furniture.
Oil & Gas Film Products.

Unless otherwise defined, all technical and scientific terms used herein have the same meaning as commonly understood by one of ordinary skill in the art to which this disclosure belongs. In case of conflict, the present specification, including definitions, will control.

Except where expressly noted, trademarks are shown in upper case.

Unless stated otherwise, all percentages, parts, ratios, etc., are by weight.

Unless stated otherwise, pressures expressed in psi units would be gauge, and pressures expressed in kPa units would be absolute. Pressure differences, however, are expressed as absolute (for example, pressure 1 is 25 psi higher than pressure 2).

When an amount, concentration, or other value or parameter is given as a range, or a list of upper and lower values, this is to be understood as specifically disclosing all ranges formed from any pair of any upper and lower range limits, regardless of whether ranges are separately disclosed. Where a range of numerical values is recited herein, unless otherwise stated, the range is intended to include the endpoints thereof, and all integers and fractions within the range. It is not intended that the scope of the present disclosure be limited to the specific values recited when defining a range.

When the term “about” is used, it is used to mean a certain effect or result can be obtained within a certain tolerance, and the skilled person knows how to obtain the tolerance. When the term “about” is used in describing a value or an end-point of a range, the disclosure should be understood to include the specific value or end-point referred to.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but can include other elements not expressly listed or inherent to such process, method, article, or apparatus.

The transitional phrase “consisting of” excludes any element, step, or ingredient not specified in the claim, closing the claim to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole.

The transitional phrase “consisting essentially of” limits the scope of a claim to the specified materials or steps and those that do not materially affect the basic and novel characteristic(s) of the claimed invention. A “consisting essentially of” claim occupies a middle ground between closed claims that are written in a “consisting of” format and fully open claims that are drafted in a “comprising” format. Optional additives as defined herein, at a level that is appropriate for such additives, and minor impurities are not excluded from a composition by the term “consisting essentially of”.

Further, unless expressly stated to the contrary, “or” and “and/or” refers to an inclusive and not to an exclusive. For example, a condition A or B, or A and/or B, is satisfied by any one of the following: A is true (or present) and B is false (or not present), A is false (or not present) and B is true (or present), and both A and B are true (or present).

The use of “a” or “an” to describe the various elements and components herein is merely for convenience and to give a general sense of the disclosure. This description should be read to include one or at least one and the singular also includes the plural unless it is obvious that it is meant otherwise.

All references cited in this document are incorporated by reference as if fully set forth herein.

### EXPERIMENTAL EXAMPLES

### Example 1—Methylene Malonate Polymerization via Anionic Polymerization Composition

This embodiment relates to a curable composition containing matrix particle, comprising:
(a) a methylene malonate monomer,
(b) a stabilizer solution, and
(c) an activator,
   (i) wherein the activator comprises a cation at a level of 0.1-500 ppm; and
   (ii) wherein the activator is encapsulated in a thermally deformable and or thermally soluble matrix particle also containing an RF susceptor (e.g. a carbon nanostructure).

### Formulations

The formulations are made up as follows by weight %, with other variations added as desired:
1. a difunctional or greater methylene malonate monomer, oligomer, or resin at 20% to 70.0%;
2. a diethyl, dipropyl, dibenzyl, di-isobornyl or similar methylene malonate monomer, 20% to 70%; and
3. an acid stabilizer solution 0.1% to 0.7%.

To the above formulations, 50 to 5000-nanometer matrix particles comprising of 90% paraffin wax, or an olefinic polymer, or oligomeric wax or similar, 8% carbon nano-tubes, and 2% activator such that the particles exhibit, in the final overall composition, 5 ppm of the activator cation.

### Matrix Studies

Overall, the activator ranges from 0.5 ppm to 500 ppm, which is accomplished by varying the concentration of either the matrix particles, from 0.5% to 10%, and the power levels to determine in the application itself the proper frequency, power level, and thus, the time required to activate said particles, and consequently, the polymerization.

### MF-Transparent Fillers

One can then adjust formulations as created above by using chemically neutral, optionally dry RF transparent fillers, for example, minerals such as calcium carbonate, glass or glass powders, polymer powders, wood or other organic powders, silicas, silicates, and ceramics. Where moisture is a challenge, combinations of transition metal accelerators could be used, in particular copper hexanoate and iron, specifically ferrocene.

### Curing, Substrates and Containers

As formulations vary, cure speed and thus exotherms of polymerization will vary. Accordingly, one should start by placing small amounts of a formulation such that a thin film fits between two glass slides, thus minimizing materials and still creating an anaerobic condition and allowing for viewing. In the next step, one can add spacers to make thick bonds. In the next step, one can move to narrow test tubes and or syringe bodies. Next, one can scale to larger test tubes and or syringe bodies. Next one can scale to small beakers. Larger volume material assemblies and or containers can be placed in oils and/or water to control thermal conduction of exotherms to avoid dangerous situations.

Essentially, RF transparent materials are desired for containment or part of the containment such that the RF energy required can be aptly transmitted.

### Example 2—Free Radical Polymerization Via Anaerobic Polymerization

### Composition

This embodiment relates to a curable composition comprising:
(a) an acrylate and or methacrylate monomer,
(b) a hydroperoxide or perester initiator, and
(c) an activator,
   (i) wherein the activator comprises a source of copper ion at a level of 0.1-100 ppm copper;
   (ii) wherein the activator is encapsulated in a thermally deformable and or thermally soluble matrix particle also containing an RF susceptor.

### Formulations

Formulations were made up as follows by weight %, with other variations added as desired:
1. Triethylene glycol dimethacrylate, a urethane diacrylate, or an epoxy diacrylate 20% to 70.0%
2. Lauryl, ethyl, methyl, ethyl hexyl, cyclohexyl, isobornyl methacrylate, 20% to 70%
3. Cumene hydroperoxide 0.5% to 3.0%
4. Stabilizer solution* 0.3% to 0.7%
5. Saccharin 0.1% to 0.5%

To these formulations, the following are added: 50 to 5000-nanometer matrix particles comprising of 90% by weight of one or more of a paraffin wax, an olefinic polymer, an oligomeric wax, or a similar matrix; 8% carbon nanotubes; and 2% copper ethyl hexanoate activator. These components are added such that the particles exhibit 0.6 ppm copper in the final composition.

Instead of the 2% copper, one can also add, 0.06% to the formulation of a 50% particle dispersion with 2% ferrocene in said particles.

### Matrix Studies:

The copper hexanoate concentration ranges from 0.6 ppm to 60 ppm, which was accomplished by varying the concentration of the matrix particles, the % of the compounds in the matrix particles from 0.5% to 10%, and the power levels to determine in the application itself the proper RF wavelength, power level and thus time required to activate said particles and thus polymerization.

### RF-Transparent Fillers

Formulations were adjusted as created above by using chemically neutral, optionally dry RF transparent fillers, such as many minerals such as calcium carbonate, glasses or glass powders, polymer powders, wood or other organic powders, silicas, silicates, ceramics and the like. Where moisture is a challenge combinations of transition metal accelerators were used, in particular copper hexanoate and iron, specifically ferrocene.

### Curing, Substrates and Containers

As formulations vary, cure speed and thus exotherms of polymerization will vary. Accordingly, first place small amounts of a formulation such that a thin film fits between two glass slides, thus minimizing materials and still creating an anaerobic condition and allowing for viewing. Next, add spacers to make thick bonds. Next, move to narrow test tubes and or syringe bodies. Next scale to larger test tubes and or syringe bodies. Next scale to small beakers. Larger volume material assemblies and or containers are placed in oils and or water to control thermal conduction of exotherms to avoid dangerous situations. Essentially, RF transparent materials are desired for containment or part of the containment such that the RF energy required can be aptly transmitted.

### Example 3—Processes for Using Commercial Microparticles as Cores

This study demonstrates the use of available microparticles as the core of a matrix particle to carry the activator to initiate curing in a one-part adhesive formulation. The main object of the study is to demonstrate the use commercial PMMA already on the micro/nanoscale particles as carriers for acrylic activation by attaching the copper activators to the surface of the core of the commercially available particle.

TABLE 2
Commercially Available Particles Tested

| PMMA Product | |
|---|---|
| Name** | Particle Size |
| MX-500ML | 0.8 μm to 30 μm; average particle size: 5 μm |
| MP-1441 | 0.15 μm to 0.4 μm; average particle size: 0.17 μm |
| XX-6666Z | average particle size 4.7 μm |
| MX-180TA | 0.8 μm to 30 μm; average particle 1.8 μm |

**The MX-500ML, MP-1441, MX-180TA were sourced from the company Soken, Japan, and the XX6666Z was sourced from Sekisui kasei, Japan.

The following formulations were prepared to evaluate conditions for preparing matrix particles using various commercially available PMMA particles as the core of the matrix particles.

Formulation 1—Commercial PMMA (MX-500ML) (2 g) was filter-washed first with a 10% (100 mL) sodium hydroxide solution and then with a 10% (10 mL) cupric chloride solution, rinsed with DI water, and dried.

Formulation 2—Commercial PMMA (MX-500ML) (2 g) was filter-washed first with a 10% (100 mL) sodium hydroxide solution and then with a 10% (10 mL) cupric chloride solution, rinsed with DI water, and dried.

Formulation 3—Commercial PMMA (MP-1441) (2 g) was filter-washed with a 10% (100 mL) sodium hydroxide solution and then with a 10% (10 mL) cupric chloride solution, rinsed with DI water, and dried.

Formulation 4—Commercial PMMA (XX-6666Z) (2 g) was filter-washed with a 10% (100 mL) sodium hydroxide solution and then with a 10% (10 mL) cupric chloride solution, rinsed with DI water, and dried.

Formulation 5—Commercial PMMA (MP-1441) (5 g) was ultrasonicated with copper (II) 2-ethylhexanoate (1 g) in isopropanol and filter-washed with additional isopropanol.

Formulation 6—Commercial PMMA (MX-180TA) (2 g) was ultrasonicated with cupric chloride (0.125 g) in isopropanol and filter-washed with additional isopropanol.

Formulation 7—Commercial PMMA (MX-180TA) (4 g) was ultrasonicated with copper (II) 2-ethylhexanoate (0.21 g) in isopropanol and filter-washed with additional isopropanol.

Formulation 8—Commercial PMMA (MX-180TA) (4 g) was ultrasonicated with cupric chloride (0.2 g) in isopropanol and vacuum-filtered.

### Example 4—Preparation of Particle Cores Through Emulsion Polymerization

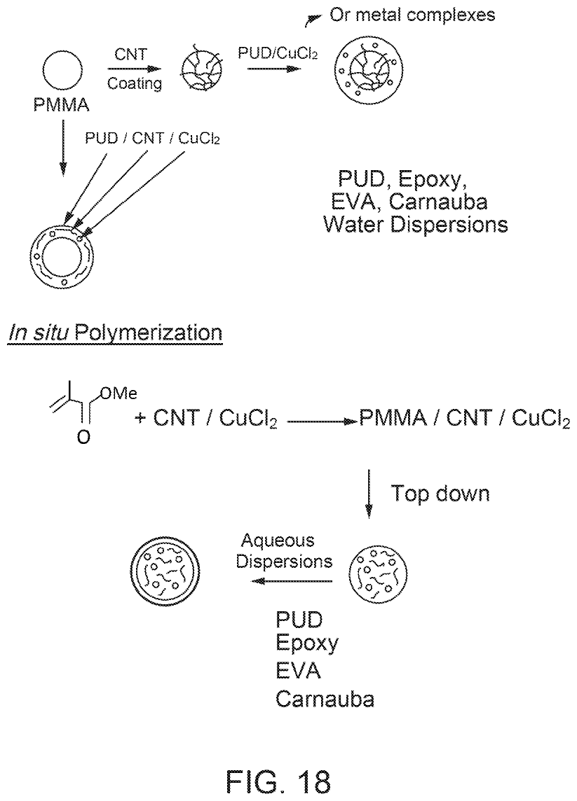

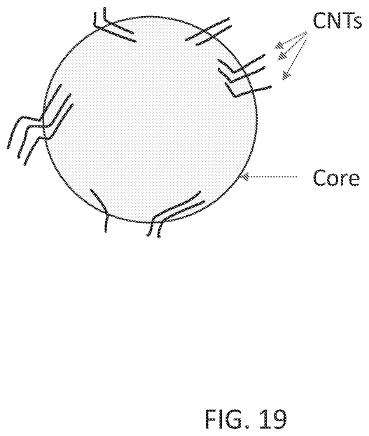

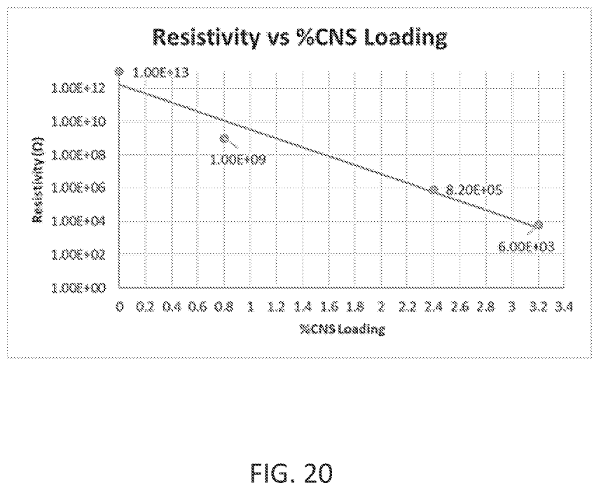

The main object of the study was to prepare nano-microparticle cores through emulsion polymerization, particularly through that of methacrylates. An exemplary reaction diagram is shown in FIG. 18. The formulations were prepared using an oil-in-water emulsion—of methacrylate in water—in order to emulsion polymerize into nanoparticles.

Experiment 1—At 70° C., methyl methacrylate (3 mL) was added to DI water (16 mL) to emulsify under inert gas. The polymerization reaction was catalyzed by ((2,2-azobis) 2-methyl-propionamidine) dihydrochloride (10-15 mg) and stirred for 30 minutes.

Experiment 2—At 70° C., methyl methacrylate (3 mL) was added to DI water (16 mL) to emulsify under inert gas. The polymerization reaction was catalyzed by ((2,2-azobis) 2-methyl-propionamidine) dihydrochloride (10-15 mg) and stirred for 40 minutes at 450 rpm.

Experiment 3—At 70° C., methyl methacrylate (3 mL) was added dropwise over 30-40 minutes to DI water (16 mL) to emulsify under inert gas. The polymerization reaction was catalyzed by ((2,2-azobis) 2-methyl-propionamidine) dihydrochloride (10-15 mg) and stirred for 40 minutes.

Experiment 4—Copper (II) 2-ethylhexanoate was dissolved in methyl methacrylate (3 mL) and injected into DI water (16 mL) under inert gas at 70° C. ((2,2-azobis) 2-methyl-propionamidine) dihydrochloride (10-15 mg) was added and stirred for 40 minutes at 350 rpm.

### Example 5—Process for the Preparation of Hollow Particle Cores

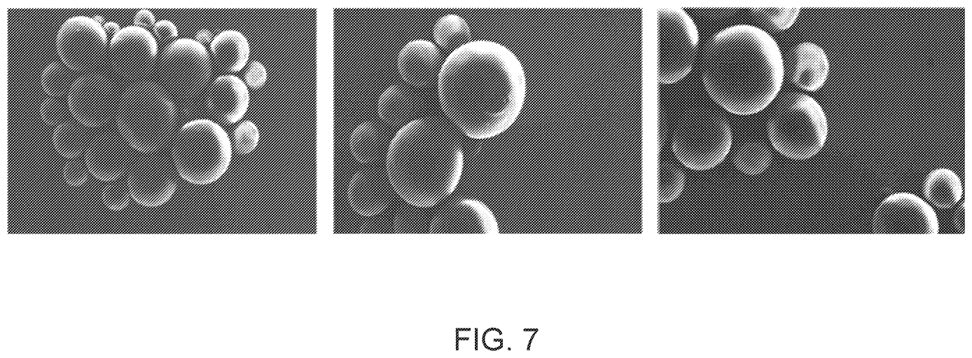

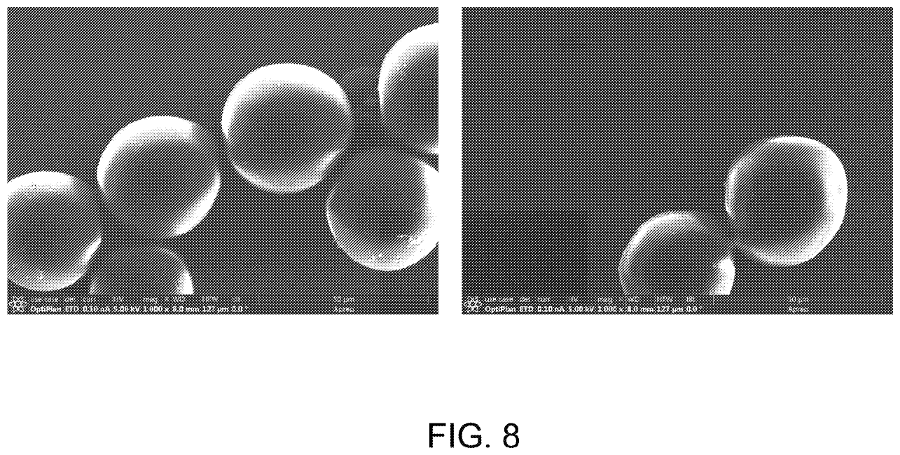

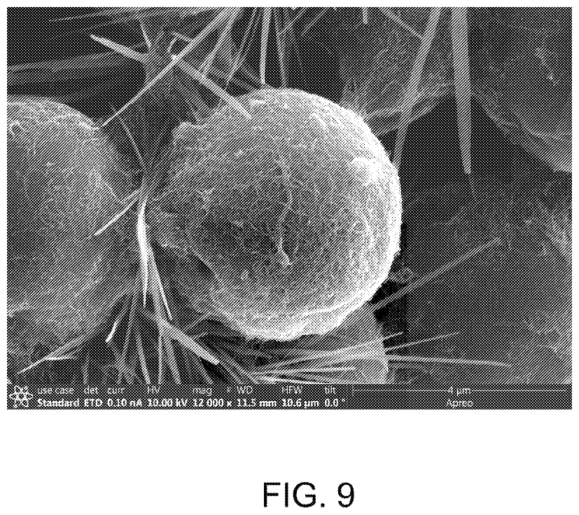

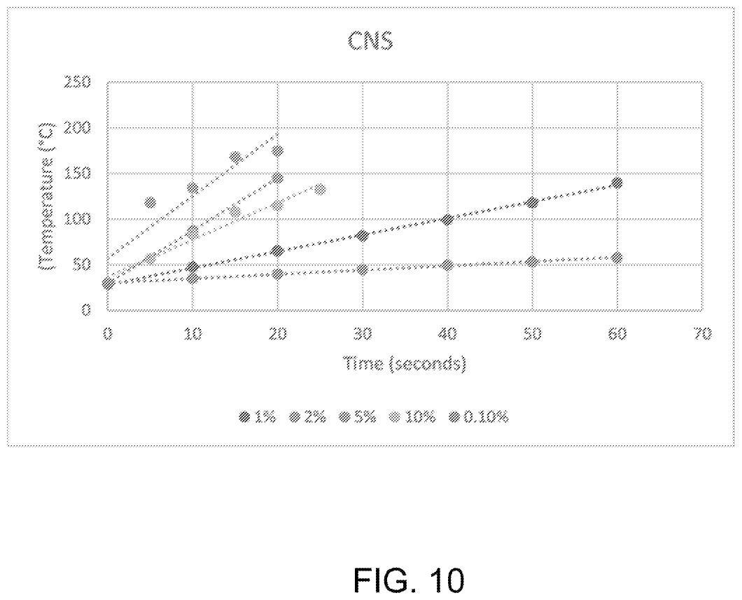

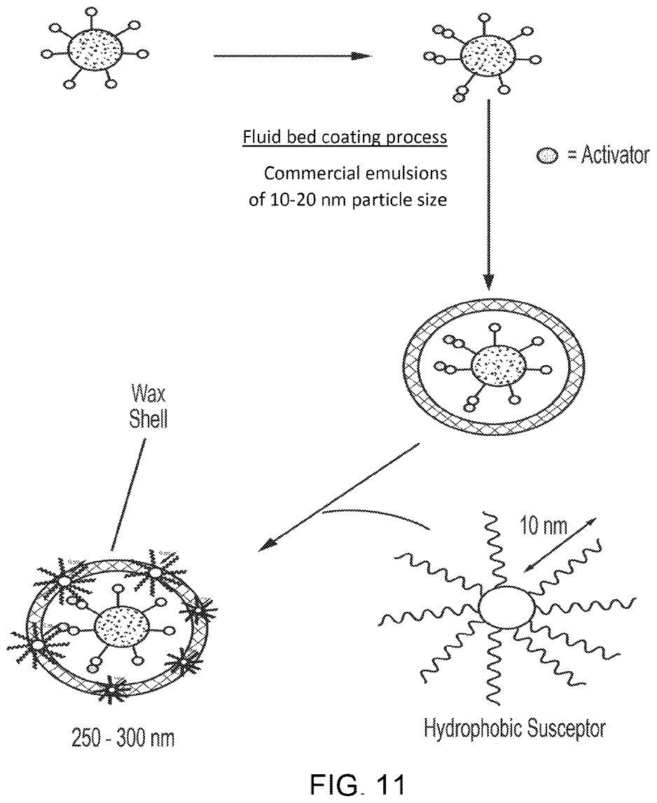

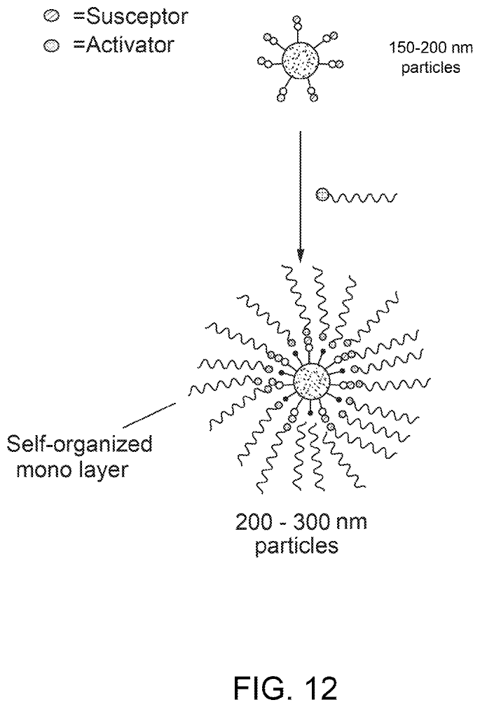

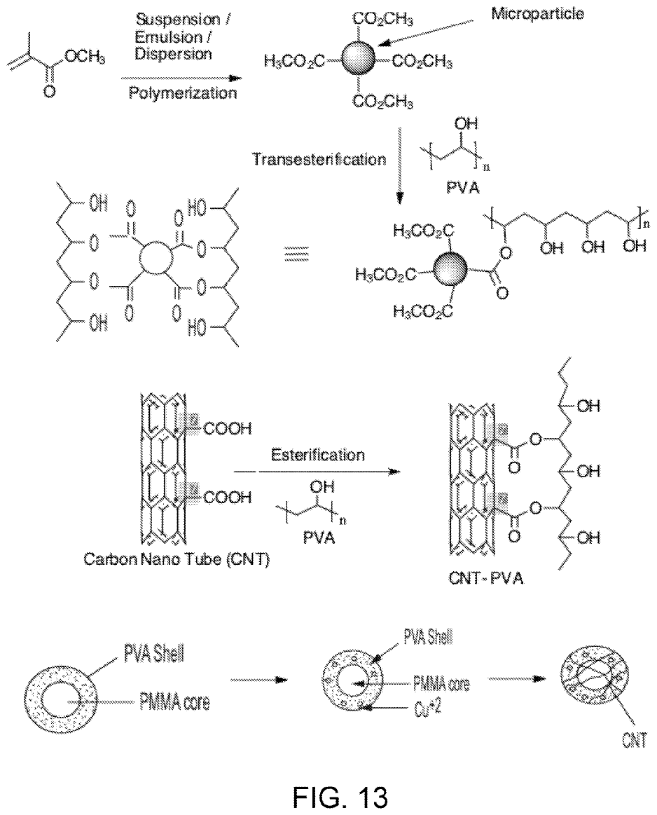

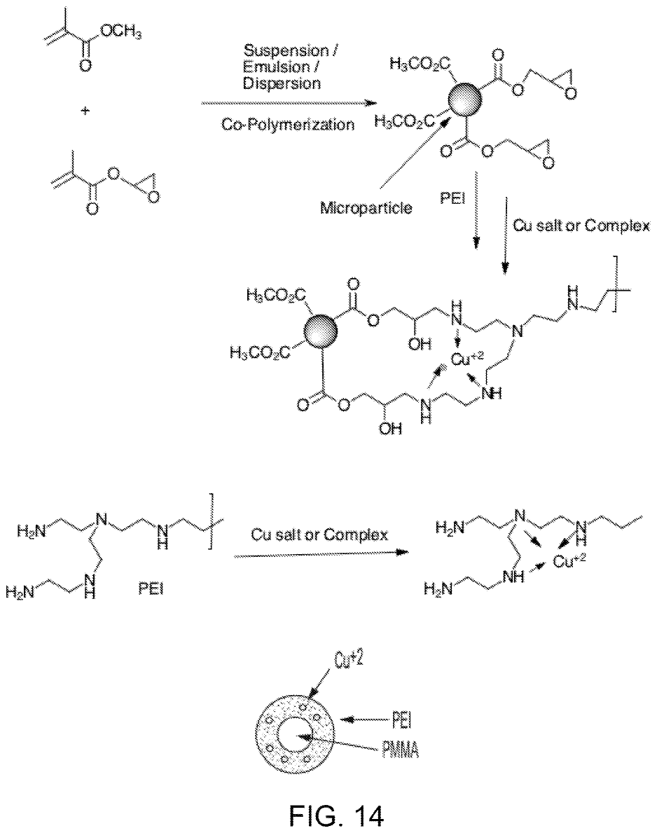

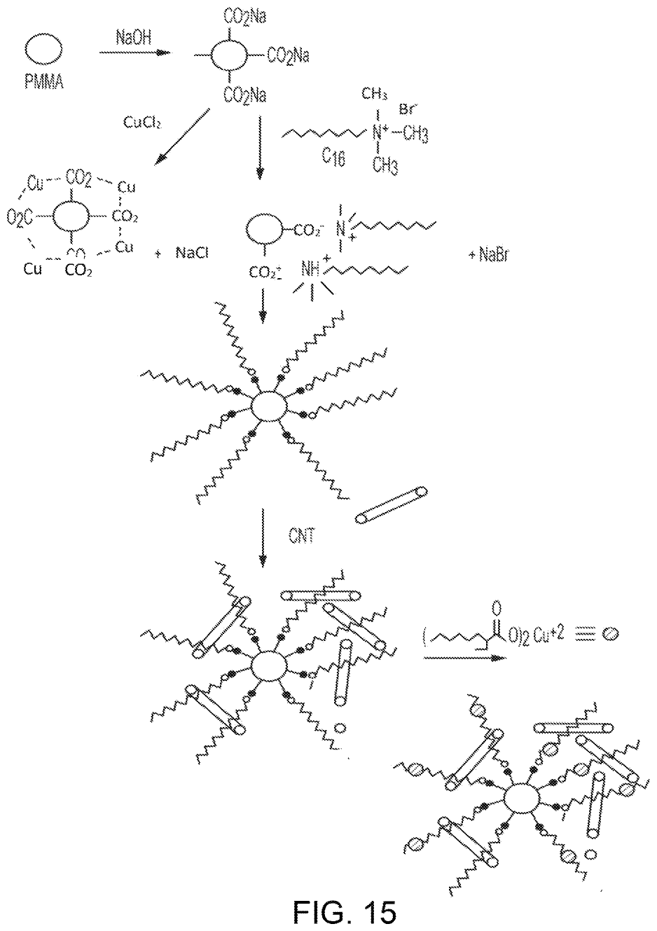

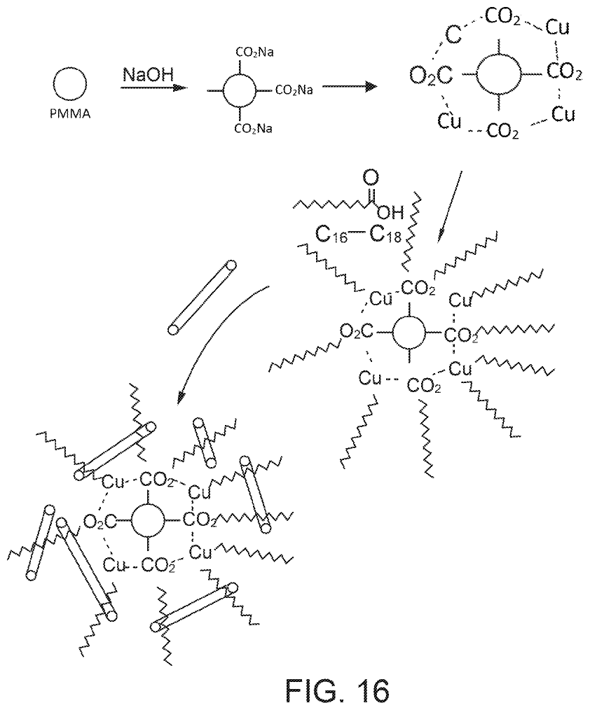

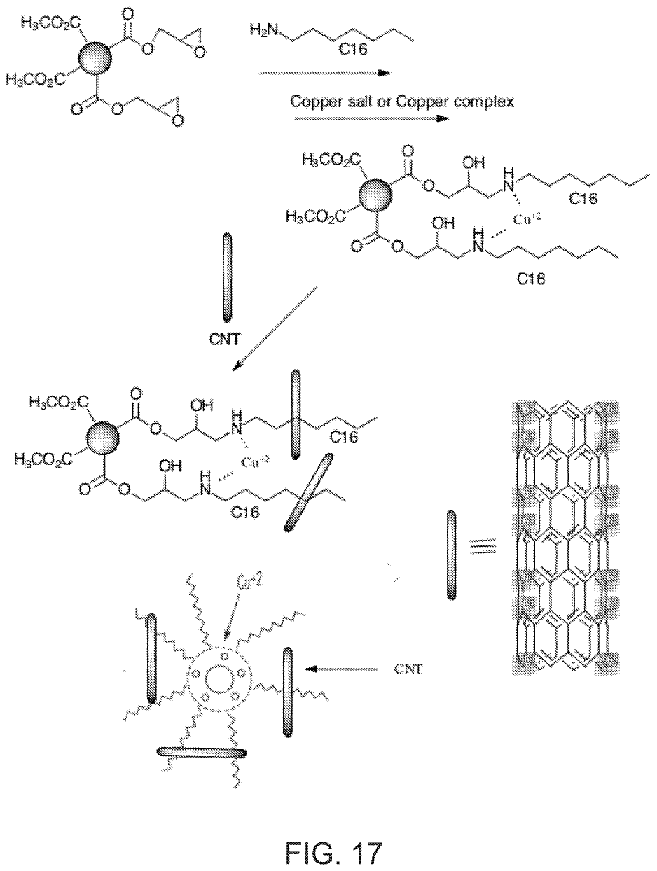

This study demonstrates methods for preparing hollow particle-core structures. Representative SEM images of hollow particles are shown in FIG. 7, while representative SEM images of hollow core particles combined with SPIONs and copper are shown in FIG.

### Experiment 1

A solution of 5-6% w/v PMMA (120,000 g/mol) dissolved in dichloromethane (DCM) was added dropwise to an aqueous medium of poly vinyl alcohol (0.5-0.6% w/v) and stirred at 500-550 rpm for 10-15 minutes. The solution was left overnight or 12-18 hours until the DCM evaporated. The hollow particles were filter-washed three times with isopropanol and left to dry, again.

### Experiment 2

A solution of 5-6% w/v PMMA (15,000 g/mol) dissolved in dichloromethane was added dropwise to an aqueous medium of poly vinyl alcohol (0.5-0.6% w/v) and stirred at 500-550 rpm for 10-15 minutes. The solution was left overnight or 12-18 hours until the DCM evaporated. The hollow particles were filter-washed three times with isopropanol and left to dry, again.

### Experiment 3

A first solution of copper (II) 2-ethyl hexanoate (12.5 mg) dissolved in dichloromethane was prepared. A second solution of 5-6% w/v PMMA (15,000 g/mol) dissolved in the first solution was added dropwise to an aqueous medium of poly vinyl alcohol (0.5-0.6% w/v) and stirred at 500-550 rpm for 10-15 minutes. The final solution was left overnight or 12-18 hours until the DCM evaporated. The hollow particles were filter-washed three times with isopropanol and left to dry again.

### Experiment 4

A dispersion of SPIONs (12.5 mg) in dichloromethane was prepared. A 5-6% w/v PMMA (15,000 g/mol) dissolved in the SPION/dichloromethane dispersion was added dropwise to an aqueous medium of poly vinyl alcohol (0.5-0.6% w/v) and stirred at 500-550 rpm for 10-15 minutes. The solution was left overnight or 12-18 hours until the DCM evaporated. The hollow particles were filter-washed three times with isopropanol and left to dry, again.

### Experiment 5

A dispersion of oleic acid-modified SPIONs (12.5 mg) in dichloromethane was prepared. A 5-6% w/v PMMA (15,000 g/mol) dissolved in the SPION/dichloromethane dispersion was added dropwise to an aqueous medium of poly vinyl alcohol (0.5-0.6% w/v) and stirred at 500-550 rpm for 10-15 minutes. The solution was left overnight or 12-18 hours until the DCM evaporated. The hollow particles were filter-washed three times with isopropanol and left to dry, again.

### Experiment 6

A dispersion of oleic acid-modified SPIONs (12.5 mg) and copper (II) 2-ethyl hexanoate (12.5 mg) in dichloromethane was prepared. A 5-6% w/v PMMA (15,000 g/mol) dissolved in the SPION/dichloromethane dispersion was added dropwise to an aqueous medium of poly vinyl alcohol (0.5-0.6% w/v) and stirred at 500-550 rpm for 10-15 minutes. The solution was left overnight or 12-18 hours until the DCM evaporated. The hollow particles were filter-washed three times with isopropanol and left to dry, again.

### Example 6—Process for Preparing Cores by Amalgamation of Susceptors and Catalysts

This study demonstrates remotely activating microwave-susceptors within a matrix particle. The matrix used in these studies was prepared by combining susceptors and other components of the matrix particle as an amalgamation. The matrix particles were exposed to microwaves to release the activator to perform its function. For example, in some cases the microwaves heated the susceptor, carbon nanostructures, to release a copper catalyst from the matrix particles to catalyze a polymerization reaction.

### Experiment 1

Solution A was prepared by dissolving 5 g PMMA in xylenes at 80° C. for 20-30 minutes. Solution B was prepared by melting 5 g carnauba wax in xylenes with a heat gun. A and B were very slowly combined while continuously heating. Copper(II) 2-ethyl hexanoate (0.5%) was added to the solution of A and B. The solution was continuously stirred and heated 110° C. until most of the xylenes evaporated. Before all of it had evaporated 10% carbon nanostructures were added and high-sheer mixed. Once sufficient xylenes had evaporated to render the solution into a paste, the solution was crashed into ethanol. The solids were broken up with water in a blender and dried overnight to obtain powder. The powder was sieved through a micron mesh to obtain the core particles

### Experiment 2

A dispersion of 0.1 g carbon nanostructure pellets was made in 30 mL dichloromethane before adding a solution of 3 g hexadecyl trimethyl ammonium bromide (CTAB) dissolved in 10 mL isopropanol and 20 mL dichloromethane while mixing at 700 rpm. Copper (II) 2-ethyl hexanoate was added with 10 g solid plasticizer (Benzoflex™ 352) to the solution accompanied with continuous stirring. The sample was left out to stir until dry.

### Experiment 3

A mixture of 0.1 g carbon nanotubes was made with 0.2 g CTAB in 30 mL dichloromethane which was sonicated for 15 minutes at 30% power. An additional 50 mL of dichloromethane was added and the sample sonicated for an additional 15 minutes at 30%. A 9.9 g of Benzoflex™ 352 (solid plasticizer) and 1 g copper(II) 2-ethylhexanoate was added and hand mixed. A stir bar was added to the sample and left to stir on a hot plate at 35° C. and 700 rpm to maintain particle suspension while the dichloromethane evaporated.

### Experiment 4

A mixture of 0.11 g of Experiment 1 particles were dispersed in 10 mL dimethyl malonate by sonicating for 10 minutes. A single drop of these particles was tested by placing it on a glass microscope slide, microwaved for 60 seconds at 800 W/4V.

### Example 7—Process for Coating Microparticles with Susceptors

The present study demonstrates methods used for coating microparticles, for example, commercial PMMA microparticles with susceptors such as carbon nanotubes (CNT) or carbon nano-substances (CNS).

### Experiment 1

In this experiment, 250 mg of PMMA (Soken MX-500ML) was added to 50 ml of water. It was then sonicated for 30 minutes at 20% amplitude using a micro probe sonicator. In another flask, 300 mg of CNT was added to 120 ml of water. It was sonicated for 15 minutes at 10% amplitude using a probe sonicator. The dispersion of PMMA and water was taken into a beaker and stirred continuously at room temperature to avoid the settling of the PMMA particles. In the next, 10 ml of the dispersed CNTs in water was taken into a syringe and added dropwise using a syringe pump into the PMMA dispersion at 0.5 ml/min. The sample was left overnight to allow the coated PMMA particles to settle. The particles were then separated using a centrifuge.

### Experiment 2

In this experiment, 250 mg of PMMA (Soken MX-500ML) was added to 50 ml of water. It was then sonicated for 30 minutes at 20% amplitude using a micro probe sonicator. In another flask, 300 mg of CNS was added to 120 ml of water. It was sonicated for 15 minutes at 10% amplitude in the sonicator. The dispersion of PMMA and water was taken into a beaker and stirred continuously at room temperature to avoid the settling of the PMMA particles. Next, 10 ml of the dispersed CNTs in water was taken into a syringe and added dropwise using a syringe pump into the PMMA dispersion at 0.5 ml/min. The sample was left overnight to allow the coated PMMA particles to settle. The particles were the separated using a centrifuge.

### Experiment 3

In this experiment, 1 ml of PMMA that was made using the previously described emulsion polymerization method was added to 9 ml of water. In another flask, 300 mg of CNT was added to 120 ml of water. It was sonicated for 15 minutes at 10% amplitude using a micro probe sonicator. The dispersion of CNT and water was taken into a beaker and stirred continuously at room temperature. Next, 10 ml of the dispersed PMMA in water was taken into a syringe and added dropwise using a syringe pump into the CNT dispersion at 0.5 ml/min. The sample was left overnight to allow the coated PMMA particles to settle. The particles were then separated using a centrifuge.

### Example 8—Process for Preparation of Microparticles Through Emulsion Copolymerization

The present study provides methods for functionalizing the PMMA by copolymerizing the PMMA with various copolymers including poly(ethylene glycol) methacrylate (PEGMA), poly(ethylene glycol) dimethacrylate (PEGDMA), stearyl methacrylate, and methacrylic acid.

### Experiment 1

At 70° C., methyl methacrylate (12 mL) was added dropwise to DI water (64 mL) to be emulsified under the presence of inert gas. The polymerization reaction was catalyzed by ((2,2-azobis) 2-methyl-propionamidine) dihydrochloride (AIBN) (20 mg) and stirred for 30-40 minutes. An additional 20 mg AIBN was added with 1.2 mL poly(ethylene glycol) methacrylate (PEGMA) and stirred for 40 minutes.

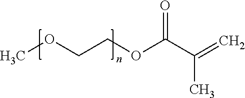

### Experiment 2

At 70° C., methyl methacrylate (12 mL) was added dropwise to DI water (64 mL) to be emulsified under the presence of inert gas. The polymerization reaction was catalyzed by ((2,2-azobis) 2-methyl-propionamidine) dihydrochloride (AIBN) (20 mg) and stirred for 10 minutes. An additional 20 mg AIBN was added with 1.2 mL poly(ethylene glycol) methacrylate (PEGMA) and stirred for 40 minutes.

### Experiment 3

At 70° C., methyl methacrylate (12 mL) was added dropwise to DI water (64 mL) to be emulsified under the presence of inert gas. The polymerization reaction was catalyzed by ((2,2-azobis) 2-methyl-propionamidine) dihydrochloride (AIBN) (20 mg) and stirred for 10 minutes. An additional 20 mg AIBN was added with 120 μL poly(ethylene glycol) methacrylate (PEGMA) and stirred for 40 minutes.

### Experiment 4

At 70° C., methyl methacrylate (12 mL) was added dropwise to DI water (64 mL) to be emulsified under the presence of inert gas. The polymerization reaction was catalyzed by ((2,2-azobis) 2-methyl-propionamidine) dihydrochloride (AIBN) (20 mg) and stirred for 10 minutes. An additional 20 mg AIBN was added with 120 μL poly(ethylene glycol) dimethacrylate (PEGDMA) and stirred for 40 min.

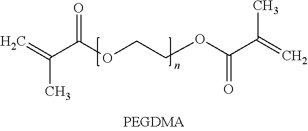

### Experiment 5

At 70° C., methyl methacrylate (12 mL) was added dropwise to DI water (64 mL) to be emulsified under the presence of inert gas. The polymerization reaction was catalyzed by ((2,2-azobis) 2-methyl-propionamidine) dihydrochloride (AIBN) (20 mg) and stirred for 10 minutes. An additional 20 mg AIBN was added with 1.2 mL poly(ethylene glycol) dimethacrylate (PEGDMA) and stirred for 40 minutes.

### Experiment 6

A solution of sodium dodecyl sulfate (SDS) (0.5 g) dissolved in hydroxyethyl methacrylate (HEMA) (15 g) was prepared. This solution was transferred into a round-bottom flask of DI water (185 g) in a hot bath set to 70° C. and stirred at a high speed. The heat was turned off and while the solution continued to be stirred while AIBN (0.2 g) was being added.

### Experiment 7

A flask of 64 mL DI water was degassed and heated to 70° C. while stirring at 670 rpm for 20 minutes. In the next step, 1 g of stearyl methacrylate was dissolved into 9 mL methyl methacrylate. This solution was injected into the water dropwise over 15 minutes accompanied with constant stirring under the presence of inert gas. Once added, ((2,2-azobis) 2-methyl-propionamidine) dihydrochloride (AIBN) (40 mg) was added to the emulsion and the mixture/solution stirred for an additional hour.

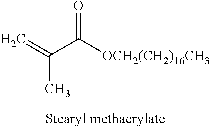

### Experiment 8

A flask containing 64 mL DI water was degassed and heated to 70° C., with stirring of its contents at 670 rpm for 20 minutes. Then, separately, 5 g of stearyl methacrylate was dissolved into 5 mL methyl methacrylate. This solution was injected into the flask dropwise over 15 minutes accompanied with constant stirring under the presence of inert gas. Once added, ((2,2-azobis) 2-methyl-propionamidine) dihydrochloride (AIBN) (40 mg) was added to the emulsion and stirred for an additional hour.

### Experiment 9

A flask of 64 mL DI water was degassed and heated to 70° C. with stirring of its contents at 670 rpm for 20 minutes. Next, 5 mL of methacrylic acid was dissolved into 5 mL methyl methacrylate. This solution was injected into the water dropwise over 15 minutes while constant stirring under inert gas. Once added, ((2,2-azobis) 2-methyl-propionamidine) dihydrochloride (AIBN) (40 mg) was added to the emulsion and stirred for an additional hour.

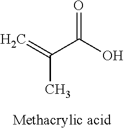

### Experiment 10

A flask of 64 mL DI water was degassed and heated to 70° C. with stirring of its contents at 670 rpm for 20 minutes. Next, 1 mL of methacrylic acid was mixed into 5 mL methyl methacrylate. This solution was injected into the water dropwise over 15 minutes while constant stirring under inert gas. Once added, ((2,2-azobis) 2-methyl-propionamidine) dihydrochloride (AIBN) (40 mg) was added to the emulsion and stirred for an additional hour.

### Experiment 11

At 70° C., methyl methacrylate (12 mL) was added dropwise to DI water (64 mL) to be emulsified under the presence of inert gas. The polymerization reaction was catalyzed by ((2,2-azobis) 2-methyl-propionamidine) dihydrochloride (AIBN) (20 mg) and stirred for 5 minutes. An additional 500 μL of glycidyl methacrylate (GMA) was added and stirred for 40 minutes under inert gas.

### Experiment 12

At 70° C., glycidyl methacrylate (12 mL) was added dropwise to DI water (64 mL) to be emulsified under the presence of inert gas. The polymerization reaction was catalyzed by ((2,2-azobis) 2-methyl-propionamidine) dihydrochloride (AIBN) (20 mg) and stirred for 40 minutes.

### Example 9—Process for Coating Commercially Available Microparticles with Commercial Emulsions

The objective of this study was to coat commercial PMMA particles as core with a shell that comprises susceptors and/or activators through a simple coating process.

### Experiment 1

In this experiment, 250 mg of PMMA (Soken MX-500ML) was added to 50 ml of water in a beaker. It was then sonicated for 30 minutes at 20% amplitude in a sonicator. At the same time, commercially manufactured SP-05032022-3: CNT dispersed in polyurethane, was diluted 100 times and added into another beaker. The dispersion of PMMA and water was stirred continuously at room temperature to avoid the settling of the PMMA particles. Then, 10 ml of the dispersed CNTs in polyurethane was added dropwise using a syringe pump into the PMMA dispersion at 0.5 ml/min. The sample was left overnight to allow the coated PMMA particles to settle. The particles were then separated using a centrifuge.

### Experiment 2

In this experiment, 250 mg of PMMA (Soken MX-500ML) was added to 50 ml of water in a beaker. It was then sonicated for 30 minutes at 20% amplitude in a sonicator. At the same time, commercially manufactured SP-05032022-05: Epoxy-CNT, was diluted 100 times and added into another beaker. The dispersion of PMMA and water was stirred continuously at room temperature to avoid the settling of the PMMA particles. Then, 10 ml of the diluted Epoxy-CNT was added dropwise using a syringe pump into the PMMA dispersion at 0.5 ml/min. The sample was left overnight in order for the coated PMMA particles to settle. The particles were then separated using a centrifuge.

### Experiment 3

In this experiment, 250 mg of PMMA (Soken MX-500ML) was added to 50 ml of water in a beaker. It was then sonicated for 30 minutes at 20% amplitude in a sonicator. At the same time, commercially manufactured SP-05032022-3: CNT dispersed in polyurethane, was diluted 10 times and added into another beaker. The dispersion of PMMA and water was stirred continuously at room temperature to avoid the settling of the PMMA particles. Then, 10 ml of the dispersed CNTs in polyurethane was added dropwise using a syringe pump into the PMMA dispersion at 0.5 ml/min. The sample was left overnight to allow for the coated PMMA particles to settle. The particles were then separated using a centrifuge.

### Example 10—Process for Using Carbon Nanostructures as Susceptors

This study demonstrates the use of commercial carbon nanostructures as radiofrequency (RF) radiation susceptors within a matrix particle to assist in the release of a catalyst to perform the catalyst's function of initiating a polymerization reaction. For example, the heating of the susceptor causes the matrix of the particle to melt which releases a chemical ingredient like a copper salt catalyst to initiate the polymerization. The objective of this study was to use commercial PMMA particles as carriers for a copper activator.

The particles generated in the experiments of the present study were prepared using commercial particles, with diameters on the micro to nanoscale, as carriers for acrylic activators by attaching the activator to the surface of the core of the matrix particle.

Microparticles from Examples 6, supra, were used for the following heating time course measurements.

### Experiment 1

Microparticles from Example 6 were taken and put in acrylic monomer formulations as 0.10 g in 3 g of monomer consisting of 3 parts triacrylated monomer (OTA 480): 1 part multifunctional acrylic monomer (EBECRYL® 896): 1 part polyurethane-acrylate (EBECRYL® 8811) all from Allnex Co and 5000 ppm of 4-methoxyphenol (MEHQ), 2% cumyl hydroperoxide (CHP) and 2% 4,N,N-trimethylaniline (DMPT). Data from heating experiments are shown in Table 4 below.

TABLE 3
Heating Time course Data

| | | | | Average Temp |
|---|---|---|---|---|
| Time (s) | Temp (° C.) | Temp (° C.) | Temp (° C.) | (° C.) |
| 0 | 30 | 33 | 30 | 31 |
| 10 | 59 | 62 | 60 | 60 |
| 20 | 109 | 113 | 101 | 10 |
| 30 | 171 | 178 | 158 | 169 |

### Example No. 11—Assessment of Stability of Particle Cores Prepared Using CNS Susceptors

Studies Performed with Foam

Foam cure tests were performed by cutting two pieces of foam into 4″ by 4″ cubes. The sample from Experiment 6 of Example 9, supra, being tested was pipetted onto one piece of foam so that it evenly covered one side of the cube, the layers were sufficiently thick to stick up above the pores of the foam. The second cube was placed on top of the first, completely covering the sample. The foam cubes were placed between two slides with a spacer and uniform pressure was maintained by clamping the glass slides using rubber bands. The clamped sample was placed in a microwave chamber under the thermal camera. To isolate the samples from direct heating, the samples were placed over the insulator in the microwave chamber. The samples were microwaved at 800 W power for preset amounts of time. After the sample was taken out of the microwave, the setup was carefully disassembled. To test if the foam has been glued together, the corners of the foam were gently pulled apart.

### Foam Types Tested:

A ½ inch Airtex high density foam used to make camper cushions, boat seating, chair pads, garden benches and small foam cushions.

A ⅛ inch divinylmat and ½ inch vinyl foam frequently used as structural core material for composite laminates, delivering added strength, stiffness, and insulation, without adding weight. Generally, the foams, readily conform to shapes, and can be bonded in layers to add thickness.

Nomex honeycomb made from aramid fiber, honeycomb exhibits outstanding flammability properties.

Studies Performed with Composite

Silicone molds in the shape of a bear were used to evaluate curing of bulk composites. One bear mold 5 cc volume was filled at a time and placed in the center of the microwave under the thermal camera. Only one sample was put in at a time to ensure the samples were under the field of view of the thermal camera. The bear mold was microwaved at 800 W power for preset amounts of time and taken out of the microwave to test for changes in viscosity or if a cure has occurred.

### Samples Tested

1. Sample A: Acrylic adhesive formula (See Experiment 1 in Example 9, above for formulation details) with no activator
2. Sample B: Acrylic adhesive formula+copper activator
3. Sample C: Acrylic adhesive formula+matrix particles (containing both susceptor and copper activator)
   Results from Experiments Performed at Room Temp with Airtex Foam:
1. Sample A: Did not cure after one month; this sample has no activator
2. Sample B: Cured in 30 minutes
3. Sample C: Cured within 30 second in the microwave, but at room temperature, it did not cure even after one month.
   Results from Experiments Performed at Room Temperature with Divinylmat, Vinyl Foam, and Honeycomb:
1. Sample A: Did not cure after one month; this sample has no activator in it.
2. Sample B: Cured in 30 minutes
3. Sample C: Cured within 30 seconds in the microwave, but at room temperature it did not cure even after one month.
   Results from Experiments Performed with Composite:
1. Sample A: Did not cure after one month; this sample has no activator in it.
2. Sample B: Cured in 30 minutes.
3. Sample C: Cured within 20 seconds in the microwave, but at room temperature it did not cure even after one month.

This experimentally shows the shelf life of the inventions matrix particles while still providing curing on-demand.

### Example B1: Nanotube Coated PMMA Particles

According to the U.S. patent application Ser. No. 18/055,302 to Malofsky et.al., which is incorporated by reference as if it is fully set forth herein, matrix particles are prepared with one or more type of nanotubes. The description is also provided in the previous set of examples. For example, a core PMMA particle of various sizes from 0.1 microns to 100 microns in diameter is prepared and coated with carbon nanotubes. These particles may or may not contain catalysts, cocatalysts or accelerators, depending upon the purpose that the matrix particle is deployed for use.

The original PMMA particles can be prepared by using emulsion polymerization, suspension polymerization, dispersion polymerization, seed swelling polymerization (See Ref: European Polymer Journal 175 (2022) 111379-Research progress of poly(methyl methacrylate) microspheres: Preparation, functionalization and application; Yafei Gao a, Jianmin Zhang, Jia Liang, Dongming Yuan, Weizhen Zhao).

They can also be purchased from companies such as Sekisui of Japan or Soken, for example. These particles can be prepared with or acquired with various functional groups, such as —OH, —NH, —COOH, epoxy and so on.

The nanotubes can be acquired from dozens of manufacturers, including cheap-tubes.com, LG Chem (CNT division), and Tuball, Kumho petrochemicals.

Here we use the following PMMA particles:

| PMMA Product | |
|---|---|
| Name** | Particle Size |
| MX-500ML | 0.8 μm to 30 μm; average particle size: 5 μm |
| MP-1441 | 0.15 μm to 0.4 μm; average particle size: 0.17 μm |
| MX-180TA | 0.8 μm to 30 μm; average particle 1.8 μm |
| XX-6666Z | average particle size 4.7 μm |

**The MX-500ML, MP-1441, MX-180TA were sourced from the company Soken, Japan, and the XX6666Z was sourced from Sekisui kasei, Japan.

### I. Process to Make PMMA Particles

Experiment B1.1—At 70° C., methyl methacrylate (3 mL) is added to DI water (16 mL) to emulsify under inert gas. The polymerization reaction is catalyzed by ((2,2-azobis) 2-methyl-propionamidine) dihydrochloride (10-15 mg) and stirred for 30 minutes.

Experiment B1.2: The present study provides methods for functionalizing the PMMA by copolymerizing the PMMA with various copolymers including poly(ethylene glycol) methacrylate (PEGMA), poly(ethylene glycol) dimethacrylate (PEGDMA), stearyl methacrylate, and methacrylic acid.

II. Process for Coating with Nanotubes

The present study demonstrates methods used for coating microparticles, for example, commercial PMMA microparticles with susceptors such as carbon nanotubes (CNT) or carbon nano-substances (CNS).

Experiment B1.3: In this experiment, 250 mg of PMMA (Soken MX-500ML) is added to 50 ml of water. It is then sonicated for 30 minutes at 20% amplitude using a micro probe sonicator. In another flask, 300 mg of CNT is added to 120 ml of water. It is sonicated for 15 minutes at 10% amplitude using a probe sonicator using SDS surfactant. The dispersion of PMMA and water is taken into a beaker and stirred continuously at room temperature to avoid the settling of the PMMA particles. In the next step, 10 ml of the dispersed CNS in water was taken into a syringe and added dropwise using a syringe pump into the PMMA dispersion at 0.5 ml/min. The sample is left overnight to allow the coated PMMA particles to settle. The particles are then separated using a centrifuge.

The particles containing 3.2% CNS by weight prepared in Experiment B1.3 were dispersed in acrylic monomer formulations at the concentrations of 25% and 75% by weight of the particles using a Flacktek speed mixer set at 2,000 RPM for 1 minute and 30 seconds. The acrylic formulation comprises of 3 parts triacrylated monomer (OTA 480): 1 part multifunctional acrylic monomer (EBECRYL® 896): 1 part polyurethane-acrylate (EBECRYL® 8811) all from Allnex Co and 5000 ppm of 4-methoxyphenol (MEHQ), 2% cumyl hydroperoxide (CHP) and 2% 4,N,N-trimethylaniline (DMPT).

The Acrylic formulation containing particles were degassed using a vacuum chamber for 30 minutes. Then samples of 100% PMMA with 3.2% CNS, and the acrylic formulation containing 0%, 25% and 75% of the particles were applied at 4 mils to a ⅛ inch poly-carbonate plaque and pressed on a hot press set at 230° F. for 30 minutes. The resistivity of cured films measured using a surface resistivity meter and tabulated as shown below table:

| PMMA/CNS loading | % CNS loading | Resistivity (Ohms) |
|---|---|---|
| 100 | 3.2 | 6.00E+03 |
| 75 | 2.4 | 8.20E+05 |
| 25 | 0.8 | 1.00E+09 |
| 0 | 0 | 1.00E+13 |

The resistivity vs CNS loading showed in the plot L2 indicates a steady drop of resistivity from 1.0×10¹³ to 6.0×10³ ohm at a CNT loading of 0 to 3.2%. This clearly demonstrates the effectiveness of the microparticles for delivering CNTs into the acrylic formulations.

Experiment B1.4: In this experiment, 1 ml of PMMA that is made using the previously described emulsion polymerization method is added to 9 ml of water. In another flask, 300 mg of CNT is added to 120 ml of water. It is sonicated for 15 minutes at 10% amplitude using a micro probe sonicator. The dispersion of CNT and water is taken into a beaker and stirred continuously at room temperature. Next, 10 ml of the dispersed PMMA in water is taken into a syringe and added dropwise using a syringe pump into the CNT dispersion at 0.5 ml/min. The sample was left overnight to allow the coated PMMA particles to settle. The particles were then separated using a centrifuge.

### Example B2: Nanotube Containing PMMA Particles Prepared by Amalgamation

Experiment B2.1: Solution A is prepared by dissolving 5 g PMMA in xylenes at 80° C. for 20-30 min. Solution B was prepared by melting 5 g carnauba wax in xylenes with a heat gun. A and B are very slowly combined while continuously heating. Copper(II) 2-ethyl hexanoate (0.5%) was added to the solution of A and B. The solution is continuously stirred and heated 110° C. until most of the xylenes evaporated. Before all of it has evaporated 10% carbon nanostructures are added and high-sheer mixed. Once sufficient xylenes has evaporated to render the solution into a paste, the solution is crashed into ethanol. The solids are broken up with water in a blender and dried overnight to obtain powder. The powder is sieved through a micron mesh to obtain the core particles.

### Example B3 Coating Nanotube-Coated Particles with Functional Nano-Particle Emulsions

Particles from Example B1, once coated with nanotubes to the desired degree, are washed and dried or left in a solvent for a subsequent coating reaction or process with chosen materials that interfere with van der Waals attraction. (Applicants do not wish to be bound by any theory that is discussed in this disclosure.) In this nano-wax, epoxy, and PUD (polyurethane dispersions) are the nano-particle emulsions and dispersions, respectively. PUDs are purchased from Covestro and epoxy emulsions form Westlake.

The functional nano-particle emulsions and dispersions can be acquired from manufacturers, including, Michelman, Covestro, BYK and, Westlake.

Here we use the following functional nano-particle emulsions and or dispersions:
A. ME98040M1 (Michelaman)
B. EPI-REZ 3514-W-56 (Westlake)
C. Baybond PU 405 (Covestro)
D. Aqacer 581, 532, 1061 (BYK)

Experimental B3.1: Functional nano-particle emulsions and dispersions in water are added dropwise using a syringe pump into the 250 mg particles from Example B1. The sample is left overnight to allow the coated particles to settle. The particles are then separated using a centrifuge.

### Example B4: Coating Nanotube-Coated Particles with Monofunctional Reactive Materials

Particles from Example 1, once coated with nanotubes to the desired degree, are washed and dried or left in a solvent for a subsequent coating reaction or process with chosen materials that interfere with van der Waals attraction, in this case using monofunctional reactive materials. These studies can be done by varying length of the aliphatic chains.

These are common materials readily available from manufacturers such as BASF and Evonik as well for laboratory experimentation from Sigma Aldrich.

Example materials include:
A. Stearic Acid
B. Octanoic acid
C. Oleic acid
D. Stearyl alcohol
E. Aliphatic amines
F. Chitosan
G. Diocatyl amines, Hexadecyl amines

Experiment B4.1: Particles from Experiment B1.3 containing alcohol functional groups are suspended in anhydrous MEK (methyl ethyl ketone) or isopropyl acetate, dimethyl carbonate, cyclohexanone, 2-methyl tetrahydrofuran. The solvents is chosen in which the particles are not soluble. They are reacted with oleic acid, stearic acid, and octanoic acid or other branched or linear fatty acids under standard Steglich-type esterification conditions.

Experiment B4.2: Particles from Experiment B1.3 containing acid functional groups were suspended in anhydrous solvents described in Experiment 4.1 and reacted with fatty acid alcohol not limited to stearyl alcohol under standard Steglich-type esterification conditions.

Experiment B4.3: Particles from Experiment B1.3 containing epoxy functional groups are suspended in anhydrous solvents described in Experiment B4.1 and reacted with aliphatic primary and secondary amines not limited to dioctyl and hexadecyl amines.

### Example B5: Coating Nanotube-Coated Particles with Difunctional Materials

Particles from Example B1, once coated with nanotubes to the desired degree, are washed and dried or left in a solvent for a subsequent coating reaction or process with chosen materials that interfere with van der Waals attraction, in this case using mono functional reactive materials. These studies can be done by varying length of the intermittent aliphatic chains containing difunctional materials. One reactive and the other protective (non-interfering) functionality. The reactive functional group designed to the react with particle from Example B1 and the protected functional group left outside for further manipulation for cross-linking.

These are common materials readily available from manufacturers such as BASF and Evonik as well for laboratory experimentation Sigma Aldrich.

Example materials include:
A. Adipic acid
B. Adipic acid half ester
C. Propylene diamine
D. Ethylene diamine
E. BOC mono protected propylene diamine

Experiment B5.1: Particles from Experiment B1.3 containing alcohol functional groups were suspended in anhydrous MEK (methyl ethyl ketone) or isopropyl acetate, dimethyl carbonate, cyclohexanone, 2-methyl tetrahydrofuran. The solvents are chosen in which the particles are not soluble. They are reacted with difunctional carboxylic acid such as adipic acid or adipic acid half ester.

Experiment 5.2: Particles from Experiment B1.3 containing acid functional groups were suspended in anhydrous solvents described in Experiment B4.1 and reacted with propylene diamine using carbodiimide/n-hydroxy benzotriazole (HOBt) couplings.

### Example B6: Viscosity Effects-Blending Materials with Carbon Nanotubes, Carbon Nanotube-Coated or Containing Particles and Coated Carbon Nanotube Coated or Containing Particles

Here we demonstrate that carbon nanotubes and/or carbon nanotube coated particles have very high viscosities due to associative van der Waals effects while coated particles do not, particularly those with repulsive coatings.

Procedure: Particles from Examples B1, B2, B3, B4, and B5 are mixed into polymerizable compositions of coating and adhesive using higher shear, sonication, and speed mixing process. Viscosities of the resulting materials are measured using ford cup or Brooke filed viscometers.

### Example B7 Performance Effects—I

In one embodiment, this invention relates to blending a polymerizable composition with carbon nanotube-coated and/or containing particles, polymerizing the matrix, and evaluating physical effect on strength, impact resistance, modulus, toughness and so on.

Here we demonstrate that carbon nanotube-coated and/or containing particles with now lower viscosities for lower cost, simpler, more facile processing and loading also then provide the slightly lower, the same or improved physical performance in a final polymerized composition.

Procedure: The polymerizable composition described in Example B6 is cured under the standard conditions. For example, the performance of the resulting coatings is tested for hardness through indentation and tabber abrasion testing. Cross hatch adhesion testing and visual comparison to the standards.

The polymerizable composition containing the particles is casted and cured into thin films and tensile, flexural-strength and modulus tested. Dynamic Mechanical Analysis (DMA) used for measuring the visco-elastic response of a sample under oscillating load, monitored against temperature, time or frequency.

### Example B8 Performance Effects—II

In one embodiment, this invention relates to blending a polymerizable composition comprising (i) carbon nanotube-coated particles; (ii) chemically-functionalized carbon nano-tube-coated particles; (iii) carbon nanotube-containing particles; and/or (iv) chemically-functionalized carbon nanotube-containing particles. In the next step such polymerizable composition is polymerized, and its physical effect on strength, impact resistance, modulus, toughness and on the like are measured.

Here we demonstrate that the aforementioned particles provide materials with lower viscosities for lower cost, simpler, more facile processing and loading also then pro-vide the slightly lower, the same or improved physical performance in a polymerizable or partially reactive polymer composition where the particles are at least partially chemically now bound to the aforementioned polymeric matrices.

The polymerized matrix is tested by DMA under ASTM D4065, D4440, D5279. Elastic modulus (or storage modulus, G′), viscous modulus (or loss modulus, G″) and damping coefficient (Tan D) as a function of temperature, frequency or time are measured.

The polymerized matrix is tested under
ASTM D638/D-882—tensile properties
ASTM D790—Flexural Properties of Plastics
ASTM D256—Izod Impact Resistance of Plastics
ASTM D4812—Unnotched Cantilever Beam Impact Resistance of Plastics

### Examples Set C

### C1. Synthesis of CNT-Modified PMMA Brush Microparticles Through a Bottom-Up Approach

This study demonstrates methods for preparing CNT-modified “brush” microparticles starting from MMA monomers and building the micron-size core from monomers through a bottom-up approach. The CNTs on the surface offer a convenient method for delivering CNTs into the polymer resin matrices for reinforcement.

60 mL SDS solution (0.1 mg/mL) is prepared in deionized (DI) water, followed by the addition of methanol (30 ml). Polyvinylpyrrolidone (PVP) (2.5 g) is added to the mixture and stirred until dissolution. Azoisobutyronitrile (AIBN) (0.2 g) is then introduced to the solution and dissolve. In a separate container, a dispersion of CNT (4 ml) and surfactant (D-1038) (4 drops) in methanol (5 ml) is sonicated for 10 minutes to homogenize.

The sonicated CNT solution is slowly added into the reaction mixture containing PVP, methanol, and AIBN, while stirring continuously. After 10 minutes of stirring, methyl methacrylate (MMA) (20 g) is added slowly to the reaction batch while maintaining a constant temperature of 70° C. The reaction is allowed to proceed for 3 hours at 70° C. to ensure complete polymerization and particle formation within the CNT dispersion. Upon completion of the reaction, the formed microparticles are filtered out from the reaction mixture.

### C2. Modification of Commercial Microparticles For Making Brush Particles with Shell

This study demonstrates methods for preparing CNT-modified “brush” microparticles from commercially available PMMA particles. The CNTs on the surface of the microparticles offer a convenient method for delivering CNTs into the polymer resin matrices for reinforcement.

Commercial PMMA particles (50-60 g) of with a diameter ranging from 1 to 5 micrometers were dispersed in a solution of epoxy 1007F resin in 60 mL tetrahydrofuran (THF) (10% concentration). The PMMA particles were stirred until a homogeneous dispersion is achieved. A CNT dispersion in ethanol is added, and the stirring continued for an additional hour at 50° C. Continuing with the procedure, the dispersion of PMMA particles in epoxy resin is slowly injected into a solution of polyvinyl alcohol (PVOH) or polyvinylpyrrolidone (PVP) at a concentration of 1%.

### C3. Modification of Commercial Microparticles for Making Brush Particles with a Lowe Melting Point

Commercial PMMA particles with a diameter ranging from 1 to 5 micrometers were dispersed in an epoxy 1004F resin and THE solution (10% concentration). The PMMA particles are dispersed in the resin solution and stirred until a homogeneous. A CNT dispersion in ethanol is added, and stirred for an additional hour at 50° C. Continuing with the procedure, the dispersion of PMMA particles in epoxy resin is slowly injected into a solution of polyvinyl alcohol (PVOH) or polyvinylpyrrolidone (PVP) at a concentration of 1%.

### C4. Modification of Commercial Microparticles for Making Brush Particles with a Low Melting Point

Commercial PMMA particles with a diameter ranging from 1 to 5 micrometers are dispersed in an Epoxy 1004F resin and the solution (10% concentration). The PMMA particles are dispersed in the resin solution and stirred until a homogeneous. A CNT dispersion in ethanol is added, and stirred for an additional hour at 50° C. Continuing with the procedure, the dispersion of PMMA particles in epoxy resin is slowly injected into a solution of polyvinyl alcohol (PVOH) or polyvinylpyrrolidone (PVP) at a concentration of 1%.

### C5. Burrowed Microparticles

This study demonstrates methods for preparing burrowed particle-core structures starting from commercial microparticles. The burrowed particles are used as cores for matrix particles. The burrowing process involves treating the microparticles with solvents such as IPA (isopropanol). The osmotic pressure at the microparticle surface and evaporation of the solvents burrows pores into the microparticles. The hydrophobic interactions result in the migration of a catalyst and/or CNTs/CNS into the burrows. The burrowed microparticles are converted into core-shell microparticles. The resulting core-shell microparticles offer the advantage of delivering CNTs into the polymeric resin.

### C6. Burrowed Core-Shell Microparticle with a PMMA Shell

A solution of polyvinyl alcohol (PVOH) (2 g) in DI water (400 g) is prepared. Separately, a dispersion of CNTs (0.8 g) in isopropanol (100 g) is prepared. Ten (10) g of commercial microparticles particles (1-10 microns) are added and dispersed into the PVOH solution. The CNT dispersion is added to the PVOH solution. The dispersion is left to stir for 12-18 hours until the IPA (isopropyl alcohol) evaporated. During the 12-18 hours period, the osmotic pressure of IPA created burrows on the surface of microparticles. As the solvent evaporated, the CNTs migrate into the burrows because of the hydrophobic interactions. The dried burrowed microparticles containing CNTs are added to clean water. Stearyl methacrylate (5 g) is added dropwise, and emulsion polymerization is performed under the presence of inert gas. The emulsion polymerization reaction is catalyzed by azoisobutyronitrile (AIBN) (20 mg) and stirred for 40 minutes to form the PMMA shell.

### C7. Burrowed Core-Shell Microparticle with a PGMA Shell

A solution of polyvinyl alcohol (PVOH) (2 g) in DI water (400 g) is prepared. Separately, a dispersion of CNTs (0.8 g) in isopropanol (100 g) is prepared. 10 g of commercial microparticles particles (1-10 micron) are added and dispersed into the PVOH solution. The CNT dispersion is added to the PVOH solution. The dispersion is left to stir for 12-18 hours until the IPA (isopropyl alcohol) evaporated. During the 12-18 hours period, the osmotic pressure of IPA creates burrows on the surface of microparticles. As the solvent evaporates, the CNTs migrate into the burrows because of the hydrophobic interactions. The dried burrowed microparticles with CNTs are added to clean water. Glycidyl methacrylate (GMA) (5 g) is added dropwise, and emulsion polymerization is performed under the presence of inert gas. The emulsion polymerization reaction is catalyzed by azoisobutyronitrile (AIBN) (20 mg) and stirred for 40 minutes to form the PGMA shell.

### C8. Burrowed Microparticle with a PSMA Shell Created Through Emulsion Polymerization

A solution of polyvinyl alcohol (PVOH) (2 g) in DI water (400 g) is prepared. Separately, a dispersion of CNTs (0.8 g) in isopropanol (100 g) is prepared. Ten (10) g of commercial microparticles particles (1-10 micron) are added and dispersed to the PVOH solution. The CNT dispersion is added to the PVOH solution. The dispersion is left to stir for 12-18 hours until the IPA evaporated. During the 12-18 hours period, the osmotic pressure of IPA creates burrows on the surface of microparticles. As the solvent evaporates, the CNTs migrate into the burrows because of the hydrophobic interactions. The dried burrowed micro-particles with CNTs are added to clean water. Steryl methacrylate (SMA) (5 g) was added dropwise, and emulsion polymerization is performed under the presence of inert gas. The emulsion polymerization reaction is catalyzed by azoisobutyronitrile (AIBN) (20 mg) and stirred for 40 minutes to form the PSMA shell.

### C9. Burrowed Core-Shell Microparticle with PU Shell

A solution of polyvinyl alcohol (PVOH) (2 g) in DI water (400 g) is prepared. Separately, a copper 2-ethyl hexanoate (0.8 g) solution in isopropanol (100 g) is prepared. To the PVOH solution, 10 g of commercial microparticles are added and dispersed. The copper solution is added to the PVOH solution. The dispersion is left to stir for 12-18 hours until the IPA evaporates. During the 12-18 hours period, the osmotic pressure of IPA creates burrows on the surface of microparticles. As the solvent evaporated, copper 2-ethyl hexanoate migrates into the burrows because of the hydrophobic interactions. A commercial polyurethane-CNT (10 mL) in acetone is mixed into the dispersion as a coating for the burrowed particle.

1. A plurality of matrix particles, comprising a matrix particle A and/or a matrix particle B:
wherein, said matrix particle A comprises a core and optionally, at least one shell,
wherein said core comprises:
(i) a matrix material, wherein said matrix material is capable of fully or partially altering its physical and/or chemical characteristics;
(ii) at least one susceptor component, wherein said at least one susceptor component is embedded in said matrix material; and
(iii) at least one releasable ingredient, wherein said at least one releasable ingredient is embedded in said matrix material, wherein said at least one releasable ingredient is capable of impacting physically or chemically a bulk physically or chemically alterable composition with which said plurality of matrix particles is contacted, and
wherein said at least one shell comprises:
(iv) optionally, said at least one susceptor component, wherein said at least one susceptor component is embedded in said at least one shell; and
(v) at least one releasable ingredient, wherein said at least one releasable ingredient is embedded in said at least one shell, wherein said at least one releasable ingredient is capable of impacting physically or chemically said bulk physically or chemically alterable composition with which said plurality of matrix particles is contacted;
AND
wherein said matrix particle B comprises a core and optionally, at least one shell, wherein said core comprises:
(vi) a matrix material, wherein said matrix material is capable of fully or partially altering its physical and/or chemical characteristics; and
(vii) at least one releasable ingredient, wherein said at least one releasable ingredient is embedded in said matrix material, wherein said at least one releasable ingredient is capable of impacting physically or chemically said bulk physically or chemically alterable composition with which said plurality of matrix particles is contacted; and
wherein said at least one shell comprises:
(viii) optionally, said at least one susceptor component, wherein said at least one susceptor component is embedded in said at least one shell; and
(ix) said at least one releasable ingredient, wherein said at least one releasable ingredient is embedded in said at least one shell, wherein said at least one releasable ingredient is capable of impacting physically or chemically said bulk physically or chemically alterable composition with which said plurality of matrix particles is contacted; and
wherein said at least one susceptor component and/or the releasable ingredient is capable of activation through radio-frequency (RF), micro-wave (MW) radiation, thermal activation, mechanical abrasion, or a combination thereof.

2. The plurality of matrix particles as recited in claim 1, wherein said matrix material is derived from and/or comprises organic, monomeric, oligomeric, polymeric materials, or a combination thereof.

3. The plurality of matrix particles as recited in claim 1, wherein said at least one susceptor and/or said at least one releasable ingredient is selected from the group consisting of fullerene compounds, graphene, graphite oxide, nanocrystalline cellulose single-wall carbon nanotubes, multi-wall carbon nanotubes, carbon nanofibers, carbon nanotubes, doped carbon nanotubes, carbon sheets, one or more ferrous metals, oxides of one or more ferrous metals, SPIONS, one or more non-ferrous metals, oxides of one or more non-ferrous metals, transition metals, transition metal oxides, silicon carbide-based material, boron nitride, and one or more combinations thereof.

4. The plurality of matrix particles as recited in claim 1, wherein the dimensions of said at least one susceptor and/or said at least one releasable ingredient are in the range of from about 0.1 nm to about 1000 μm, and optionally, said at least one susceptor and/or said at least one releasable ingredient are functionalized and/or non-functionalized.

5. The plurality of matrix particles as recited in claim 1, wherein said at least one susceptor and/or said at least one releasable ingredient are in said at least one shell and wherein said at least one susceptor and said at least one releasable ingredient are in direct or indirect contact.

6. The plurality of matrix particles as recited in claim 1, wherein the matrix particle is partially or wholly coated in one or more layers of a deformable material, wherein, optionally, one or more of said layers contains said at least one susceptor and/or said at least one releasable ingredient.

7. The plurality of matrix particles as recited in claim 1, wherein said at least one releasable ingredient is a single chemical, a combination of chemicals, organic chemicals, and/or inorganic chemicals, and wherein said at least one releasable ingredient comprises one or more catalysts, co-catalysts, co-reactants, oxidizers, reaction-inhibiting compounds, accelerators, co-accelerators, fuels, an explosives, or one or more combinations thereof.

8. The plurality of matrix particles as recited in claim 1, wherein said at least one releasable ingredient is released when the matrix material or the shell is deformed, dissolved, melted, expanded, contracted, ruptured, plasticized, solvated, impacted by light, or one or more combinations thereof.

9. The plurality of matrix particles as recited in claim 1, wherein the particle is further chemically surface-modified via one or more chemical reactions, optionally comprising said at least one releasable ingredient, and optionally then forming a partial or complete coating.

10. The plurality of matrix particles as recited in claim 1, possessing a chemical functionality, wherein said at least one releasable ingredient comprises a chemically functional monomer, wherein the matrix material comprises a polymerized material, and optionally, the matrix particle is coated with a polymerized coating.

11. The plurality of matrix particles as recited in claim 1, wherein the one or more alterable matrix material comprises a wax, one or more of polymethyl methacrylate (PMMA), other substituted acrylates, styrene, or one or more polymers or copolymers thereof.

12. A process for preparing the plurality of matrix particles as recited in claim 1, using the process A, B, C, D, or combination thereof, wherein:
(A) comprises emulsion, dispersion, and/or suspension polymerization; or
(B) comprises core-shell polymerization; or
(C) comprises copolymerization, wherein said copolymerization step comprises emulsion, dispersion, suspension polymerization or combinations thereof;
(D) comprises the following steps:
(i) coating a polymeric microparticle with a material comprising susceptors and releasable ingredient,
(ii) encapsulating a microparticle in which susceptor and releasable ingredients are embedded, with a monomeric, oligomeric, or a polymeric or a polymeric material, and/or
(iii) amalgamating the susceptors and releasable ingredients, and
(iv) entrapping the susceptors and releasable ingredients into external pores on the surface or internal pores in the core of the porous microspheres.

13. A process for impacting a chemical reaction or a process for releasing at least one releasable ingredient from a plurality of matrix particles, comprising:
(i) providing a bulk reaction mixture;
(ii) providing matrix particles as recited in claim 1;
(iii) incorporating said plurality of matrix particles in the bulk reaction mixture; and
(iv) optionally incorporating said plurality of matrix particles in said bulk reaction mixture, and impinging the bulk reaction mixture with at least one frequency of RF radiation and/or at least one frequency of MW radiation, at least once, on to thermally activate said susceptor component embedded within the matrix particles;
heating said bulk reaction mixture comprising said plurality of matrix particles;
mechanically abrade said bulk reaction mixture comprising said plurality of matrix particles; or
a combination thereof.

14. The plurality of matrix particles as recited in claim 1, wherein the CNT are incorporated into the matrix particle by the process recited in claim 12.

15. An article comprising the plurality of matrix particles as recited in claim 1.

16. An article prepared as recited in claim 12, that is in whole or in part:
(i) a polymerizable composition or several polymerizable compositions of at least one chemistry;
(ii) a reinforced composite article;
(iii) a laminated article;
(iv) a rigid laminated article;
(v) a flexible laminated article;
(vi) a foam; or a
(vii) combination thereof.

17. A composition comprising the plurality of matrix particles as recited in claim 1, wherein said composition is an adhesive, sealant, coating, paint, ink, plastic, molded plastic, thermoset plastic, molded thermoset plastic, or other polymer forming composition, in whole or part.

18. The plurality of matrix particles as recited in claim 1, wherein the releasable ingredient is a catalyst selected from the group consisting of transition metal complexes; transition metal alkoxides; stannous (II) bis(2-ethylhexanoate); carboxylates, alkoxide, and complexes of stannous, bismuth, zinc, titanium; blocked super acids; dodecyl benzene sulphonic acids; dinonyl naphthalene sulphonic acids; N,N′,N″-tris(dimethylaminopropyl) hexahydrotriazine; organic bases; 1,8-diazabicyclo [5.4.0] undec-7-ene; 1,5-diazabicyclo [4.3.0] nonene-5); (1,4-diazabicylo 2.2.2 octane); and combinations thereof.

19. A multilayer polymer composition comprising a first plurality of matrix particles and one or more additional plurality of matrix particles as recited in claim 1, wherein the one or more plurality of matrix particles are disposed upon the first matrix particle forming one or more matrix particle layers.

20. A precursor, intermediate, or final monomeric, oligomeric, or polymeric composition, comprising a plurality of matrix particles as recited in claim 1, wherein the composition is solid state polymerized or is prepared from a reactive hot-melt formulation.

21. A plurality of matrix particles as recited in claim 1, wherein the plurality of matrix particles comprises carbon nanotubes, wherein the carbon nanotubes are coated on the matrix particle and/or are contained in the matrix particle.

22. The plurality of matrix particles as recited in claim 1, wherein the CNT are incorporated into the plurality of matrix particles by the process of amalgamation.

23. The plurality of matrix particles as recited in claim 1, wherein matrix particle is further coated with functional nano-particle emulsions or dispersions.

24. The plurality of matrix particles as recited in claim 1, wherein matrix particle is further coated with monofunctional reactive materials or with di-reactive materials.

25. A precursor, intermediate, or final monomeric, oligomeric, or polymeric composition, comprising a plurality of matrix particles as recited in claim 1; optionally wherein the composition is prepared from a functionalized polymer formulation and optionally wherein the composition is prepared as a reactive blend with non-reactive polymers or oligomers.

26. A process for impacting a chemical reaction, comprising:
(i) providing a bulk reaction mixture;
(ii) providing a plurality of matrix particles as recited in claim 1;
(ii) incorporating said plurality of matrix particles in said bulk reaction mixture, and impinging the bulk reaction mixture with at least one frequency of RF radiation and/or at least one frequency of MW radiation, at least once, on to thermally activate said susceptor component embedded within the matrix particles;
heating said bulk reaction mixture comprising said plurality of matrix particles;
mechanically abrade said bulk reaction mixture comprising said plurality of matrix particles; or
a combination thereof;
wherein the bulk reaction mixture is a precursor or intermediate monomeric, oligomeric, or polymeric composition for solid state polymerization;
wherein the bulk reaction mixture is a precursor or intermediate monomeric, oligomeric, or polymeric composition for reactive hot-melt formulation;
wherein the bulk reaction mixture is a precursor or intermediate monomeric, oligomeric, or polymeric composition for a reactive blend with non-reactive polymers or oligomers; or
wherein the bulk reaction mixture is a precursor or intermediate monomeric, oligomeric, or polymeric composition for a functionalized polymer formulation.

27. A process to increase the overall loading of CNTs in a bulk physically or chemically alterable composition, by the process recited in claim 29.

28. A process to maintain lower viscosity upon adding of at least one additive in a bulk physically or chemically alterable composition comprising incorporating said at least one additive as at least one releasable ingredient in the plurality of matrix particles as recited in claim 1, and incorporating said plurality of matrix particles in the bulk physically or chemically alterable composition.

29. A process for increasing the overall loading of additives in a bulk physically or chemically alterable composition, comprising:
(i) providing said bulk physically or chemically alterable composition;
(ii) incorporating said at least one additive in a plurality of matrix particles as recited in claim 1, as a releasable ingredient;
(ii) incorporating said plurality of matrix particles in said bulk physically or chemically alterable composition, and impinging said bulk physically or chemically alterable composition with at least one frequency of RF radiation and/or at least one frequency of MW radiation, at least once, to thermally activate said susceptor component embedded within the matrix particles;
heating said bulk physically or chemically alterable composition comprising said plurality of matrix particles;
mechanically abrade said bulk physically or chemically alterable composition comprising said plurality of matrix particles; or
a combination thereof;
optionally wherein the bulk physically or chemically alterable composition is a precursor or intermediate monomeric, oligomeric, or polymeric composition for reactive hot-melt formulation, adhesives, coatings, composites, are a combination there of.

30. A process to maintain lower viscosity upon adding of at least one additive in a bulk physically or chemically alterable composition, comprising the steps of:
(i) providing said bulk physically or chemically alterable composition;
(ii) incorporating said at least one additive in a plurality of matrix particles as recited in claim 1, as a releasable ingredient;
(ii) incorporating said plurality of matrix particles in said bulk physically or chemically alterable composition, and impinging said bulk physically or chemically alterable composition with at least one frequency of RF radiation and/or at least one frequency of MW radiation, at least once, to thermally activate said susceptor component embedded within the matrix particles;
heating said bulk physically or chemically alterable composition comprising said plurality of matrix particles;
mechanically abrade said bulk physically or chemically alterable composition comprising said plurality of matrix particles; or
a combination thereof;
optionally wherein the bulk physically or chemically alterable composition is a precursor or intermediate monomeric, oligomeric, or polymeric composition for reactive hot-melt formulation, adhesives, coatings, composites, are a combination there of.

31. The plurality of matrix particles as recited in claim 1, wherein the releasable ingredient is a catalyst for curing, polymerizing, reacting acrylates, silane-terminated polymers, hydrolysis, condensation catalysts, isocyanate trimerization, 1K moisture cure isocyanates, melamine crosslinked systems, 2K polyurethanes, 1K blocked isocyanate-based polyurethanes, epoxy, esterification, and transesterifications.
